(19) United States
(12) Patent Application Publication
(10) Pub. No.: US 2006/0183543 A1
(43) Pub. Date: Aug. 17, 2006

(54) Gaming machine and game article

(75) Inventor: Kenichi Yagi, Tokyo (JP)

Correspondence Address: ARENT FOX PLLC, 1050 CONNECTICUT AVENUE, N.W., SUITE 400, WASHINGTON, DC, 20036, US

(73) Assignee: AZURE CORP.

(21) Appl. No.: 11/317,895

(22) Filed: Dec. 27, 2005

(30) Foreign Application Priority Data
Dec. 28, 2004 (JP) P2004-380201
Dec. 28, 2004 (JP) P2004-381126

(51) Int. Cl. A63F 13/00

(52) U.S. Cl. 463/31

(57) ABSTRACT

A gaming machine includes: a read unit for reading game information concerning a game from a game article including a main body section having an incidence section for introducing light incident from the outside into the inside and an emission section for emitting light incident from the incidence section and passing through the inside to the outside and a storage section for storing the game information concerning a game; a light emission mode determination unit for determining a light emission mode of a light emission body for emitting light to the incidence section of the game article based on the game information read through the read unit; and a light emission control unit for controlling the light emission of the light emission body in accordance with the light emission mode determined by the light emission mode determination unit.

### CROSS-REFERENCE TO THE RELATED APPLICATION(S)

This application is based upon and claims a priority from prior Japanese Patent Applications No. 2004-380201 and No. 2004-381126 filed on Dec. 28, 2004, the entire contents of which are incorporated herein by reference.

### BACKGROUND OF THE INVENTION

1. Field of the Invention

This invention relates to a gaming machine having a read function of information stored in a three-dimensional game article such as a figure, a cassette, or a cartridge and a write function of information into a game article.

2. Description of the Related Art

Hitherto, a game system has been known wherein information is previously stored in a three-dimensional game article such as a figure, a cassette, or a cartridge and the information stored in the game article is read for a player to play a game. For example, JP-A-2002-126345 discloses a game system wherein game program data stored in a program cartridge is read and is transferred to a gaming machine for a player to play a game based on the transferred game program data. In the game system, basic program data and subprogram data unsealed by a three-dimensional toy are transferred to the gaming machine for the player to play a game. JP-A-2003-230761 discloses a game board system wherein when a figure is placed on a pedestal on a game board unit, figure data stored in the figure is read by a read/write section provided in each cell (square) of the pedestal and is transmitted from the game board unit to a gaming machine, which then produces game effect responsive to the figure data.

### SUMMARY OF THE INVENTION

In the game system as described above, a separate game article from the gaming machine is included in addition to the gaming machine and is used to transfer information to the gaming machine for executing a game and producing the game effect.

However, the game article has a three-dimensional shape whose existence is visually recognized easily by the player and the shape is unchanged and therefore if the player continues to use the same game article of the figure, etc., the player easily gets tired of the shape of the game article and loses the desire to play a game using the game article. Nevertheless, to prevent the player from getting tired of the game article, a large number of game articles different in shape must be provided as much as possible. If a large number of game articles are provided, the cost implementing the game system also increases and time and manpower are also required.

In other words, the player must provide for several game articles by purchasing a new game article, etc., each time the player feels tired or weary. On the other hand, the provider selling game articles, etc., has trouble to continue developing a new game article such that the player always feels it fresh. Thus, the player and the provider look forward to the advent of a gaming machine for eliminating the need for providing for new several game articles and enabling the player to play a game without feeling tired or weary.

It is therefore an object of the invention to provide a gaming machine and a game article for enabling a player to keep interest without exchanging the game article for another.

According to the invention, there is provided a gaming machine including a read unit for reading game information concerning a game from a game article including a main body section having an incidence section for introducing light incident from the outside into the inside and an emission section for emitting light incident from the incidence section and passing through the inside to the outside and a storage section for storing the game information concerning a game; a light emission mode determination unit for determining a light emission mode of a light emission body for emitting light to the incidence section of the game article based on the game information read through the read unit; and a light emission control unit for controlling the light emission of the light emission body in accordance with the light emission mode determined by the light emission mode determination unit.

In the gaming machine, when the game information is read from the storage section of the game article through the read unit, the light emission mode determination unit determines the light emission mode of the light emission body based on the game information, and the light emission control unit controls the light emission of the light emission body in accordance with the light emission mode determined by the light emission mode determination unit. The light emitted from the light emission body to the incidence section of the game article passes through the inside of the main body section of the game article and is emitted from the emission section to the outside. Therefore, in the gaming machine, if the light emission mode of the light emission body is changed based on the game information stored in the game article, the light emitted from the emission section of the game article placed for enabling the player to visually recognize the game article changes and the appearance of the game article is seen in a different way. That is, the gaming machine according to the invention enables the appearance of the game article to be changed without exchanging the game article for another, so that interest to the player can be kept.

Preferably, the light emission body can emit light of a plurality of colors to the incidence section of the game article. In this case, the light emission modes richer in variety can be provided.

Preferably, the gaming machine is provided with the light emission body. If each player owns the game article, the number of the game articles is by far larger than the number of the gaming machines, so that the number of provided light emission bodies can be decreased as compared with the case where each game article is provided with the light emission body.

Preferably, the game article has the light emission body. In this case, for example, a light emission body different in color or the number of colors can be provided for each game article and a different light emission mode can be realized for each game article. Further, the light emission modes rich in variety can be easily realized as compared with the case where the gaming machine is provided with the light emission body.

Preferably, the gaming machine further includes: an image display unit for displaying a game image used for a game; an operation unit for a player to perform operation input required for progress of an image game using the game image; a game progress control unit for displaying the game image on the image display unit and allowing the image game to proceed; and a communication unit for receiving game relevant information concerning the image game from the outside, wherein the light emission mode determination unit determines the light emission mode of the light emission body based on the game relevant information received by the communication unit and the game information read through the read unit. In this case, the light emission mode determination unit determines the light emission mode of the light emission body based on not only the game information, but also the external game relevant information received by the communication unit, so that the light emission modes rich in variety can be realized and accordingly interest to the player can be kept.

Preferably, a usual gaming mode and a special gaming mode for giving an advantageous bonus to the player are provided as gaming mode, and the gaming machine further includes a gaming mode control unit for causing the gaming mode to make a transition from the usual gaming mode to the special gaming mode as a predetermined transition condition holds. The player repeats playing a game while expecting the transition to the special gaming mode; as the light emission mode is changed, a sense of player expectation grows and thus the interest to the player can be kept.

According to a second aspect of the invention, there is provided a gaming machine including a read unit for reading from a game article including an incidence section for introducing light incident from the outside into the inside and an emission section for emitting light incident from the incidence section and passing through the inside to the outside, game information concerning a game stored in the game article; a write unit for storing rewritable rewrite game information of the game information except for unique information to the game article in the game article; a light emission unit for generating light that can be made incident on the incidence section of the game article; a light emission mode determination unit for determining the light emission mode of the light emission unit based on the unique information and the rewrite game information in the game information read through the read unit; and a light emission control unit for controlling the light emission of the light emission unit in accordance with the light emission mode determined by the light emission mode determination unit.

In this gaming machine, the game information stored in the game article is read through the read unit, the light emission mode is determined based on the read game information, and the light emission unit emits light in accordance with the determined light emission mode. Thus, in addition to change in the unique information as the game article changes, even if the same game article is applied, when the rewrite game information of the game information changes, the light emission mode changes accordingly and the light emission unit emits light in a different way. Therefore, one game article can be decorated in different manners. Thus, if a large number of game articles are not provided, the player is enabled to play a game without losing interest in playing the game and the interest in the game play can be enhanced. Since and light emission unit generates light that can be made incident on the incidence section, the light generated from the light emission unit passes through the game article and the player visually recognizes as if the game article emits light from the inside of the game article. Therefore, the game article emits light in a different mode from the mode wherein application light is applied to the outside of the game article, so that the number of decorative modes of the game article can be increased.

Preferably, the gaming machine further includes an effect information storage unit for storing effect information to produce different types of game effects; and an effect determination unit for determining the description of the effect produced using the effect information stored in the effect information storage unit, wherein when the effect determination unit determines producing a specific effect, the write unit stores effect relevant information relevant to the specific effect in the game article as the rewrite game information.

In doing so, the game information stored in the game article changes in response to the description of the effect and thus the light emission mode of the light emission unit changes based on the description of the effect and the decoration of the game article changes. Therefore, the player's interest in the game play can be more enhanced.

In the gaming machine, when the operation amount of the gaming machine by a player reaches a specific operation amount, the write unit can also store operation relevant information concerning the specific operation amount in the game article as the rewrite game information.

In doing so, the rewrite game information stored in the game article changes in response to the operation amount of the gaming machine by the player, so that the light emission mode of the light emission unit changes and the decoration of the game article changes based on the operation amount. Therefore, the player's interest in the game play can be more enhanced and the player can be made to become attached to the game article.

The gaming machine can further include a gaming state transition unit for causing the gaming state to make a transition from a usual gaming state to a specific gaming state more advantageous to the player than the usual gaming state, wherein when the number of times the gaming state transition unit has caused the gaming state to make a transition from the usual gaming state to the specific gaming state reaches a specific number of times, the write unit can store number-of-times relevant information concerning the specific number of times in the game article as the rewrite game information.

In doing so, the rewrite game information stored in the game article changes in response to the number of times the gaming state has made a transition to the specific gaming state, so that the light emission mode of the light emission unit changes and the decoration of the game article changes based on the number of times the gaming state has made a transition to the specific gaming state. Therefore, the player obtains a profit because of the transition to the specific game state and the decoration of the game article is changed and the interest in the game play can be more enhanced.

Preferably, the gaming machine further includes a gaming state determination unit for determining the gaming state for the player to play a game from among a usual gaming state and a plurality of specific gaming states more advantageous to the player than the usual gaming state, wherein the light emission mode determination unit determines the light emission mode based on the game information read through the read unit and the gaming state determined by the gaming state determination unit.

In the gaming machine, the light emission mode of the light emission unit changes based on the determined gaming state and the decoration of the game article changes. Therefore, the player can keep track of the gaming state according to the decoration of the game article and the interest in the game play can be more enhanced.

Preferably, the gaming machine further includes a transition permission/inhibition determination unit for determining whether or not the gaming state is allowed to make a transition from a usual gaming state to a specific gaming state more advantageous to the player than the usual gaming state; and a gaming state transition unit for causing the gaming state to make a transition to the specific gaming state when the transition permission/inhibition determination unit determines the gaming state transition to the specific gaming state, wherein before the gaming state transition unit causes the gaming state to make a transition to the specific gaming state, the light emission mode determination unit determines the light emission mode based on the game information read through the read unit and the determination of the transition permission/inhibition determination unit and the light emission control unit controls the light emission of the light emission unit.

In doing so, before the gaming state transition to the specific game state is made, the light emission unit emits light and the player is notified of the gaming state transition to the specific game state, so that the interest in the game play can be more enhanced.

Preferably, the gaming machine further includes a determination unit for determining whether or not the game article is used for a game, wherein when the determination unit determines that the game article is not used for the game, the light emission control unit inhibits the light emission unit from emitting light to control the light emission of the light emission unit.

In doing so, when the game article is not used for a game, the light emission unit does not emit light, so that the power required for the light emission unit to emit light can be saved.

The gaming machine may further include a display unit for displaying a game image used for a game and the game execution result; and a communication processing unit for receiving the game relevant information relevant to the game from the outside, wherein the light emission mode determination unit may determine the light emission mode of the light emission unit based on the game information and the game relevant information received by the communication processing unit.

In doing so, the light emission mode is determined based on the game relevant information received from the outside in addition to the game information, so that the player can play a game while imaging the relationship between the decoration of the game article and the game relevant information received from the outside, and can be prevented from losing interest in playing the game.

The gaming machine can further include a variable display unit for variably displaying a plurality of symbols; and a gaming state transition unit for causing the gaming state to make a transition from a usual gaming state to a specific gaming state more advantageous to the player than the usual gaming state when the symbols stopped and displayed on the variable display unit are specific symbols.

In the gaming machine, the decoration of the game article varies with the game information, so that the player can play a game while considering the relationship among the game article, the stopped and displayed symbols, and the transition to the specific gaming state. Thus, the player can be prevented from losing interest in playing the game.

According to the invention, there is provided a game article including a storage section for storing game information concerning a game of a gaming machine; and a main body section having an incidence section for introducing light incident from a light emission body into the inside and an emission section for emitting light incident from the incidence section and passing through the inside to the outside.

In the game article, when light is emitted from the light emission body to the incidence section of the main body section, the light passes through the inside of the main body section and is emitted to the outside. Therefore, for example, to use the game article with the gaming machine capable of changing the light emission mode of the light emission body based on the game information stored in the storage section, the light emitted from the emission section of the game article placed for enabling the player to visually recognize the game article changes and the appearance of the main body section of the game article is seen in a different way. That is, the gaming machine using the game article according to the invention enables the appearance of the game article to be changed without exchanging the game article for another, so that interest to the player can be kept.

According to the invention, there can be provided the gaming machine and the game article for enabling the player to keep interest without exchanging the game article for another.

### BRIEF DESCRIPTION OF THE DRAWINGS

These and other objects and advantages of the present invention will be more fully apparent from the following detailed description taken in conjunction with the accompanying drawings, in which:

FIG. 1 is a diagram to show the configuration of a game system including a plurality of gaming machines according to the invention;

FIG. 2 is a perspective view to show a plurality of gaming machines and a card selling machine;

FIG. 3 is a perspective view to show the overall configuration of the gaming machine;

FIG. 4 is an exploded perspective view of a figure installation unit of the gaming machine in FIG. 3;

FIG. 5 is an exploded front view to show the configuration of a figure;

FIG. 6 is a block diagram of the gaming machine shown centering on the internal configuration thereof;

FIG. 7 is a drawing to show an example of a light emission mode database;

FIG. 8 is a block diagram to show an example of the internal configuration of an image control circuit;

FIG. 9 is a block diagram to show an arcade server;

FIG. 10 is a block diagram to show a game server and a database server;

FIG. 11 is a flowchart to show an operation procedure of game processing from game start to game end in the gaming machine;

FIG. 12 is a flowchart to show an operation procedure of game start processing;

FIG. 13 is a flowchart to show an operation procedure of character generation processing;

FIG. 14 is a sequence chart to show an operation sequence executed among the gaming machine, the arcade server, and a center server group;

FIG. 15 is a drawing to show the light emission state of the figure installation unit;

FIG. 16 is a front view to show a figure installation unit different from the figure installation unit in FIG. 4;

FIG. 17 is a circuit diagram relevant to LEDs built in the figure installation unit in FIG. 16;

FIG. 18 is a drawing to show the light emission state of the figure installation unit in FIG. 16;

FIG. 19 is an exploded front view to show the configuration of a figure different from the figure in FIG. 5;

FIG. 20 is a perspective view to show the overall configuration of a Pachi-Slot machine according to a second embodiment of the invention;

FIG. 21 is a block diagram of the Pachi-Slot machine shown centering on the internal configuration thereof;

FIG. 22 is a drawing to show an example of a light emission mode database;

FIG. 23 is a flowchart to show an operation procedure of effect control processing;

FIG. 24 is a flowchart to show an operation procedure of light emission control processing;

FIG. 25 is a perspective view to show a pachinko gaming machine 201 according to a third embodiment of the invention from the front;

FIG. 26 is a block diagram of the pachinko gaming machine shown centering on the internal configuration thereof;

FIG. 27 is a drawing to show an example of a light emission mode database;

FIG. 28 is a perspective view to show a pachinko gaming machine according to a fourth embodiment of the invention from the front;

FIG. 29 is a front view of the pachinko gaming machine shown in FIG. 28;

FIG. 30 is an exploded perspective view of the pachinko gaming machine shown in FIG. 28;

FIG. 31 is a perspective view to show the pachinko gaming machine shown in FIG. 28 from the rear;

FIG. 32 is a front view of a game board shown in FIG. 28;

FIG. 33 is a fragmentary sectional view of the pachinko gaming machine shown in FIG. 28;

FIG. 34 is an exploded perspective view of a figure according to the embodiment of the invention;

FIG. 35 is a front view of an authentication unit of the pachinko gaming machine shown in FIG. 28;

FIG. 36 is an exploded perspective view of the authentication unit of the pachinko gaming machine shown in FIG. 28;

FIG. 37 is a perspective view of the authentication unit of the pachinko gaming machine shown in FIG. 28;

FIG. 38 is a plan view of the authentication unit of the pachinko gaming machine shown in FIG. 28;

FIG. 39 is a block diagram of the pachinko gaming machine shown centering on the internal configuration thereof;

FIG. 40 is a circuit diagram to show a decorative illumination control circuit and an LED circuit;

FIG. 41 is a flowchart to show an operation procedure of effect control processing;

FIG. 42 is a flowchart to show an operation procedure of game processing;

FIG. 43 is a flowchart to show an operation procedure of effect determination processing;

FIG. 44 is a flowchart to show an operation procedure of information write processing;

FIG. 45 is a flowchart to show an operation procedure of decorative illumination control processing;

FIGS. 46A to 46G are drawings to show tables; FIG. 46A is a drawing to show gaming state data, FIG. 46B is a drawing to show operation amount data, FIG. 46C is a drawing to show big bonus determination table, FIG. 46D is a drawing to show unique information numbers, FIG. 46E is a drawing to show game information, FIG. 46F is a drawing to show effect description data, and FIG. 46G is a drawing to show number-of-big-games data;

FIGS. 47A to 47D are drawings to show lighting pattern determination table; FIG. 47A is a drawing to show a first LED light emission mode determination table, FIG. 47B is a drawing to show a second LED light emission mode determination table, FIG. 47C is a drawing to show a third LED light emission mode determination table, and FIG. 47D is a drawing to show a fourth LED light emission mode determination table;

FIGS. 48A to 48D are drawings to show light emission mode determination tables; FIG. 48A is a drawing to show a first LED light emission mode table, FIG. 48B is a drawing to show a second LED light emission mode table, FIG. 48C is a drawing to show a third LED light emission mode table, and FIG. 48D is a drawing to show a fourth LED light emission mode table;

FIG. 49 is a perspective view to show the overall configuration of a Pachi-Slot machine according to a fifth embodiment of the invention;

FIG. 50 is a block diagram of the Pachi-Slot machine shown centering on the internal configuration thereof;

FIG. 51 is a diagram to show the configuration of a game system including a plurality of gaming machines according to the fifth embodiment of the invention;

FIG. 52 is a perspective view to show a plurality of gaming machines and a card selling machine;

FIG. 53 is a perspective view to show the overall configuration of the gaming machine;

FIG. 54 is a block diagram of the gaming machine centering on the internal configuration thereof; and

FIG. 55 is an exploded perspective view to show a figure different from the figure in FIG. 34.

### DETAILED DESCRIPTION OF THE PREFERRED EMBODIMENTS

The best mode for carrying out a gaming machine and a game article according to the invention will be discussed in detail with reference to the accompanying drawings. Components of one embodiment identical with or similar to those of another embodiment are denoted by the same reference numerals and will not be discussed again.

### First Embodiment

General Configuration of Game System

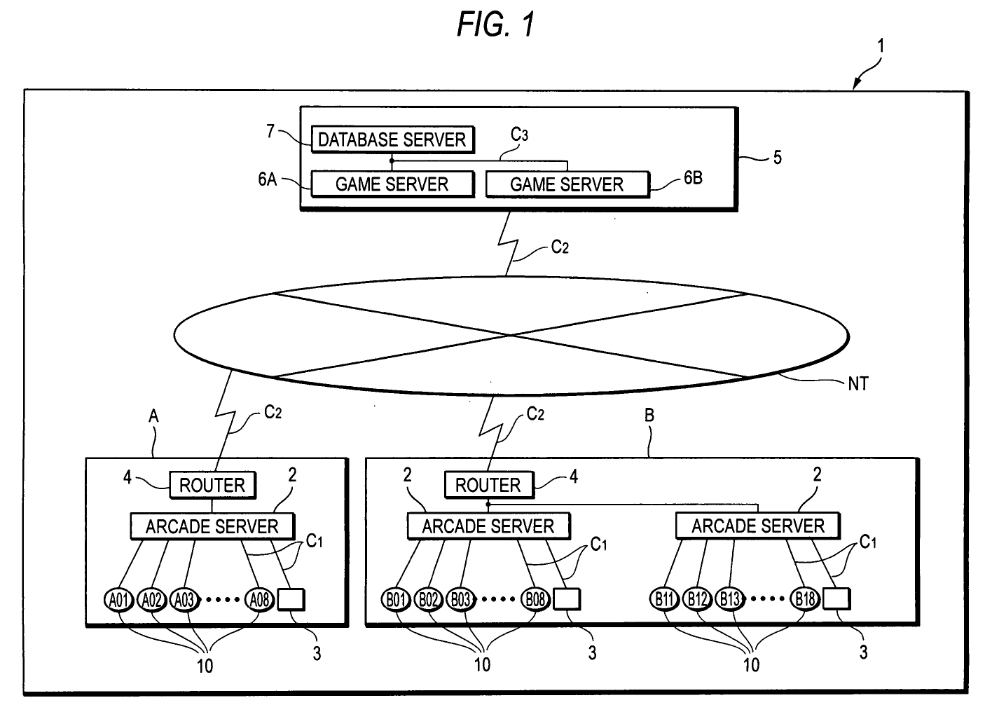

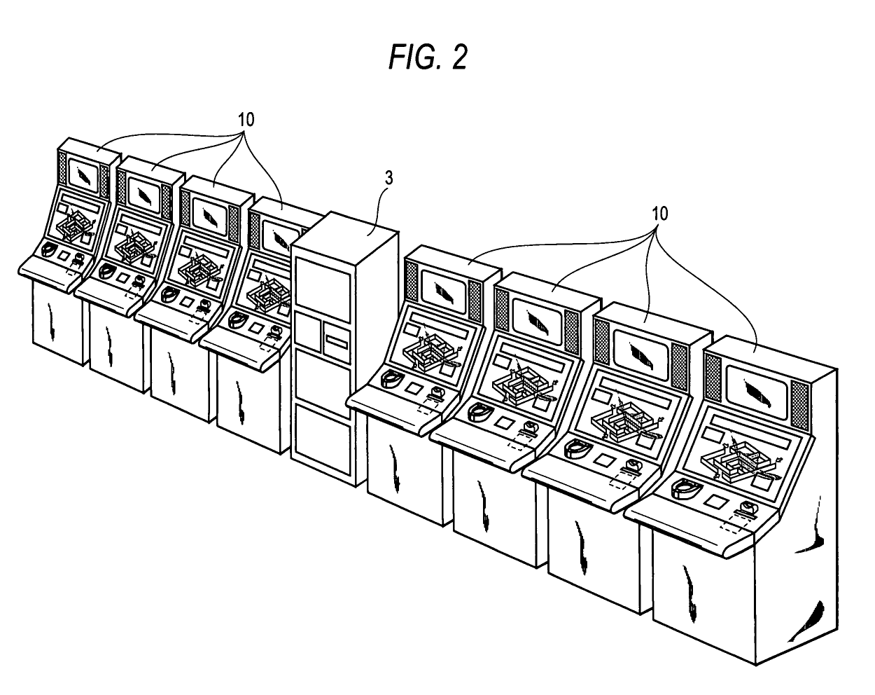

FIG. 1 is a diagram to show the configuration of a game system including a plurality of gaming machines according to the invention. FIG. 2 is a perspective view to show a plurality of gaming machines and a card selling machine. A game system 1 has a total of three arcade servers 2 (one server installed in a game arcade A and two servers installed in a game arcade B), a plurality of (in the embodiment, eight) gaming machines 10 and a card selling machine 3 connected to the server by dedicated lines C₁ so that they can communicate with each other, in-arcade routers 4 installed in the game arcades A and B, and a center server group 5 connected to the in-arcade routers 4 through communication lines C₂ and Internet NT.

In each game arcade A, B, the arcade server(s) 2, the gaming machines 10, and the card selling machine 3 are connected by the dedicated lines C₁ to form an in-arcade local area network (LAN), and the in-arcade LAN is connected to the Internet NT through the in-arcade router 4.

Each of the gaming machines 10 forming the game system 1 is a gaming machine according to a first embodiment of the invention and is assigned the unique machine ID. The machine ID is made up of the server ID unique to each arcade server 2 and the ID unique to each gaming machine 10; for example, the machine IDs of the gaming machines 10 installed in the arcade A are A01, A02, A03, . . .

Configuration of Gaming Machine

The gaming machine 10 has an image display unit for displaying a character image indicating a character acting in response to player operation as a game image used to play a game and enables the player to play an image game for causing the character to act in response to player operation. The gaming machine 10 in the embodiment enables the player to a game wherein while a character moves in a labyrinth along the route selected by the player, the character opposes a different character (a player character acting in accordance with selection of a different player or a non-player character caused to act by the gaming machine), struggles for items each other, gathers all items and then falls down the character of the final goal (which will be hereinafter referred to as “labyrinth battle game”). In the labyrinth battle game, the owned points of each character (called “life” in the embodiment) rises or falls matching the battle result or the progress situation of the game and the character having no owned points becomes a loser.

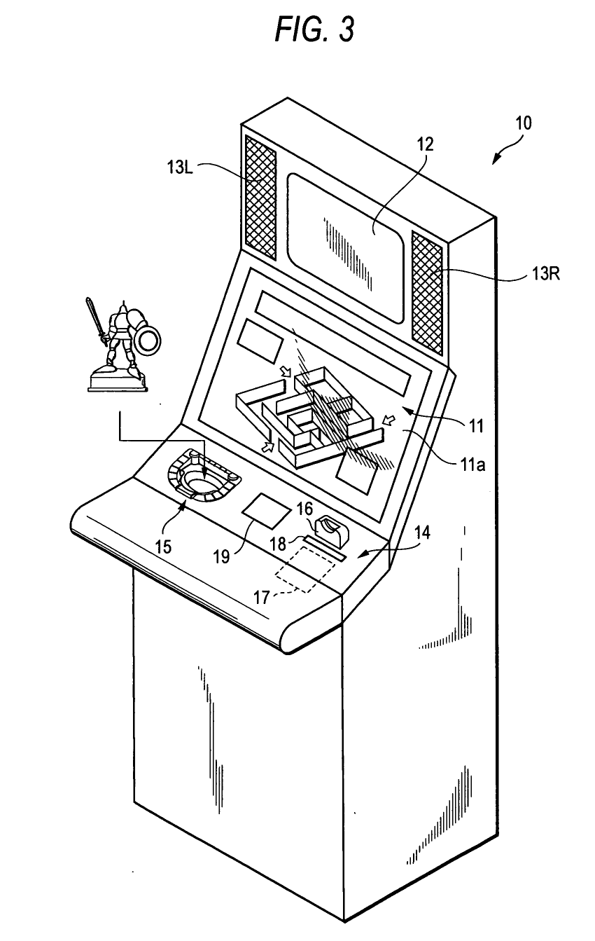

As shown in FIG. 3, the gaming machine 10 has a main display 11 including a liquid crystal display on the front of a cabinet. It also has a subdisplay 12 including a liquid crystal display above the main display 11 and loudspeakers 13L and 13R for outputting a sound used for the effect of game play on the right and the left sides of the subdisplay 12.

The main display 11 displays a game image responsive to each stage of game play (for example, a labyrinth image, etc.,). The subdisplay 12 displays an image at a specific stage of game play (for example, a battle image). The main display 11 and the subdisplay 12 make up an image display unit of the embodiment.

The gaming machine 10 also has an operation panel 14 below the main display 11 and a figure installation unit 15 at the left of the operation panel 14. A coin insertion slot 16 for inputting a coin required for playing a game (a game medium such as a coin or a game medal) and a card slot 18 for inserting an ID card 17 are provided at the right of the operation panel 14, and an operation unit 19 including operation buttons, etc, is provided in the vicinity of the center of the operation panel 14.

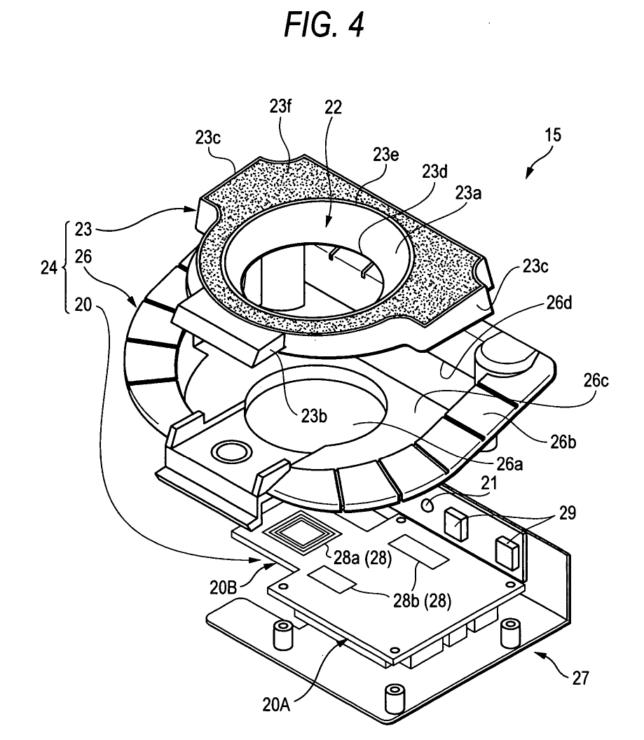

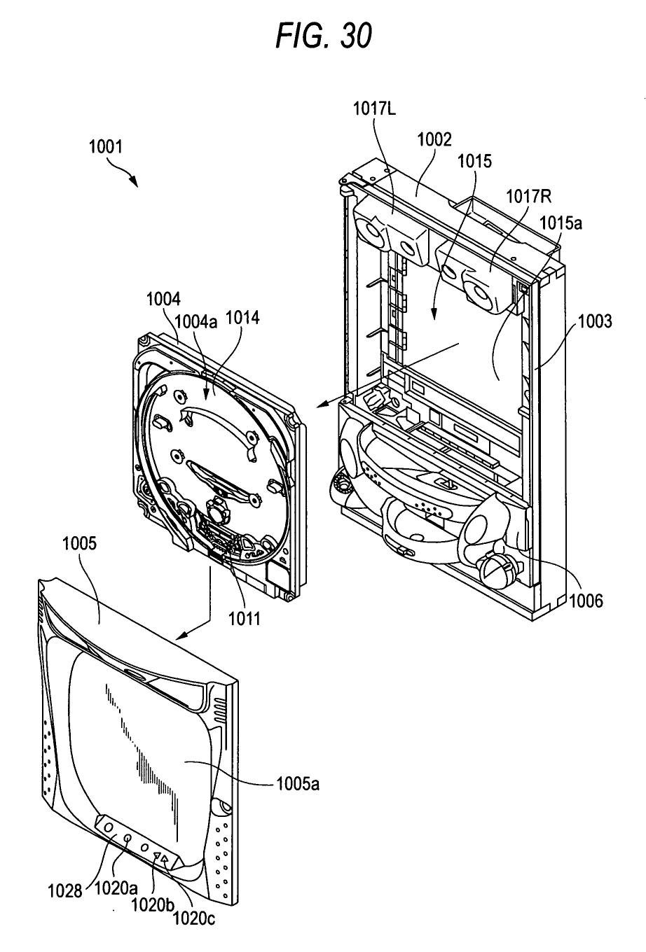

Here, the figure installation unit 15 will be discussed with reference to FIG. 4. FIG. 4 is an exploded perspective view of the figure installation unit 15. The figure installation unit 15 holds a figure 30 described later so as to be able to read figure storage information through an IC chip reader/writer 20 from the figure 30. It has a full-color LED unit (light emitting diode unit) 21 for emitting light to the held figure 30 and a holder section 24 formed with a holding hole 22 for holding the figure 30 and a light transmission area between a peripheral wall face 23a of the holding hole 22 and the LED unit 21. The IC chip reader/writer 20 is placed in the lower part of the holder section 24.

The holder section 24 has a holding member 23 having the holding hole 22 and made of a transparent and colorless light transmission material such as transparent urethane, a holding frame 26 for holding the holding member 23 from side and from below, and a base 27 for fixing the holding frame 26 onto the operation panel 14 of the gaming machine 10.

The holding member 23 is formed roughly like a ring having the holding hole 22 and has a projection part 23b provided to the front (player side), wide parts 23c and 23c provided wider to the rear, and a light shield seal 23f put on the upper surface (except the peripheral wall face 23a formed with the holding hole 22). The holding member 23 is held with the lower face of the projection part 23b assembled into the holding frame 26 and the wide parts 23c and 23c caught in the holding frame 26.

The holding member 23 also includes a circular opening 23d on the base 27 side (the side closed by a placement part 26a of the holding frame 26) facing the holding hole 22 and a circular opening end part 23e on the open side. The opening end part 23e has a larger diameter than the opening 23d has and the peripheral wall face 23a between the opening end part 23e and the opening 23d is a cone-shaped inclined face becoming gradually narrower in diameter from the opening end part 23e to the opening 23d. The shape of the opening 23d corresponds to the shape of the bottom of the figure 30 described later, allowing the bottom to be inserted through the opening 23d. As the peripheral wall face 23a is thus inclined, when the figure 30 is set in the figure installation unit 15, the bottom of the figure 30 arrives at the placement part 26a while it is guided along the peripheral wall face 23a, so that the player can easily set the figure 30 to the correct read position of the figure installation unit 15 and can be saved the trouble in starting a game using the figure 30.

The holding frame 26 includes an annular frame 26b surrounding the holding member 23, a holding reception part 26c being dented inside the frame 26b for holding the holding member 23, a light transmission window 26d formed at the rear of the holding reception part 26c, and the placement part 26a dented like a column with a step roughly at the center of the inside of the holding reception part 26c. The opening of the placement part 26a corresponds to the shape of the opening 23d of the holding member 23 and is a circle concentric with the opening 23d and having the same diameter as the opening 23d.

The IC chip reader/writer 20 is a circuit board corresponding to a read unit of the invention and is formed on a top face 20a with a read circuit 28 containing an antenna 28a and a control circuit 28b. The IC chip reader/writer 20 is made up of a square portion 20A formed with the control circuit 28b, etc., and a projection portion 20B projecting from one side of the square portion 20A and formed mainly with the antenna 28a. The IC chip reader/writer 20 reads information recorded in the figure 30 (game information in the invention, which will be hereinafter referred to as figure storage information), inputs the information into a main CPU 42, and writes predetermined information into an IC chip 34 as instructed from the main CPU 42. The IC chip reader/writer 20 can read the figure storage information even from the IC chip 34 at a distance of about 5 cm.

The holding frame 26 and the IC chip reader/writer 20 are fixed onto the base 55 with screws in a state in which the projection portion 20B of the IC chip reader/writer 20 and the placement part 26a of the holding frame 26 are aligned so that they overlap. Thus, the IC chip reader/writer 20 can read/write the figure storage information stored in the IC chip 34 of the figure 30 placed in the placement part 26a using the antenna 28a formed on the projection portion 20B.

The above-mentioned LED unit 21 is disposed on the base 27 positioned at the rear of the holding frame 26 with a predetermined spacing from the holding frame 26. The LED unit 21 is made up of a red light emission element, a blue light emission element, and a green light emission element and thus can emit light of various colors by combining the colors of light emitted from the elements. The LED unit 21 is disposed at the position corresponding to the light transmission window 26d of the holding frame 26 with a given gap (about 5 mm) from the holding member 23 exposed from the light transmission window 26d, provided by a spacer 29.

When power is supplied to the LED unit 21 from a light emission control circuit 50 described later, a part of light emission is incident on the holding member 23 having translucency through the light transmission window 26d of the holding frame 26. The light incident on the holding member 23 passes through the holding member 23 and is emitted from the peripheral wall face 23a of the holding member 23. Here, since the peripheral wall face 23a is at the position surrounding the figure 30 which is set, the light emitted from the peripheral wall face 23a of the holding member 23 illuminates the figure 30 set in the figure installation unit 15 from the lower side of the figure 30.

Configuration of Figure

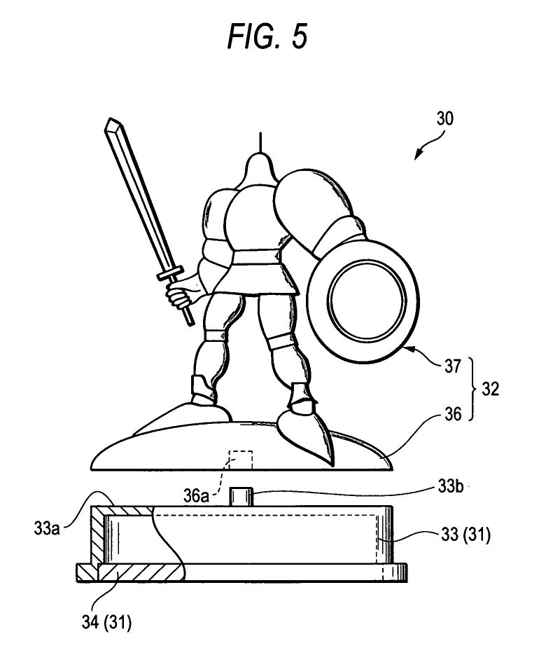

FIG. 5 is an exploded front view to show the configuration of the figure 30. The figure 30 is made up of a pedestal 31 and a figure main body 32 representing the three-dimensional shape of each character appearing in a labyrinth battle game.

The pedestal 31 is a thick hollow disk having a cross-sectional shape corresponding to the placement part 26a of the holding frame 26. The pedestal 31 corresponds to a storage section of the invention and is made up of a closed-end cylindrical pedestal main body 33 having a top section 33a and the above-mentioned IC chip 34. A projection part 33b is provided roughly at the center of the top section 33a of the pedestal main body 33 and the IC chip 34 is embedded and fixed in an opening of the pedestal main body 33 so as not to close the opening.

The above-described figure storage information is stored in the IC chip 34 and contains the figure ID (figure identification information) unique to the character corresponding to the figure main body 32. The figure ID is made up of an alphabetic character and four digits; the alphabetic character represents the figure type corresponding to the three-dimensional shape of the figure main body 32 (for example, “A” represents a magician, “B” represents a soldier, “C” represents a villager, etc.,) and the four digits represent unique identification information to distinguish one figure from another. This means that the player can identify the type of character according to the three-dimensional shape of the figure main body 32 of the figure 30 and the gaming machine can distinguish one figure from another according to the figure ID. As for the figure 30 shown in FIG. 5, the figure ID is “B1001” where “B” is the type and “1001” is the identification information.

The figure main body 32 corresponds to the main body section of the invention and is formed of a material having a light transmission property (translucency) (for example, a transparent material such as crystal glass or transparent plastic) and is made up of a foot pedestal section 36 having a concave part 36a corresponding to the projection part 33b of the pedestal 31 and a figure section 37 of a three-dimensional shape standing erect with two legs from the foot pedestal section 36. The material of the figure main body 32 may be transparent and colorless or may be colored if it has translucency.

The figure 30 is assembled as the projection part 33b of the pedestal 31 is fitted into the concave part 36a of the figure main body 32. The figure 30 is sized so that it is stored in a capsule about 7 cm in diameter (not shown). The figure 30 is sold at a selling machine similar to the card selling machine 3 in a state in which the figure 30 is housed in such a capsule. Since a monster figure is stored in some capsules, if the figure 30 is used, a monster figure can be used in some cases. The uniqueness of each character is represented by delicately changing the color of the character of the same type so as to promote the collection desire of the player.

Thus, the figure 30 is identified by the player according to the appearance of the figure main body 32 and is identified by the gaming machine 10 according to the figure ID. The figure IDs are unique so that only one unique figure ID can be assigned to a single figure in the game system 1.

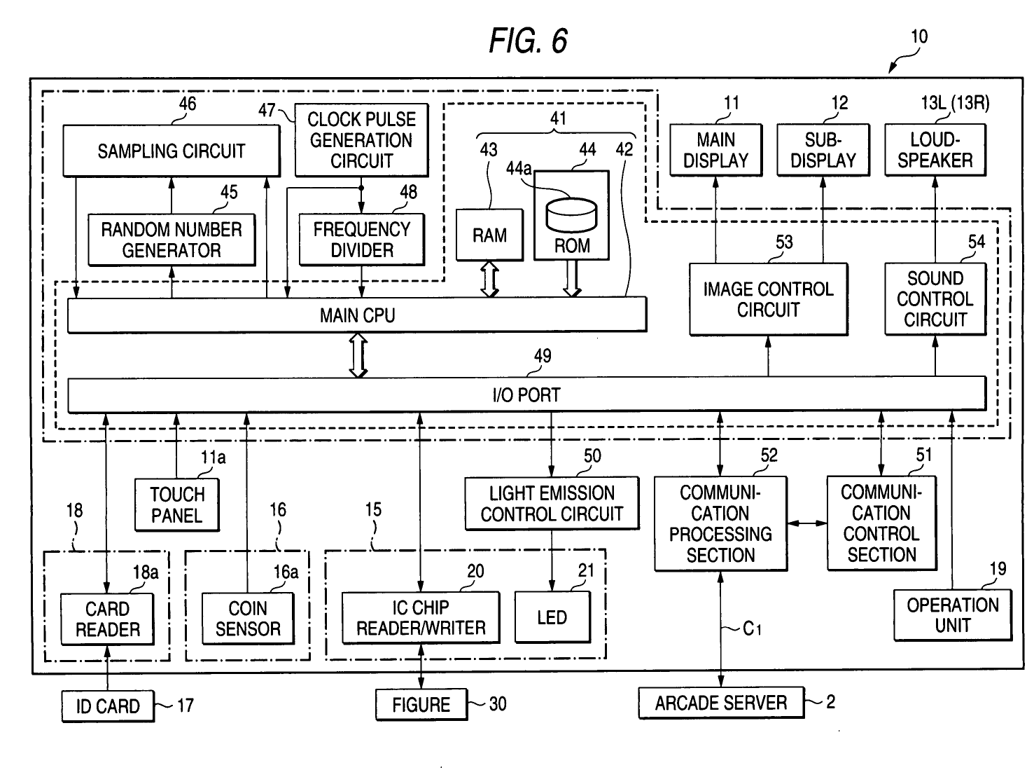

Next, the internal configuration of the gaming machine 10 will be discussed with reference to FIG. 6. FIG. 6 is a block diagram of the gaming machine 10 centering on the internal configuration thereof. The gaming machine 10 has components centering on a microcomputer 41.

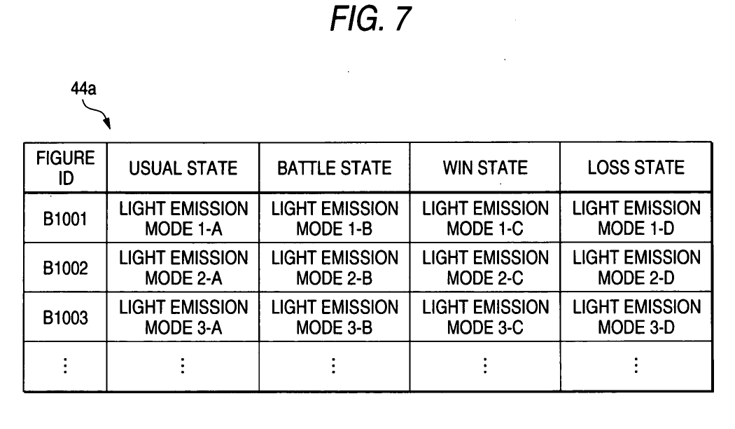

The microcomputer 41 has a main CPU (Central Processing Unit) 42, RAM (Random Access Memory) 43, and ROM (Read-Only Memory) 44. The main CPU 42 operates in accordance with a program stored in the ROM 44 and inputs a signal from each component provided on the operation panel 14 through an I/O port 49 and on the other hand, inputs/outputs a signal from/to other components for controlling the whole operation of the gaming machine 10. The RAM 43 stores data and a program used for the main CPU 42 to operate (in the embodiment, application data described later). The ROM 44 stores the control program executed by the main CPU 42 and a light emission mode database 44a as shown in FIG. 7 and also stores various permanent pieces of data.

More particularly, the light emission mode database 44a stores the figure ID of the figure storage information stored in the IC chip 34 of each figure 30 and the light emission mode in each gaming state in a labyrinth battle game (FIG. 4 shows four types of state of usual state, battle state, win state, and loss state) in association with each other. Each light emission mode stored in the light emission mode database 44a is information to determine the light emission mode of the LED unit 21 of the figure installation unit 15 described above and is defined by the elements of the type of light emission element to emit light, the lighting timing, the light emission strength, etc. For example, “light emission mode 1-A” corresponding to the “usual state” of the figure ID “B1001” is information indicating the light emission mode in which the blue light emission element of the LED unit 21 is lighted; “light emission mode 1-B” corresponding to the “battle state” is information indicating the light emission mode in which the red, light emission element of the LED unit 21 is lighted; “light emission mode 1-C” corresponding to the “win state” is information indicating the light emission mode in which the red and blue light emission elements of the LED unit 21 are lighted alternately in 0.5-second periods; and “light emission mode 1-D” corresponding to the “loss state” is information indicating the light emission mode in which all light emission elements of the LED unit 21 blink for 10 seconds at 1-second intervals.

The gaming machine 10 has a random number generator 45, a sampling circuit 46, a clock pulse generation circuit 47, a frequency divider 48. The random number generator 45 operates in accordance with an instruction of the main CPU 42 and generates random numbers in a given range. The sampling circuit 46 extracts any random number from among the random numbers generated by the random number generator 45 in accordance with an instruction of the main CPU 42 and inputs the extracted random number into the main CPU 42. The clock pulse generation circuit 47 generates a reference clock to operate the main CPU 42, and the frequency divider 48 inputs a signal provided by dividing the reference clock with a given period into the main CPU 42.

Further, a touch panel 11a, a coin sensor 16a, a card reader 18a, the above-mentioned light emission control circuit 50, the above-mentioned figure installation unit 15, a communication control section 51, a communication processing section (a communication unit) 52, an image control circuit 53, and a sound control circuit 54 are connected to the I/O port 49 of the gaming machine 10.

The touch panel 11a is provided so as to cover the display screen of the main display 11 for detecting the touch position of a finger of a player and inputting a position signal corresponding to the detection position into the main CPU 42. The player uses the touch panel 11a to execute operation input for determining the action of the character. For example, the touch panel 11a has a rectangular transparent plate surface to which a conductive substance is applied, applies a voltage from electrodes placed in four corners of the transparent plate, detects feeble current change caused by touching with a finger of the player with the electrode, and detects the touch position of the finger of the player. The touch panel 11a and the operation unit 19 make up an operation unit in the embodiment.

The coin sensor 16a detects a coin input through the coin insertion slot 16 and outputs a detection signal corresponding to the coin detection to the main CPU 42. The card reader 18a reads card information of the player ID, etc., recorded on the ID card 17 inserted into the card slot 18 and inputs the read card information into the main CPU 42.

The light emission control circuit 50 outputs a light emission signal to each light emission element (red light emission element, blue light emission element, green light emission element) of the LED unit 21 of the figure installation unit 15 in accordance with an instruction of the main CPU 42. That is, the light emission control circuit 50 enables the LED unit 21 to produce various light emission effects in the light emission modes.

The figure installation unit 15 includes the IC chip reader/writer 20 and the LED unit 21. The IC chip reader/writer 20 reads the figure storage information from the IC chip 34 of the figure 30 and inputs the figure storage information into the main CPU 42 and writes information from the main CPU 42 into the IC chip 34 to update the figure storage information, as required. Light emission of the LED unit 21 is controlled by the light emission control circuit 50 described above.

The communication control section 51 operates as instructed by the main CPU 42 and controls connection and disconnection of the communication line with the arcade server 2. The communication processing section 52 operates as instructed by the communication control section 51 and transmits and receives data via the dedicated line C₁.

The image control circuit 53 controls image display of the main display 11 and the subdisplay 12 and causes the main display 11 and the subdisplay 12 to display various images such as an image indicating a character.

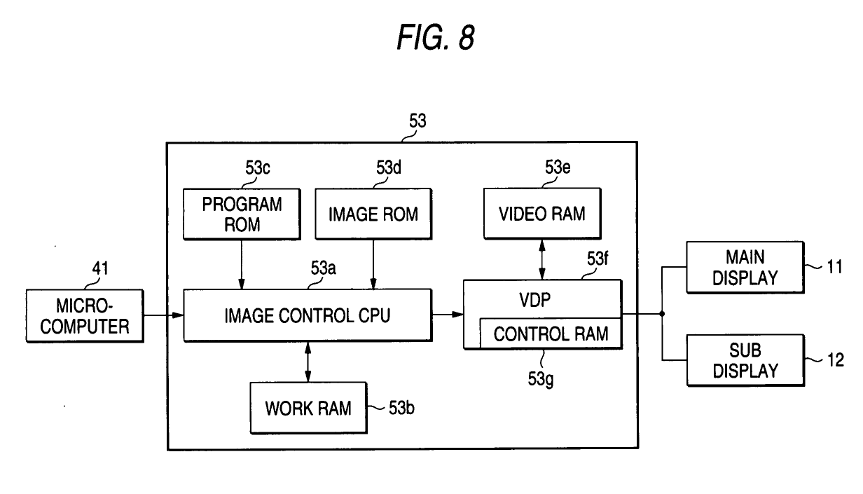

The image control circuit 53 has an image control CPU 53a, work RAM 53b, program ROM 53c, image ROM 53d, video RAM 53e, and a VDP (video display processor) 53f, as shown in FIG. 8. The mage control CPU 53a determines the image to be displayed on the main display 11, the subdisplay 12 in accordance with an image control program (concerning display of the main display 11, the subdisplay 12) previously stored in the program ROM 53c based on a parameter set in the microcomputer 41. The work RAM 53b is implemented as a temporary storage unit when the image control CPU 53a executes the image control program.

The program ROM 53c stores the image control program, various selection tables, etc. The image ROM 53d stores dot data to form images. The video RAM 53e is implemented as a temporary storage unit when the VDP 53f forms an image. The VDP 53f has control RAM 53g and forms an image responsive to the display of the main display 11, the subdisplay 12 determined by the image control CPU 53a and outputs the formed image to the main display 11, the subdisplay 12.

The sound control circuit 54 inputs a sound signal for outputting a sound from the loudspeakers 13L and 13R into the loudspeakers 13L and 13R. For example, a sound to liven up the game is output from the loudspeakers 13L and 13R at an appropriate timing after the game starts.

Configurations of Arcade Server, Card Selling Machine, and in-Arcade Router

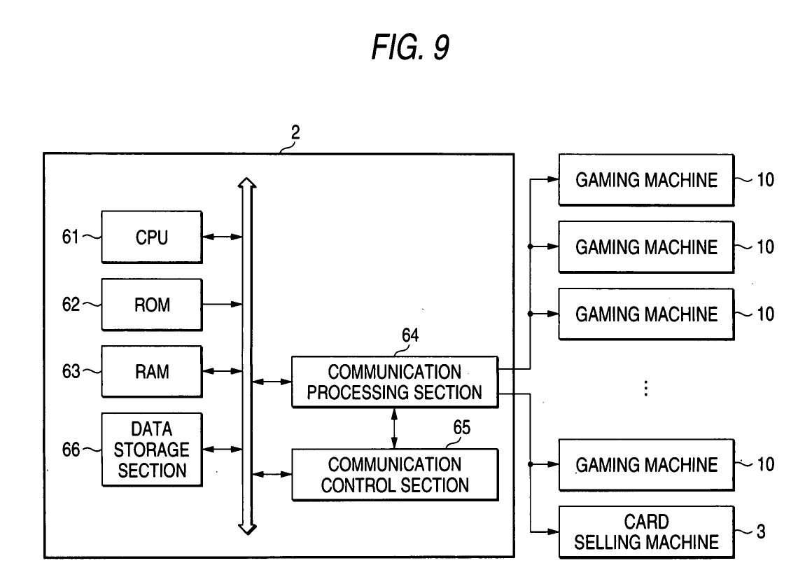

The arcade server 2 has a CPU 61, ROM 62, RAM 63, a communication processing section 64, a communication control section 65, and a data storage section 66 storing application data, as shown in FIG. 9. The CPU 61 operates while reading and writing data from and into the RAM 63 in accordance with a program stored in the ROM 62 and on the other hand, the communication control section 65 causes the communication processing section 64 to operate in accordance with an instruction of the CPU 61. The arcade server 2 transmits and receives data to and from each game machine 10 installed in each game arcade A, B via the dedicated line C₁ and transmits (downloads) application data to each game machine 10 and relays data transmission and reception between the gaming machines 10 and between each gaming machine 10 and the center server group 5. The application data contains various pieces of data used for executing a labyrinth battle game in the gaming machine 10 (game image data) and board data (a setting program to associate the operation buttons of the operation unit 19 with the labyrinth battle game).

The card selling machine 3 has an operation section for the player to input personal information and a card issuing unit. As the player performs predetermined input operation using the operation section, the card issuing unit issues an ID card 17 storing card information containing the player ID unique to each player.

The in-arcade router 4 connects the in-arcade LAN formed in each arcade A, B and a LAN formed in the center server group 5 through the communication line C₂ and the Internet NT.

Configuration of Center Server Group

The center server group 5 has a plurality of game servers installed in one-to-one correspondence with games (in FIG. 1, two game servers 6A and 6B) and a database server 7 and the game servers are connected via a dedicated line C₃ to form the LAN and the LAN is connected to the Internet NT through a router (not shown).

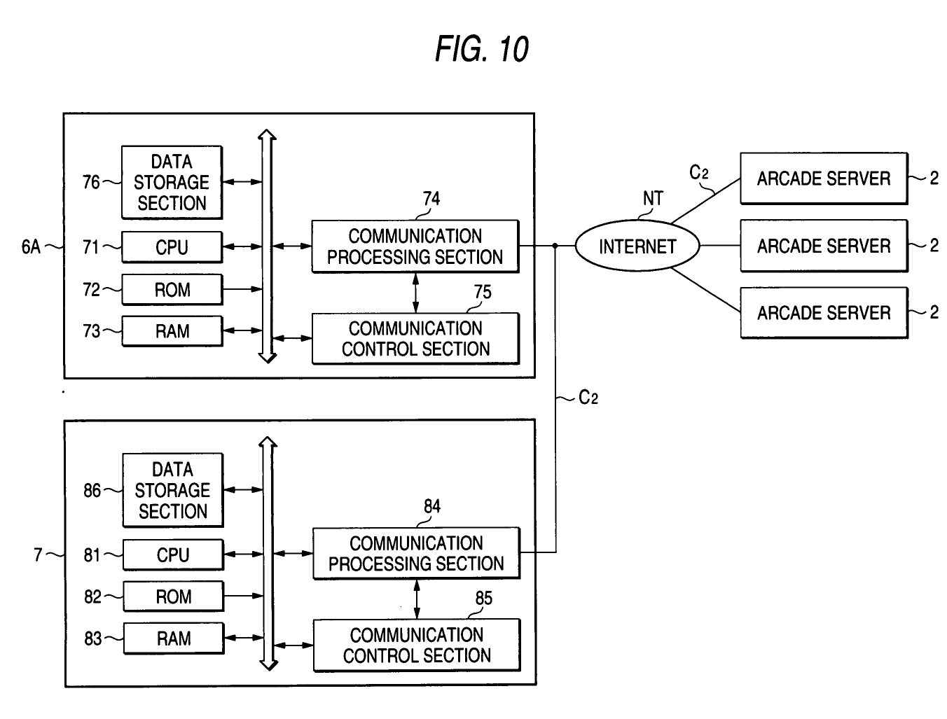

The game server 6A is installed for executing a labyrinth battle game and has a CPU 71, ROM 72, RAM 73, a communication processing section 74, a communication control section 75, and a data storage section 76, as shown in FIG. 10. In the game server 6A, the CPU 71 operates while reading and writing data from and into the RAM 73 in accordance with a program stored in the ROM 72 and on the other hand, the communication control section 75 causes the communication processing section 74 to operate in accordance with an instruction of the CPU 71.

The game server 6A transmits and receives data to and from each arcade server 2 through the Internet NT. The game server 6A receives entry data (described later) transmitted from each gaming machine 10, accepts entry of a player in a labyrinth battle game, updates entry information of the player, determines a player of an opponent, and transmits the result to the database server 7.

The game server 6B is installed for executing a game different from the game provided by the game server 6A; it differs from the game server 6A in stored data and programs and has the same system configuration as the game server 6A.

The database server 7 has a CPU 81, ROM 82, RAM 83, a communication processing section 84, a communication control section 85, and a data storage section 86. In the database server 7, the CPU 81 operates while reading and writing data from and into the RAM 83 in accordance with a program stored in the ROM 82 and on the other hand, the communication control section 85 causes the communication processing section 84 to operate in accordance with an instruction of the CPU 81 and transmits and receives data to and from each arcade server 2 through the Internet NT. The data storage section 86 stores the player ID, the password used to authenticate the player, the game type, and game data. The player ID is read from the ID card 17 and is transmitted by the gamin machine 10.

As described above, each player sets his or her used FIG. 30 in the figure installation unit 15 in the gaming machine 10 and the figure ID of the figure storage information is read, whereby the read figure ID of the figure 30 is transmitted from the gaming machine 10 to the database server 7. In the database server 7, an ID management file in which a plurality of figure IDs can be associated with one player ID transmitted from the gaming machine 10 for storage is formed in the data storage section 86. The players and the figures used by the players are managed according to the ID management file. The ID management file is used to authenticate the players and the figures as described later.

The game data contains character unique data to characterize each of the characters appearing in a labyrinth battle game (information indicating the costume of each character, the costume color, the character capability values containing a defense parameter, an attack parameter, and the attack range, special capability, etc., which will be hereinafter referred to as “figure information”) and data indicating the labyrinth battle game history for each player. The game data is transmitted from the database server 7 to the gaming machine 10 and is used in a labyrinth battle game.

Operation Description of Gaming Machine

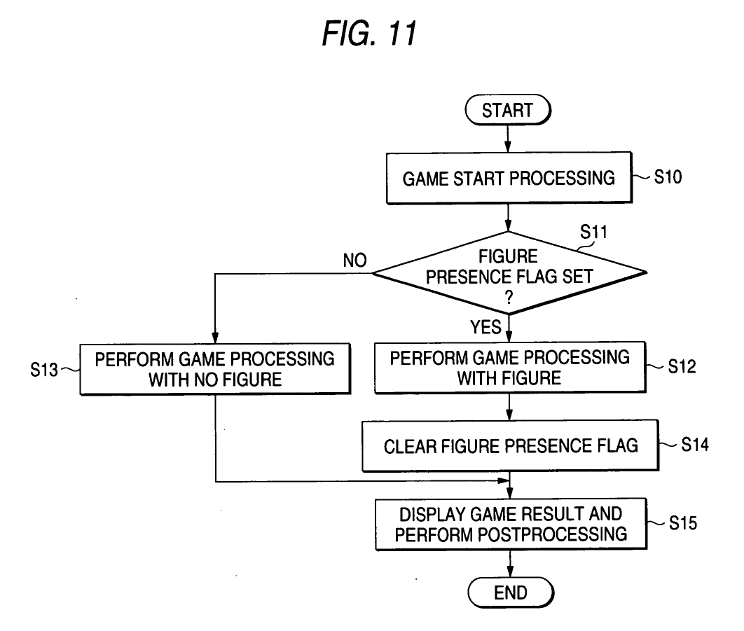

Next, the operation of the described gaming machine 10 will be discussed with reference to flowcharts of FIGS. 11 to 14. In the description to follow, the case where players operate four of the eight gaming machines 10 installed in the game arcade A to play the same labyrinth battle game is taken as an example.

FIG. 11 is a flowchart to show an operation procedure of game processing from game start to game end in each gaming machine 10. Each step in FIGS. 11 to 14 is abbreviated as S. In the description to follow, one of the gaming machines 10 operated by the four players is taken as an example.

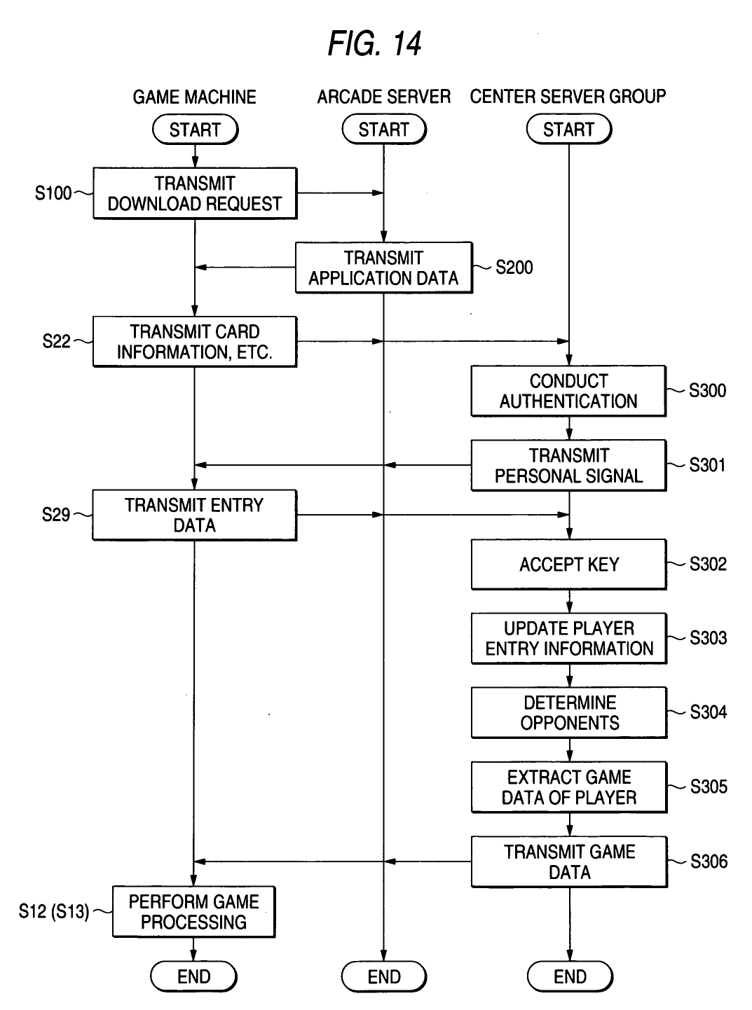

When power is turned on, the gaming machine 10 transmits an application data download request to the arcade server 2 (step 100 described later). On the other hand, upon reception of the download request, the arcade server 2 transmits application data to the gaming machine 10 transmitting the download request (see FIG. 14).

Upon reception of the application data, the gaming machine 10 stores the application data in the RAM 43. When the main CPU 42 reads the application data, it allows the labyrinth battle game to proceed in response to operation input of the player. At this time, the main CPUs 42 of the gaming machines 10 synchronize with each other through the arcade server 2 and the center server group 5 for displaying the game image on each main display 11.

At this time, when starting game processing, the gaming machine 10 goes to step 10 and performs game start processing containing coin input, ID card insertion, and character generation processing (described later). At step 11, whether or not a figure presence flag is set to predetermined data from the result of the game start processing and the process goes to step 12 or 13 in response to the determination result. That is, when the figure presence flag is set to predetermined data, the process goes to step 12; when the flag is not set to predetermined data, the process goes to step 13. The processing at step 12 or 13 is performed and then the figure presence flag is cleared at step 14 and then the process goes to step 15. The game result of the battle result, etc., is displayed. On the other hand, to update the game data in the database server 7, postprocessing of transmitting the data indicating the battle result to the database server 7 via the arcade server 2 is performed and the process is terminated.

Thus, the gaming machine 10 enables the player to play the labyrinth battle game regardless of the figure presence or no-figure mode. However, in the figure presence mode, the game content is more advantageous to the player than in the no-figure mode.

Game Start Processing

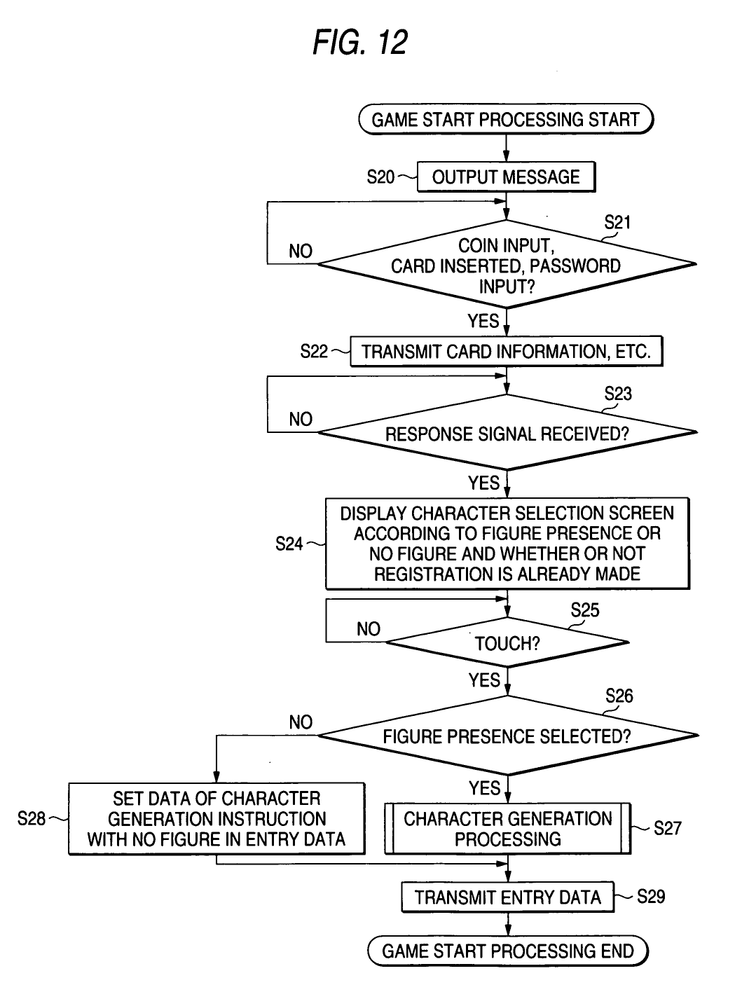

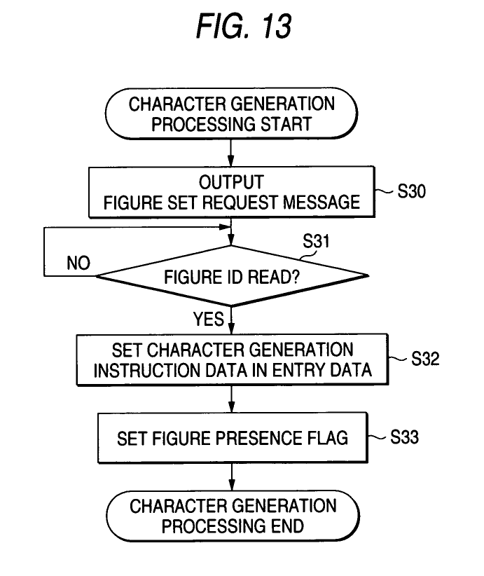

The game start processing at step 1 is performed according to a flowchart of FIG. 12. FIG. 12 is a flowchart to show an operation procedure of the game start processing, and FIG. 13 is a flowchart to show an operation procedure of the character generation processing.

When the game start processing is started, the main CPU 42 goes to step 20 and performs message output processing and instructs the image control circuit 53 to display a predetermined message (coin input request, ID card insertion request, and password input request) on the main display 11. Subsequently, steps 21 and 22 are executed.

To start a game, the player inputs a coin through the coin insertion slot 16, inserts the ID card 17 into the card slot 18, and inputs the password through the operation unit 19. Then, a detection signal of the input coin is input from the coin sensor 16a to the main CPU 42, and the card information stored on the ID card 17 is input from the card reader 18a. Further, the password is input from the operation unit 19. When they are all input, the process goes to step 22 and the main CPU 42 instructs the communication control section 51 to operate the communication processing section 52 for transmitting the read card information and the input password to the arcade server 2.

At step 23, the process waits until reception of a response signal from the arcade server 2. Upon reception of a response signal, an instruction is given at step 24 for displaying a selection screen on the main display 11 for the player to select any of selectable characters according to figure presence or no figure and whether or not authentication (registration) has been conducted from the response signal. At step 25, the process waits until the player touches the touch panel 11a. When the player touches the touch panel 11a, the process goes to step 26 and whether or not figure presence is selected at step 24 is determined. If figure presence is selected, the process goes to step 27; otherwise, the process goes to step 28. At step 27, the character generation processing described later is performed; at step 28, data of a character generation instruction with no figure is set in entry data described later. Then, the process goes to step 29. More particularly, at step 26, if the player selects figure presence when a figure is first used or when an already authenticated figure is first used or when an already already authenticated figure is used, the process goes to step 27 and the character generation processing is performed. When no figure is used from the beginning or when an already authenticated figure exists and is not used, if the player selects no figure, the process goes to step 28.

At step 27, the main CPU 42 performs the character generation processing according to the flowchart of FIG. 13. When the character generation processing is started, the process goes to step 30 and figure set request message output processing is performed. Here, the main CPU 42 instructs the image control circuit 53 to display on the main display 11 a message for requesting the player to place the figure; 30 in the figure installation unit 15 for reading the figure ID (for example, “Set the pedestal of the figure in the figure installation unit on the operation unit. When authentication of the figure starts, the figure installation unit is lighted brightly. Do not remove the figure before the light is turned off. “). At step S31, the process waits until reading the figure ID is complete. When the player sets the figure 30 in the figure installation unit 15 following the displayed message, the figure installation unit 15 reads the figure ID stored in the IC chip 34 of the figure 30 and inputs the figure ID into the main CPU 42. Then, the process goes to step 32 and the main CPU 42 sets character generation instruction data containing the read figure ID in the entry data. At step 33, the figure presence flag indicating reading of the figure ID of the figure 30 (setting of the figure) is set to predetermined data (in the embodiment, “1”). The character generation processing is now complete.

Thus, when the figure is set, the gaming machine 10 sets the figure presence flag to predetermined data. Once the figure is set, the entry data containing the character generation instruction data is transmitted to the database server 7 via the arcade server 2. In the database server 7, the figure ID is stored in the ID management file in association with the player ID unique to the player setting the figure and is used to determine whether or not the figure is already authenticated. The determination result as to whether or not the figure is already authenticated according to the ID management file is transmitted as a response signal from the database server 7, so that the player can select the character corresponding to the already authenticated figure and play a labyrinth battle game. However, if the figure is not set, the figure presence flag is not set and therefore even if the figure is already authenticated, the figure 30 needs to be set in the figure installation unit 15 for reading the figure ID for the player to play a labyrinth battle game in the figure presence mode. When the figure is set, the figure information corresponding to the read figure ID is generated in the database server 7 and the player can play a labyrinth battle game without repeating setting the figure 30.

When the process goes to step 27 of the game start processing, the main CPU 42 instructs the communication control section 51 to operate the communication processing section 52 for transmitting the entry data to the arcade server 2. The game start processing is now complete.

On the other hand, in the gaming machine 10, the arcade server 2, and the center server group 5, processing is executed in the order shown in FIG. 14 corresponding to the processing described above. FIG. 14 is a sequence chart to show an operation sequence executed among the gaming machine 10, the arcade server 2, and the center server group 5.

The gaming machine 10 transmits a download request to the arcade server 2 and downloads application data at step 100 and transmits the card information, etc., at step 22 as described above. Then, the center server group 5 goes to step 300 and the CPU 81 in the database server 7 performs authentication processing of determining whether or not the player and the figure are registered by referencing the ID management file, etc., using the card information and the password transmitted from the gaming machine 10. If they are already registered, they are determined already authenticated and the process goes to step 301 and a response signal indicating the authentication result is transmitted to the gaming machine 10. In this case, the database server 7 performs similar authentication processing for the eight gaming machines 10 installed in each of the arcades A and B.

The gaming machine 10 also transmits the entry data at step 29 described above. Then, the center server group 5 goes to step 302 and the game server 6A accepts entry of the player using the entry data from each gaming machine 10. Further, at step 303, entry information of the player is updated and the figure is registered or updated in the ID management file and figure information is generated or updated using the figure ID corresponding to the character generation instruction data (the figure ID contains the figure IDs of both an unauthenticated and newly registered figure and an already authenticated figure to be again authenticated). At step 304, the players of the opponents (in the embodiment, four) are determined. At step 305, the database server 7 extracts the game data of the players of the opponents and goes to step 306 and transmits the extracted game data to the arcade server 2. Upon reception of the game data, the arcade server 2 transmits the game data to each gaming machine 10.

Light Emission Mode of LED Unit

While the game processing with figure (step 12) described above is executed, the LED unit emits light in response to the gaming state of the labyrinth battle game based on the figure ID read at step 31.

That is, in the game processing with figure, the main CPU 42 operates as a game progress control unit for allowing the labyrinth battle game (image game) to proceed and operates as a light emission mode determination unit for determining the light emission mode of the LED unit 21 based on the gaming state of the home gaming machine (usual state, battle state, etc.,), game relevant information (information of battle result, opponents, etc.,) received from the center server group 5 and the arcade server 2 through the communication processing section 52 and the light emission mode database 44a stored in the ROM 44 whenever necessary.

A more specific description is given with reference to FIG. 7. When the figure 30 with the figure ID “B1001” is set in the figure installation unit 15, the main CPU 42 operating as the light emission mode determination unit sets the light emission mode of the LED unit 21 to the “light emission mode 1-A” when the battle state is not entered; to the “light emission mode 1-B” when the battle state is entered. When information concerning the battle result is sent from the arcade server 2, the main CPU 42 sets the light emission mode to the “light emission mode 1-C” of the win state or the “light emission mode 1-D” of the loss state based on the information.

When the main CPU 42 thus determines the light emission mode, the light emission control circuit (a light emission control unit) 50 controls light emission of the LED unit 21 in accordance with the determined light emission mode.

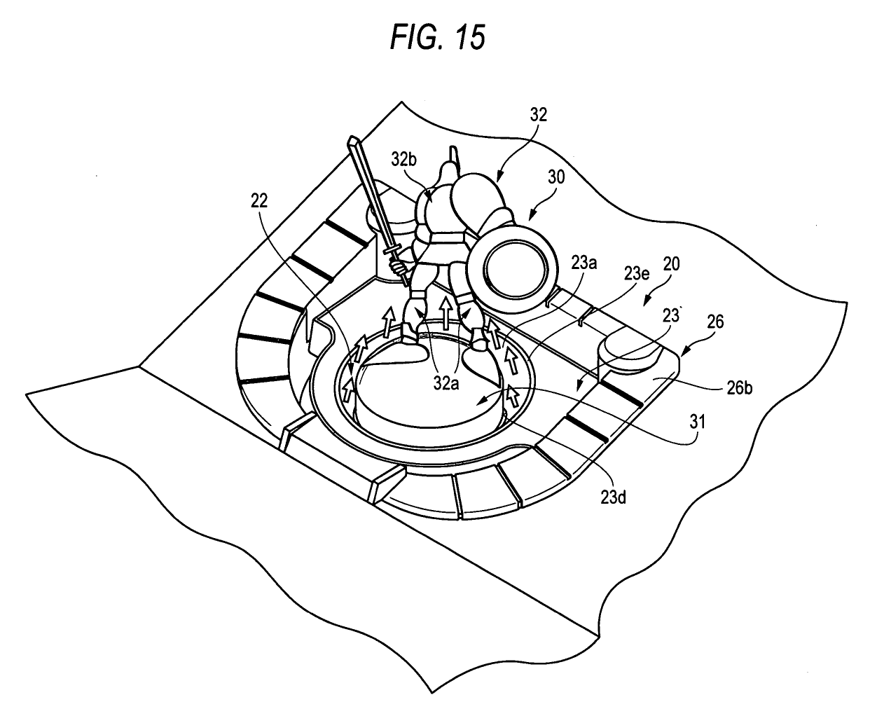

When light is emitted from the LED unit 21 following the light emission mode, the emitted light passes through the inside of the holding member 23 of the figure installation unit 15 and illuminates the figure 30 from below from the peripheral wall face 23a as shown in FIG. 15. Thus, a part of the light applied from the peripheral wall face 23a of the holding member 23 hits an incidence part of the figure main body 32 of the FIG. 30 (for example, a leg part 32a of the figure main body 32). Since the figure main body 32 of the figure 30 is formed of a material having translucency as described above, a part of the light hitting the incidence part 32a of the figure main body 32 of the figure 30 is made incident on the inside of the figure main body 32 from the incidence part and while it is repeatedly reflected and refracted appropriately, it passes through the figure main body 32 and is emitted from an emission part (for example, a trunk part 32b of the figure main body 32).

Then, the player can be given the visual effect as if the color of the figure 30 placed for enabling the player to visually recognize the figure 30 changed because of the emitted light from the emission part 32b of the figure main body 32 in addition to the reflected light on the surface of the figure main body 32.

As described above in detail, in the gaming machine 10, when the figure storage information is read from the IC chip 34 contained in the pedestal 31 of the figure 30 through the IC chip reader/writer 20 of the figure installation unit 15, the main CPU 42 determines the light emission mode of the LED unit 21 based on the light emission mode database 44a based on the figure ID contained in the figure storage information, the gaming state of the home gaming machine, and the external information received through the communication processing section 52, and the light emission control circuit 50 controls light emission of the LED unit 21 in accordance with the light emission mode determined by the main CPU 42. The light reaching the incidence part 32a of the figure main body 32 of the figure 30 from the LED unit 21 passes through the inside of the figure main body 32 of the figure 30 and is emitted from the emission part 32b to the outside. Therefore, in the gaming machine 10, when the light emission mode of the LED unit 21 is changed based on the figure ID stored in the IC chip 34 of the figure 30, the light emitted from the emission part 32b of the figure 30 changes and the appearance of the figure 30 is seen in a different way. That is, the gaming machine 10 enables the appearance of the figure 30 to be changed without exchanging the figure 30 for another, so that interest to the player can be kept sufficient. Particularly, the full-color LED unit 21 capable of emitting light of different colors is adopted as the light emission body, so that the light emission modes richer in variety can be provided.

The main CPU 42 operating as the light emission mode determination unit determines the light emission mode of the LED unit 21 based on not only the figure ID contained in the figure storage information, but also the information from the arcade server 2 received by the communication processing section 52, so that the light emission modes rich in variety can be provided and accordingly interest to the player can be kept.

Since it is assumed that each player owns the figure 30 described above, the number of the figures 30 is by far larger than the number of the gaming machines 10. As the LED unit 21 is attached to each gaming machine 10, the number of provided LED units 21 can be decreased as compared with the case where each figure 30 is provided with the LED unit 21. Since the gaming machine 10 determines the color of the light incident on the figure 30, the same light emission control can be easily realized in the same gaming state without depending on the figure storage information of the figure ID, etc. Further, the figure 30, which need not contain the LED unit 21, can be manufactured at low cost.

The light emission mode need not necessarily be changed only by change in the four types of gaming state described above; for example, the light emission mode can be changed in any of various gaming states, for example, when the level is raised, when a specific item is obtained, when a specific character appears, etc. In the first embodiment, the figure ID of the figure storage information is used as the game information, but the game battle history, the capability value, the growth degree, etc., may be stored directly in the IC chip 34 for use as the game information, for example.

In the first embodiment, the emitted light from one full-color LED unit provided in the lower part of the figure installation unit 15 is made incident on the incidence part 32a of the figure 30 through the holding member 23, but the installation number and the installation positions of the light emission bodies of the LED units, etc., can be changed whenever necessary.

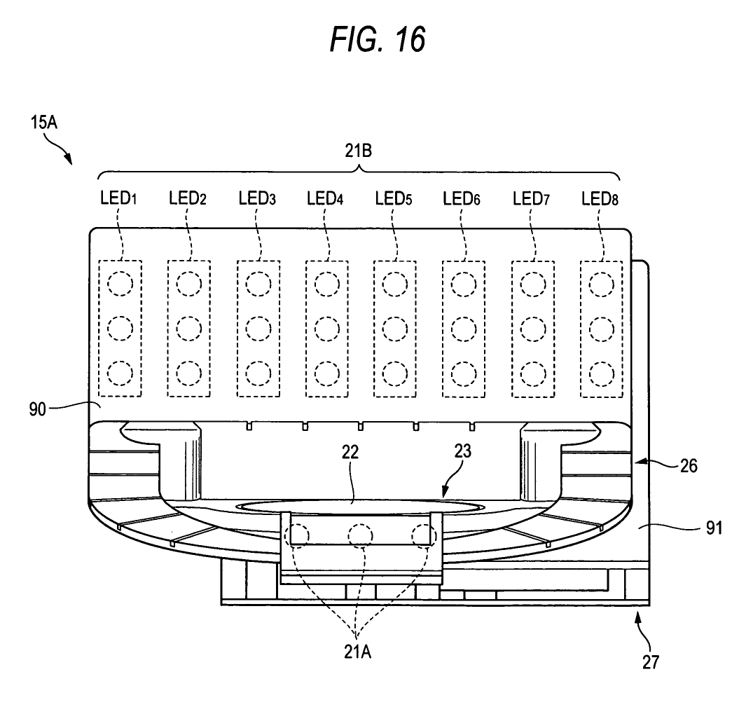

For example, the figure installation unit 15 described above can also be changed to a figure installation unit 15A as shown in FIGS. 16 to 18.

The figure installation unit 15A differs from the figure installation unit 15 described above mainly in that it has a rear transmission panel 90, a rear plate 91, and an LED support plate 92 placed between the rear transmission panel 90 and the rear plate 91.

The rear transmission panel 90 is a panel having translucency installed so as to be upright like a flat plate in the rear portion of a holding member 23 in a frame 26b of a holding frame 26. The rear plate 91 is a part of a base 27 and is upright at the depth from the rear transmission panel 90. Further, a lower light emission body 21A made up of LEDs 21 arranged in one horizontal row at the height position corresponding to the LED unit 21 described above and a side light emission body 21B made up of 24 LEDs 21 (3 LEDs×8 LEDs) placed above the lower light emission body 21A are attached to the LED support plate 92. That is, the side light emission body 21B is placed as LED₁ to LED₈ each made up of three LEDs are arranged in order from left to right, as shown in FIG. 16.

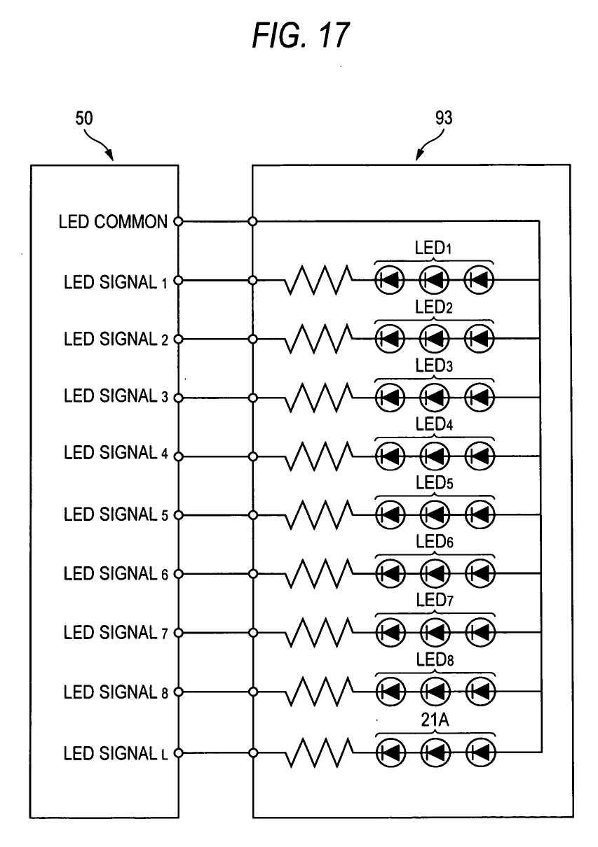

In the gaming machine including the figure installation unit 15A, each LED 21 of the lower light emission body 21A and the side light emission body 21B corresponds to light emission body in the invention and the LEDs 21 are controlled by the light emission control circuit 50 described above. FIG. 17 is a circuit diagram to show the light emission control circuit 50 and an LED circuit 93 wherein the LED₁ to the LED₈ making up the side light emission body 21B are connected in parallel. The light emission control circuit 50 has an LED common line for outputting a signal common to the LED₁ to the LED₈ making up the side light emission body 21B and an LED signal line ₁ to an LED signal line ₈ for outputting signals for separately lighting the LED₁ to the LED₈ as shown in FIG. 17. In the LED circuit 93, the LED₁ to the LED₈ are connected in parallel to a common line connected to the LED common line and the LED₁ to the LED₈ (each made up of three LEDs) are connected in series to the LED signal line ₁ to the LED signal line ₈ respectively each via a resistor. The light emission control circuit 50 further has an LED signal line _{L} for outputting a signal for lighting the lower light emission body 21A.

When the main CPU 42 operates as the light emission mode determination unit, preferably it uses a database equal to the light emission mode database 44a shown in FIG. 7; the light emission mode may be defined for each of the LED₁ to the LED₈ or for each LED 21 in each gaming state. In this case, various light emission modes can be provided as compared with the case where one light emission body is used, so that the interest in playing a game is furthermore improved.

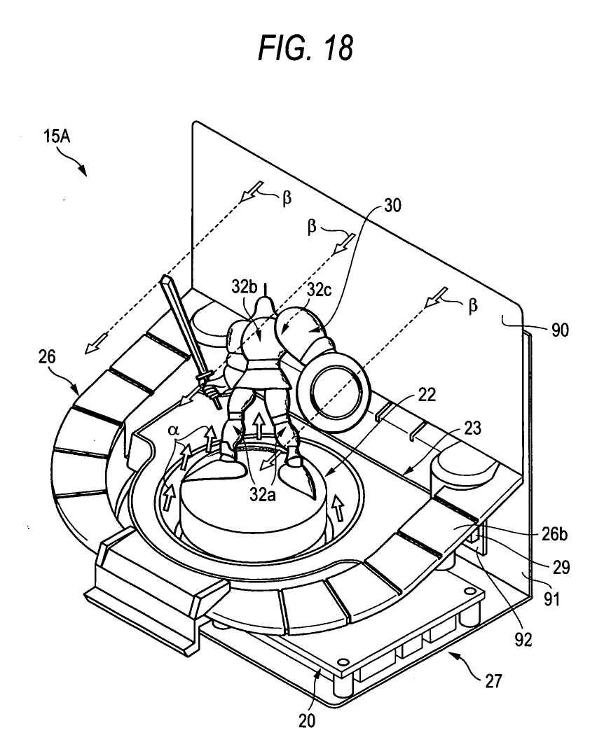

In the light emission state of the LED 21 in the figure installation unit 15A described above, application light α from below and application light β from the rear are applied to the figure 30 as shown in FIG. 18. That is, the light emitted from the lower light emission body 21A passes through the holding member 23 and light α is emitted from a peripheral wall face 23a of the holding member 23, illuminating the figure 30 from below. Light β emitted from the side light emission body 21B passes through the rear transmission panel 90, illuminating the figure 30 from the rear. Thus, a part of the application light a and a part of the application light β hit the incidence parts of the figure main body 32 of the figure 30 (for example, the leg part 32a and a rear part 32c of the figure main body 32) and passes through the inside of the figure main body 32 of the figure 30 and is emitted from the emission part (for example, the trunk part 32b of the figure main body 32).

That is, in the gaming machine adopting the figure installation unit 15A, the player can also be given the visual effect as if the color of the figure 30 placed for enabling the player to visually recognize the figure 30 changed as in the gaming machine 10 adopting the figure installation unit 15 described above. Particularly, with the figure installation unit 15A, the application light a and the application light β are applied to the figure 30 from a plurality of directions, so that the more complicated visual effect can be provided.

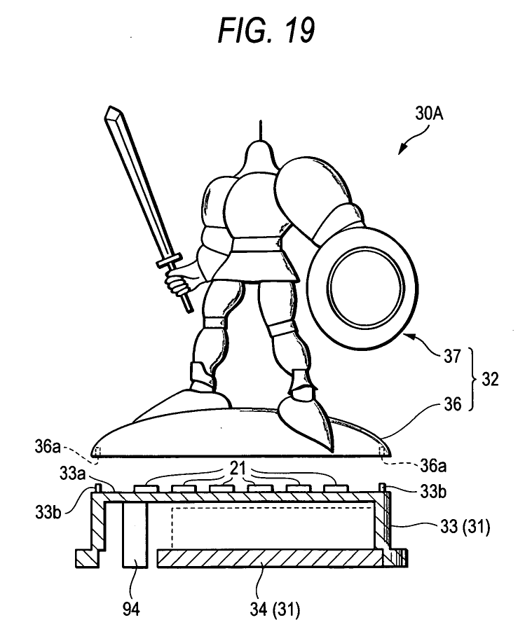

To provide the visual effect equal to the effect described above, a figure 30A containing LEDs 21 as shown in FIG. 19 can also be used. That is, the figure 30A differs from the figure 30 in that six LEDs 21 are provided in a top part 33a of a pedestal 31, that the pedestal 31 is provided with a terminal 94 to which an electric signal for the LEDs 21 is input, and that a projection part 33b is provided in an end part of the top part 33a of the pedestal 31. To adopt the figure 30A, the gaming machine like the gaming machine 10 need not have the LEDs 21 and an electric signal from the light emission control circuit 50 is sent directly to the figure 30A. That is, in the gaming machine incorporating the figure 30A, the electric signal for the LEDs 21 of the figure 30A is sent from the light emission control circuit 50 through the terminal 94 to the figure 30A in accordance with the light emission mode determined by the main CPU 42 as the light emission mode determination unit, and the LEDs 21 of the figure 30A emit light. This means that the LEDs 21 of the figure 30A are controlled by the light emission control circuit 50.

The light emitted from the LEDs 21 contained in the figure 30A is made incident on the inside of a figure main body 32 from a foot pedestal section (incidence section) 36 of the figure main body 32. Then, the light passes through the figure main body 32 and is emitted from an emission section (for example, a figure section 37 of the figure main body 32). The player can be given the visual effect as if the color of the FIG. 30A placed for enabling the player to visually recognize the figure 30A changed because of the emitted light from the emission section 37, so that interest to the player can be kept sufficient as in the embodiment described above. Particularly, with the figure 30A, the number of the LEDs 21 or the types of light emitting elements of LEDs 21 can be changed for each FIG. 30A. Thus, if the electric signal from the light emission control circuit 50 is uniform, various light emission modes can be provided for each figure 30A. The light emission mode responsive to the type (group), the strength, etc., of the figure 30A can be easily realized as compared with the case where the LED 21 is provided in the gaming machine 10.

### Second Embodiment

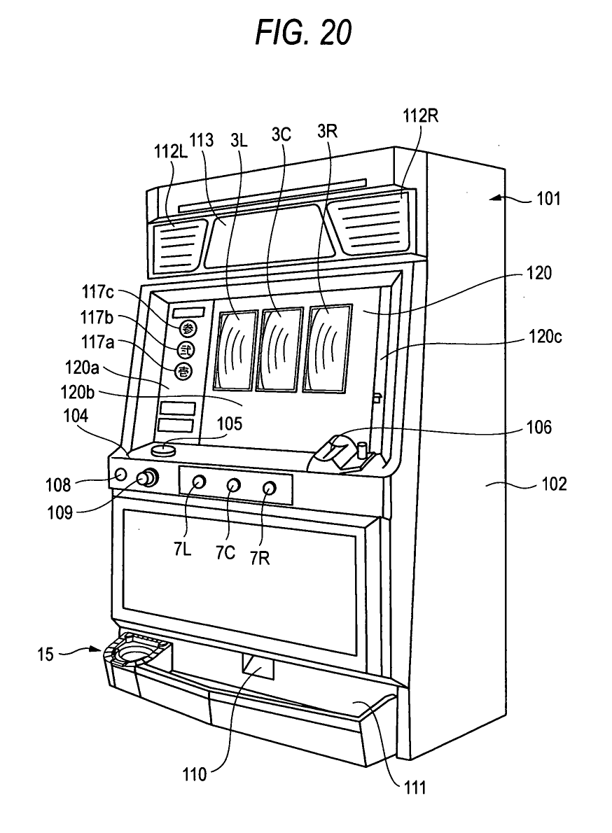

Next, a Pachi-Slot machine of a gaming machine according to a second embodiment of the invention will be discussed. FIG. 20 is a perspective view to show the overall configuration of a Pachi-Slot machine 101 according to the second embodiment of the invention. The Pachi-Slot machine 101 has a variable display unit for variably displaying a plurality of symbols in a plurality of rows and variably displays a plurality of reels by the variable display unit, enabling a player to play a game.

General Configuration of Pachi-Slot Machine

The Pachi-Slot machine 101 has an image display section 120 on the front of a cabinet 102 and has three mechanical reels 3L, 3C, and 3R placed in one horizontal row for rotation at the rear of the image display section 120 in the cabinet 102. The reels 3L, 3C, and 3R can be visually recognized from the outside. The reels 3L, 3C, and 3R have each a symbol row with 21 different symbols drawn on the outer peripheral surface, and make up the rotatable variable display unit for variably displaying the symbols.

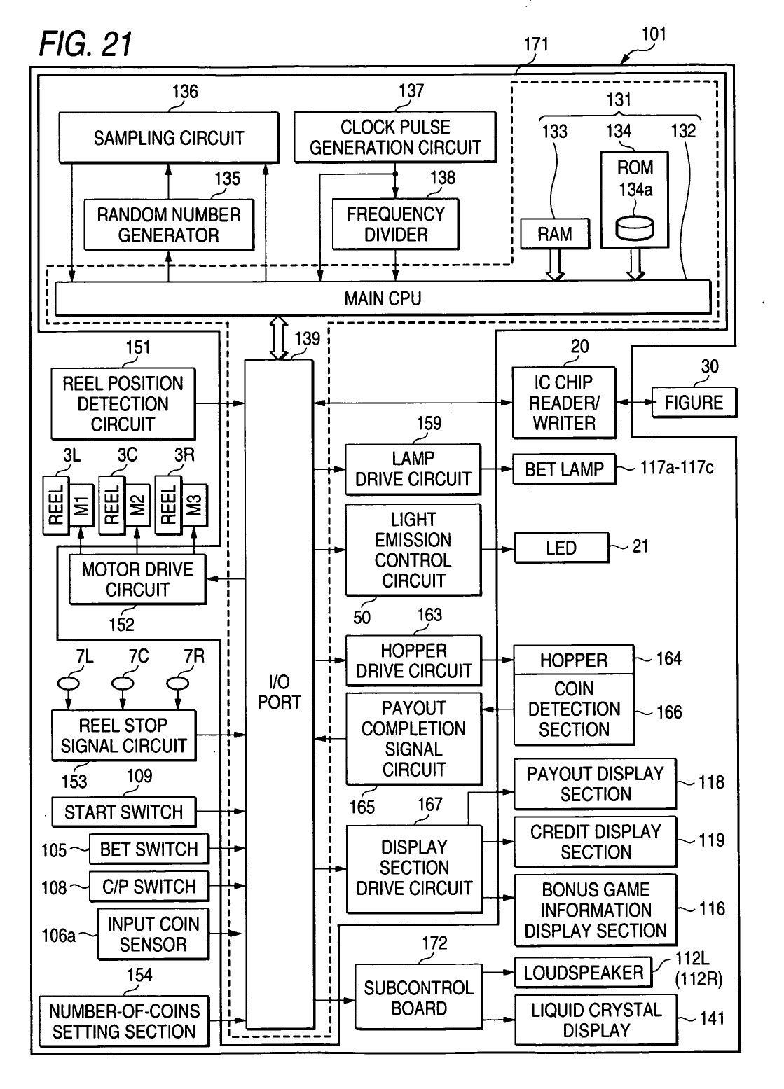

The Pachi-Slot machine 101 has an image display section frontward projection portion 104 below the image display section 120, a BET switch 105 for the player to make setting to bet a credited coin by pushbutton operation at the left of the frontward projection portion 104, and a coin insertion slot 106 for the player to input a coin at the right of the frontward projection portion 104. The coin insertion slot 106 has an input coin sensor 106a for outputting a signal indicating coin input (see FIG. 21).

The Pachi-Slot machine 101 further has a C/P switch 108 for the player to switch between credit and payout of a gained coin in a game and a start switch 109 from left to right on the front of the frontward projection portion 104 and three stop buttons 7L, 7C, and 7R at the front center of the frontward projection portion 104. The start switch 109 is a switch for the player to perform start operation of variable display of the symbols with rotation of the reels 3L, 3C, and 3R (game start operation). The stop buttons 7L, 7C, and 7R are provided as a stop operation unit for the player to stop rotation of the reels 3L, 3C, and 3R (scroll display).

The Pachi-Slot machine 101 also has a figure installation unit 15 similar to the figure installation unit 15 in the first embodiment, a coin payout opening 110, and a coin receiving tray 111 for collecting paid-out coins at the bottom of the cabinet 102, has loudspeakers 112L and 112R on the left and the right above the image display section 120 of the cabinet 102, and has an award display panel 113 between the loudspeakers 112L and 112R.

FIG. 21 is a block diagram of the Pachi-Slot machine 101 shown centering on the internal configuration thereof. The Pachi-Slot machine 101 has a plurality of components centering on a main control board 171 including a microcomputer 131. The main control board 171 has the microcomputer 131, a random number generator 135, a sampling circuit 136, a clock pulse generation circuit 137, a frequency divider 138, a lamp drive circuit 159, a hopper drive circuit 163, a payout completion signal circuit 165, a display section drive circuit 167, and a light emission control circuit 50.

The microcomputer 131 has a main CPU (Central Processing Unit) 132, RAM (Random Access Memory) 133, and ROM (Read-Only Memory) 134. The main CPU 132 operates in accordance with a program stored in the ROM 134 and inputs/outputs a signal from/to other components via an I/O port 39 for controlling the whole operation of the Pachi-Slot machine 101. The main CPU 132 implements a game mode control unit in the invention. That is, as a predetermined condition of the arrangement result of the stop symbols, etc., holds, the main CPU 132 causes the gaming mode to make a transition from a usual game (usual gaming mode) to a bonus game (special gaming mode) for enabling the player to expect a large number of paid-out medals.

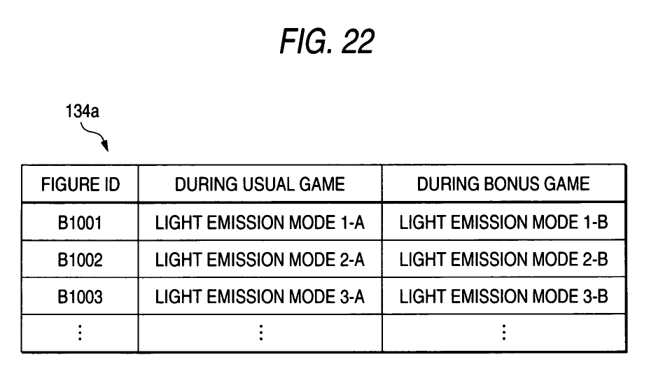

The RAM 133 stores data and a program used for the main CPU 132 to operate; for example, it temporarily retains the random number value sampled by the sampling circuit 136 described later after a game starts, and also stores the code numbers and the symbol numbers of the reels 3L, 3C, and 3R. The ROM 134 stores programs executed by the main CPU 132 and permanent data. In the Pachi-Slot machine 101, the ROM 134 stores a light emission mode database 134a shown in FIG. 22. That is, the light emission mode database 134a stores the light emission modes during a usual game and the light emission modes during a bonus game for each figure ID.

The random number generator 135 operates in accordance with an instruction of the main CPU 132 and generates random numbers in a given range. The sampling circuit 136 extracts any random number from among the random numbers generated by the random number generator 135 in accordance with an instruction of the main CPU 132 and inputs the extracted random number into the main CPU 132. The clock pulse generation circuit 137 generates a reference clock to operate the main CPU 132, and the frequency divider 138 inputs a signal provided by dividing the reference clock with a given period into the main CPU 132.

Further, a reel drive unit 150 and a reel stop signal circuit 153 are connected to the main control board 171. The reel drive unit 150 has a reel position detection circuit 151 for detecting the positions of the reels 3L, 3C, and 3R and a motor drive circuit 152 for inputting a drive signal into motors M1, M2, and M3 for rotating the reels 3L, 3C, and 3R. The drive signal is input from the motor drive circuit 152, whereby the motors M1, M2, and M3 operate and rotate the reels 3L, 3C, and 3R. The reel stop signal circuit 153 outputs a stop signal responsive to stop operation of each stop button 7L, 7C, 7R and inputs the stop signal into the microcomputer 131 through the I/O port 139. In addition, the start switch 109, the BET switch 105, the C/P switch 108, and the input coin sensor 106a are connected to the main control board 171 and a signal is input to the main control board 171 from the components.

The lamp drive circuit 159 outputs a signal for lighting various lamps (BET lamps 117a, 117b, and 117c). The hopper drive circuit 163 drives a hopper 164 under the control of the main CPU 132, and the hopper 164 operates for paying out a coin and causes a coin to be paid out from the coin payout opening 110. The payout completion signal circuit 165 inputs the number-of-coins data from a coin detection section 166 connected to the payout completion signal circuit 165 and when the number of coins reaches the setup value, inputs a signal reporting the coin payout completion into the main CPU 132. The coin detection section 166 counts the number of coins paid out by the hopper 164 and inputs the data of the counted number of coins into the payout completion signal circuit 165. The display section drive circuit 167 controls the display operation of display sections (a payout display section 118, a credit display section 119, and a bonus game information display section 116).

The light emission control circuit 50 outputs a light emission signal to each light emission element (red light emission element, blue light emission element, green light emission element) of an LED unit 21 of the figure installation unit 15 in accordance with an instruction of the main CPU 132. An IC chip reader/writer 20 connected to the I/O port 139 reads figure storage information from an IC chip 34 of a figure 30 and inputs the figure storage information into the main CPU 132 and writes information from the main CPU 132 into the IC chip 34 to update the figure storage information, as required.

Further, a subcontrol board 172 is connected to the main control board 171. The subcontrol board 172 inputs a control instruction (command) from the main control board 171 and performs display control of a liquid crystal display 141 (which implements the image display section 120 and is placed at the front of the reels 3L, 3C, and 3R for producing transparent display in a part) and performs output control of a sound produced by the loudspeakers 112L and 112R. The subcontrol board 172 is implemented on a circuit board separate from the circuit board implementing the main control board 171. It has a microcomputer not shown (which will be hereinafter referred to as submicrocomputer) as the main component and also has a sound source IC for controlling the sound output from the loudspeakers 112L and 112R, a power amplifier, and an image control circuit operating as a display control unit of the liquid crystal display 141.

In the described Pachi-Slot machine 101, the reels 3L, 3C, and 3R rotate for producing variable display of the symbols as the player operates the start lever 109; the reels 3L, 3C, and 3R stop as the player operates the stop buttons 7L, 7C, and 7R. At this time, when the symbols stopped and displayed on a predetermined activated pay line become specific symbols in symbol display areas 121L, 121C, and 121R of the image display section 120, a medium used with a game, such as a medal or a coin, (which will be hereinafter referred to as coin), is paid out to the player. Further, the main CPU 132 operates as the game mode control unit and causes the gaming state to make a transition from the usual gaming state to a specific gaming state such as BB (big bonus) or RB (regular bonus) more advantageous to the player than the usual gaming state.

Operation Description of Pachi-Slot Machine

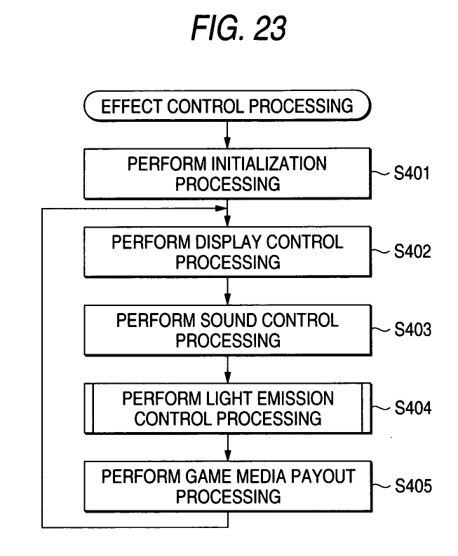

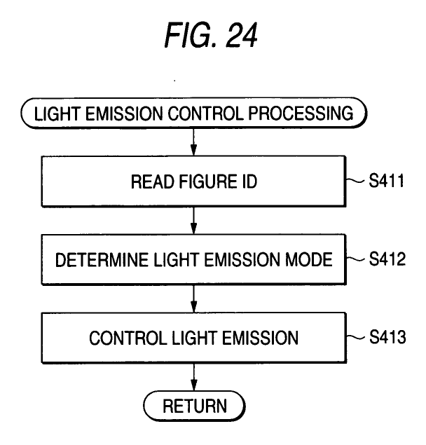

Next, the control processing procedure of the main control board 171 of the Pachi-Slot machine 101 will be discussed with reference to flowcharts of FIGS. 23 and 24. FIG. 23 is a flowchart to show the operation procedure of effect control processing executed by the main control board 171 in the Pachi-Slot machine 101. Each step in FIGS. 23 and 24 is abbreviated as S.

Operation Procedure of Effect Control Processing

When the main CPU 132 starts effect control processing, steps 401 to 405 are executed in order and initialization processing, display control processing, sound control processing, light emission control processing, and game media payout processing are executed in order. A loop of steps 402 to 405 is entered.

In the display control processing at step 402, the main CPU 132 instructs the subcontrol board 172 to display an image on the liquid crystal display 141. In the sound control processing at step 403, the main CPU 132 instructs the subcontrol board 172 to output a sound from the loudspeakers 112L and 112R.

Further, at step 404, the light emission control processing is performed. This light emission control processing is executed according to the flowchart of FIG. 24. That Is, when the light emission control processing is started, the process goes to step 411 and the figure ID is read through the IC chip reader/writer 20. At step 412, the main CPU 132 operates as a light emission mode determination unit and determines whether the current game state is the usual game state or the bonus game state and determines the light emission mode of the LED unit 21 from the light emission mode database 134a based on the figure ID read through the IC chip reader/writer 20. When the main CPU 132 determines the light emission mode, the process goes to step 413 and the light emission control circuit 50 controls light emission of the LED unit 21 in accordance with the determined light emission mode.

Therefore, also in the Pachi-Slot machine 101, the figure 30 shown in FIG. 5 is set in the figure installation unit 15, the light applied to the incidence part 32a of the figure main body 32 of the figure 30 form the LED unit 21 passes through the inside of the figure main body 32 of the figure 30 and is emitted from the emission part 32b to the outside. Therefore, also in the Pachi-Slot machine 101, the light emission mode of the LED unit 21 is changed based on the figure ID stored in the IC chip 34 of the figure 30, whereby the appearance of the figure 30 can be changed. Therefore, interest to the player can also be kept sufficient in the Pachi-Slot machine 101 like the gaming machine 10 shown in the first embodiment. The player repeats playing a game while expecting the transition to a bonus game; as the light emission mode is changed whenever necessary, a sense of player expectation grows and thus the interest to the player can be maintained and can be furthermore improved.

### Third Embodiment

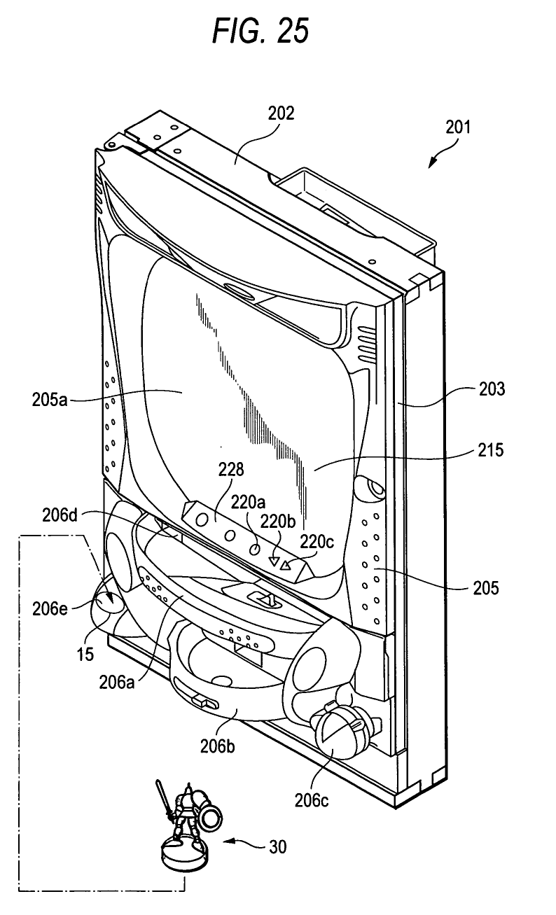

Next, a pachinko gaming machine of a gaming machine according to a third embodiment of the invention will be discussed. FIG. 25 is a perspective view to show the whole configuration of a pachinko gaming machine 201 according to the third embodiment. In the embodiment, the pachinko gaming machine 201 is a digital pachinko gaming machine (called digipachi, pachinko gaming machine of first kind).

Whole Configuration of Pachinko Gaming Machine

The pachinko gaming machine 201 shown in FIG. 25 includes an outer frame 202 housed and installed in a predetermined installation frame in a game arcade (hall). A base door (inner frame) 203 provided pivotally relative to the outer frame 202 is disposed on the front of the outer frame 202, and a game board (not shown) is built in the base door 203. A front door 205 is provided on the front of the outer frame 202. The front door 205 covers the front of the game board and is installed pivotally relative on the front of the base door 203.

A card unit for lending game balls in response to the balance on the prepaid card when a prepaid card, etc., is inserted is installed adjacent to the pachinko gaming machine 201.

The front door 205 includes a glass plate 205a roughly in all area in the center of the front door 205, enabling a player to visually recognize the game board inside the glass plate 205a. A ball lending operation panel 228 having ball lending operation relevant buttons for the player to perform card return operation of the card unit, game ball lending operation, etc., is provided in the lower part of the front door 205. The ball lending operation panel 228 is provided with a determination button 220a and selection buttons 220b and 220c for the player to perform predetermined operation.

A tray panel 206 that can be opened and closed relative to the outer frame 202 is installed below the front door 205. An upper tray 206a for receiving game balls lent from the card unit and game balls paid out when a ball enters a win opening (described later), a lower tray 206b for receiving game balls overflowing the inside of a ball exit 206d when the upper tray 206a is full, and a propelling handle 206c provided at the right of the lower tray 206b are placed on the front of the tray panel 206.

The propelling handle 206c is used to propel game balls in the upper tray 206a and is provided for rotation relative to the tray panel 206 and the player can operate the propelling handle 206c for advancing a pachinko game. When the player holds the propelling handle 206c and turns the handle clockwise, power is supplied to a propelling motor provided at the rear of the propelling handle 206c in response to the turn angle and game balls are propelled onto the game board in order.

The figure installation unit 15 described above is provided in an installation part 206e at the left of the lower tray 206b.

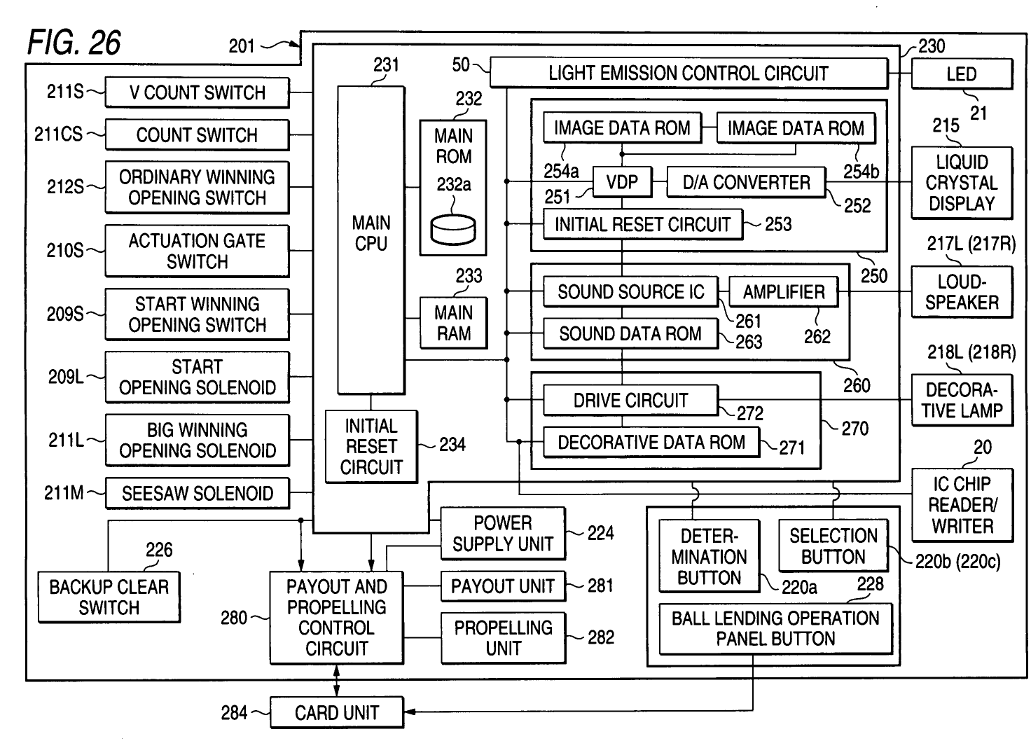

FIG. 26 is a block diagram of the pachinko gaming machine 201 shown centering on the internal configuration thereof. The pachinko gamin machine 201 has a plurality of components centering on a main control circuit 230, a payout and propelling control circuit 280, and a power supply unit 224. The power supply unit 224 is connected to the main control circuit 230 and the payout and propelling control circuit 280 and can supply power thereto. The main control circuit 230 has a main CPU (Central Processing Unit) 231 implemented as a one-chip microcomputer, main ROM (Read-Only Memory) 232, and main RAM (Random Access Memory) 233 and also has an initial reset circuit 234, an image control circuit 250, a sound control circuit 260, a lamp control circuit 270, and a light emission control circuit 50.

The main CPU 231 inputs a game ball detection signal from a V count switch 211S, etc., described later and on the other hand, operates in accordance with a control program stored in the main ROM 232 and controls the whole operation of the pachinko gaming machine 201 such as big bonus lottery, win ball ejection in the pachinko gaming machine 201. The main CPU 231 implements a game mode control unit in the invention. That is, as a predetermined condition of the big bonus lottery result, change in the gaming state, etc., the main CPU 231 causes the gaming mode to make a transition from a usual gaming mode to a special gaming mode (big bonus) for enabling the player to expect a large number of paid-out balls. In the pachinko gaming machine 201, the gaming modes (gaming state) include the usual gaming state, a probability change gaming state, and a big bonus (big bonus gaming state).

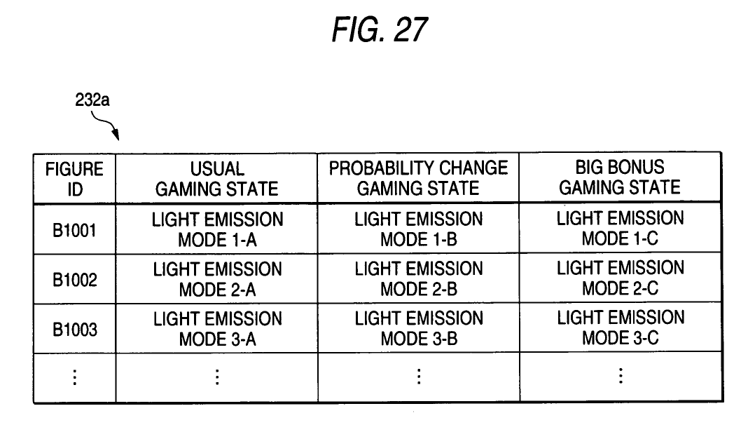

The main ROM 232 stores control programs executed by the main CPU 231 and permanent data. In the pachinko gaming machine 201, the ROM 232 stores a light emission mode database 232a shown in FIG. 27. That is, the light emission mode database 232a stores the light emission modes in the usual gaming state, the light emission modes in the probability change gaming state, and the light emission modes in the big bonus gaming state for each figure ID.

The main RAM 233 temporarily stores data and a program used for the main CPU 231 to operate. The initial reset circuit 234 outputs a reset signal to the main CPU 231 on a regular basis. The reset signal causes the main CPU 231 to execute processing starting at the top of the control program.

Various switches including the V count switch 211S and the like are connected to the main control circuit 230. The V count switch 211S counts the number of game balls passing through a V zone provided in a big winning opening 211 and outputs a detection signal indicating the count result to the main control circuit 230. A count switch 211CS counts the number of game balls entering the big winning opening 211 and outputs a detection signal indicating the count result to the main control circuit 230.

An ordinary winning opening switch 212S outputs a detection signal of a game ball entering each of ordinary winning openings 212a to 212d to the main control circuit 230. An actuation gate switch 210S outputs a detection signal of a game ball passing through a usual symbol actuation gate 210 to the main control circuit 230. A start winning opening switch 209S outputs a detection signal of a game ball entering a start winning opening 209 to the main control circuit 230.

A start opening solenoid 209L opens and closes a pair of blades 209a and 209a provided in the start winning opening 209, and a big winning opening solenoid 211L opens and closes a shutter of the big winning opening 211. A seesaw solenoid 211M drives a seesaw (not shown) of the big winning opening 211. A backup clear switch 226 clears backup data at the power failure time, etc., in response to operation of the operator.

In the pachinko gaming machine 201, when the start winning opening switch 209S detects winning of a game ball and outputs a detection signal, a random number is extracted and lottery processing using the random number is performed and a decorative symbol on a liquid crystal display 215 is determined.

When a big bonus occurs, the main CPU 231 outputs a drive signal to the big winning opening solenoid 211L, thereby opening the big winning opening 211. When the big winning opening 211 is opened, it is closed under a condition of winning of a predetermined number of (for example, 10) game balls or the expiration of a predetermined time (for example, 30 seconds). The main CPU 231 also controls the power supply unit 224 in accordance with a signal from the selection button 220b, 220c, the determination button 220a.

The main CPU 231 performs control required for the effects such as variable display of decorative symbol, riichi effect, and notice effect using the liquid crystal display 215 and on the other hand, operates the image control circuit 250 to display a predetermined image on the liquid crystal display 215. The main CPU 231 operates the sound control circuit 260 and the lamp control circuit 270 and performs control required for the effect produced by sound output using loudspeakers 217L and 217R and the effect produced by blink display of decorative lamps 218L and 218R.

The image control circuit 250 has a VDP (Video Display Processor 251, a D/A converter 252, an initial reset circuit 253, and image data ROM (an image storage unit) 254a and 254b. The VDP 251 forms an image responsive to the display of the liquid crystal display 215 determined by the main CPU 231 and outputs the formed image to the D/A converter 252. The D/A converter 252 converts the digital image data output from the VDP 251 into an analog signal and outputs the provided analog signal to the liquid crystal display 215 for displaying the image. The initial reset circuit 253 receives a reset instruction from the main CPU 231 and executes processing of restoring the VDP 251 to the initial state. Image data indicating a decorative symbol, a special symbol, a character, a background, etc., is stored in the image data ROM 254a, and image data to display various pieces of image data on the liquid crystal display 215 is stored in the image data ROM 254b.

The sound control circuit 260 has a sound source IC 261 for generating a sound signal, an AMP 262 for amplifying the generated sound signal, and sound data ROM 263 storing sound data used for various effects.

The lamp control circuit 270 has decorative data ROM 271 storing decorative data indicating blink patterns of the decorative lamps 218L and 218R and a drive circuit 272 for blinking the decorative lamps 218L and 218R using the decorative data stored in the decorative data ROM 271 in accordance with an instruction from the main CPU 231.

The payout and propelling control circuit 280 operates a payout unit 281 for paying out a predetermined number of game balls as winning balls and paying out winning balls when a game ball enters the big winning opening 211 under the control of the main control circuit 230. The payout and propelling control circuit 280 operates the propelling handle 206c and a propelling unit 282 having a propelling motor and propels game balls toward the game area on the game board by the propelling unit 282.

The power supply unit 224 supplies power to the main control circuit 230 and the payout and propelling control circuit 280 and limits power supply to the payout and propelling control circuit 280 and the main control circuit 230 under the control of the main control circuit 230.

Operation Description of Pachinko Gaming Machine

The control processing procedure of the main control circuit 230 in the operation of the pachinko gaming machine 201 is executed like the control processing of the main control board 171 in the Pachi-Slot machine 101 described above (see FIGS. 23 and 24). That is, when the main CPU 231 starts effect control processing, initialization processing, display control processing, sound control processing, light emission control processing, and game media payout processing are executed in order and a loop of the display control processing to the game media payout processing is entered as with the Pachi-Slot machine 101.

In the display control processing, the main CPU 231 instructs the image control circuit 250 to display an image on the liquid crystal display 215. In the sound control processing, the main CPU 231 instructs the sound control circuit 260 to output a sound from the loudspeakers 271L and 217R.

Further, the light emission control processing is performed as in the flowchart of FIG. 24. That is, when the light emission control processing is started, the figure ID is read through the IC chip reader/writer 20. Subsequently, the main CPU 231 operates as a light emission mode determination unit and determines the current game mode and determines the light emission mode of an LED unit 21 from the light emission mode database 232a based on the figure ID read through the IC chip reader/writer 20. When the main CPU 231 determines the light emission mode, the light emission control circuit 50 controls light emission of the LED unit 21 in accordance with the determined light emission mode.

Therefore, also in the pachinko gaming machine 201, the FIG. 30 shown in FIG. 5 is set in the figure installation unit 15, the light applied to the incidence part 32a of the figure main body 32 of the figure 30 from the LED unit 21 passes through the inside of the figure main body 32 of the figure 30 and is emitted from the emission part 32b to the outside. Therefore, also in the pachinko gaming machine 201, the light emission mode of the LED unit 21 is changed based on the figure ID stored in the IC chip 34 of the figure 30, whereby the appearance of the figure 30 can be changed. Therefore, interest to the player can also be kept sufficient in the pachinko gaming machine 201 like the gaming machine 10 shown in the first embodiment and the Pachi-Slot machine 101 shown in the second embodiment.

The invention is not limited to the specific embodiments described above and various medications can be made. For example, as the game article, a figure is taken as an example. However, for example, a three-dimensional article such as a cassette or a cartridge may be used in place of a three-dimensional article such as a figure.

As the gaming machine, the gaming machine for allowing the player to play a labyrinth battle game is taken as an example, but the invention can also be applied to a gaming machine for allowing the player to play any other image game. For example, the invention can be applied to a gaming machine for allowing the player to simulate a team play using figures or cassettes corresponding to players in a game in which a plurality of players appear like a baseball or a soccer.

Further, the read unit is not limited to the non-contact type IC chip reader and may be a contact type IC chip reader. Further, the read unit is not limited to the purpose of reading the figure ID (identification information) and can also be of read/write type, namely, can be of a configuration capable of writing information into a record unit of an IC chip, etc. In the Pachi-Slot machine and the pachinko gaming machine in the embodiments described above, the components of the light emission mode determination unit, the light emission control unit, the light emission mode database, etc., are provided on the main control board. As a modification, however, a separate subcontrol board can also be provided on which some or all of the components are provided.

### Fourth Embodiment

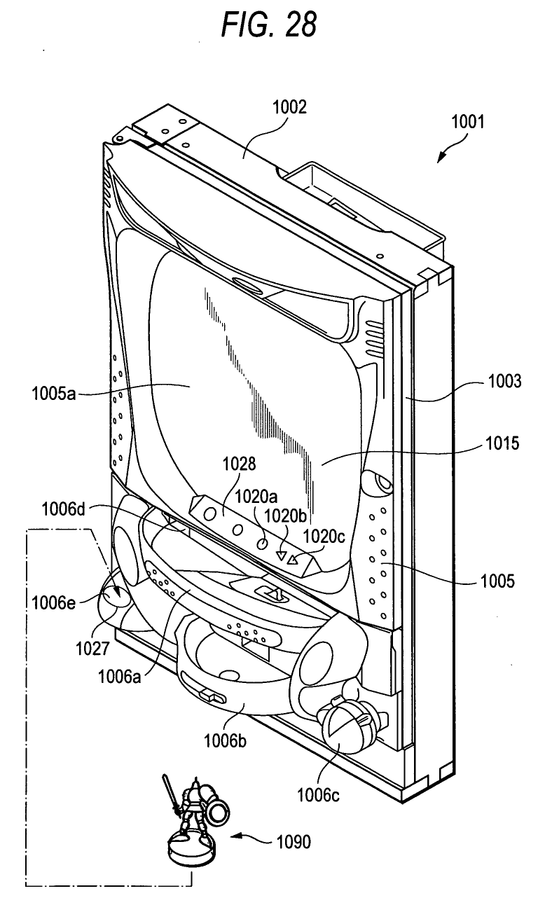

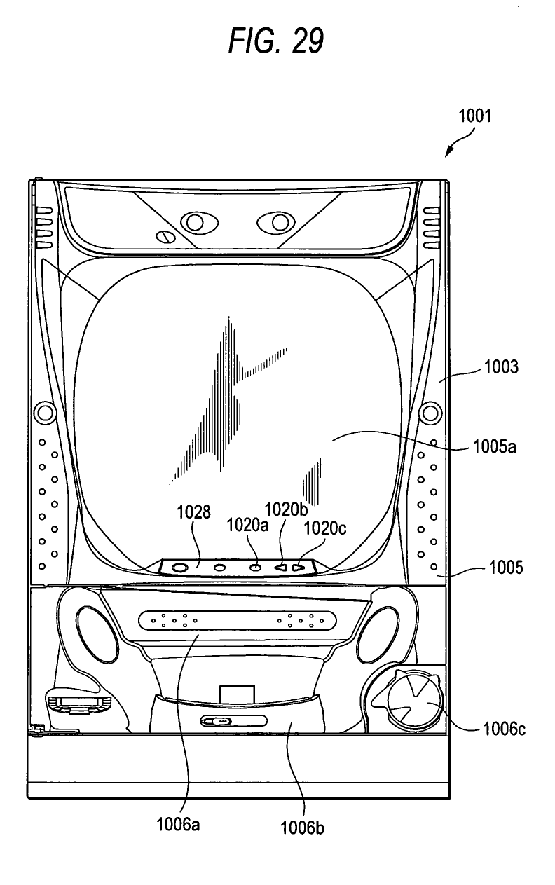

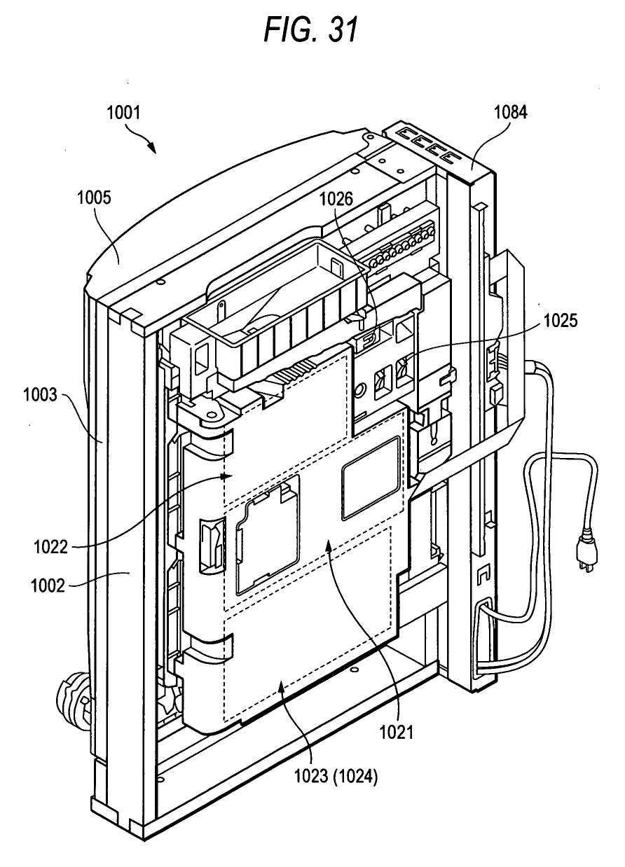

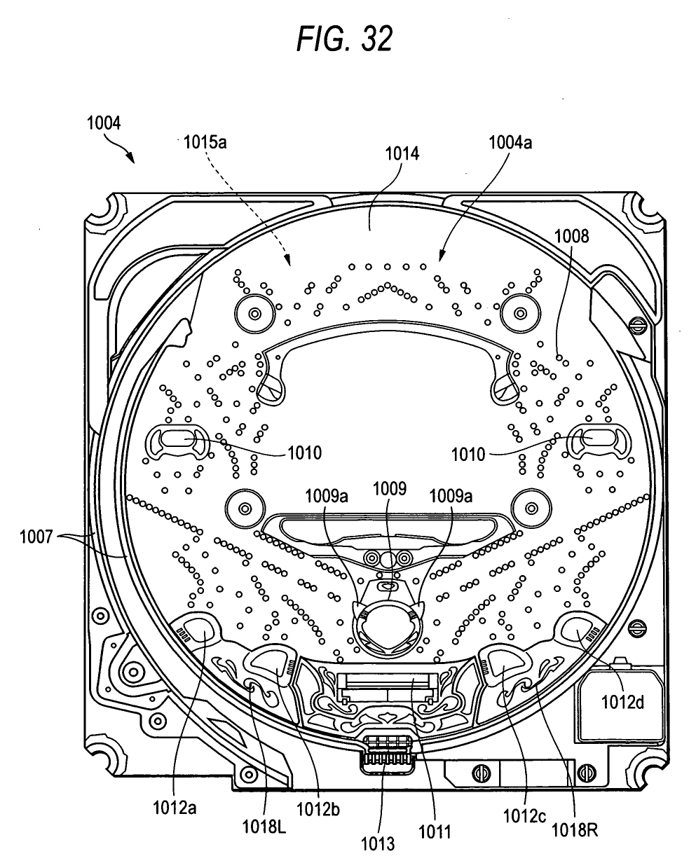

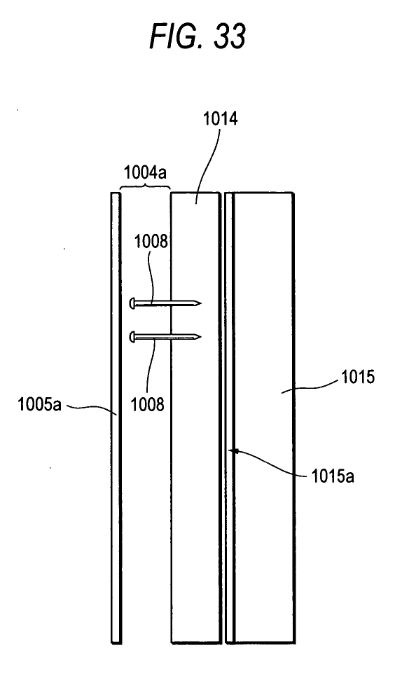

FIG. 28 is a perspective view to show a pachinko gaming machine according to a fourth embodiment of the invention from the front, FIG. 29 is a front view of the pachinko gaming machine shown in FIG. 28, FIG. 30 is an exploded perspective view of the pachinko gaming machine shown in FIG. 28, FIG. 31 is a perspective view to show the pachinko gaming machine shown in FIG. 28 from the rear, FIG. 32 is a front view of a game board shown in FIG. 30, and FIG. 33 is a fragmentary sectional view of the pachinko gaming machine shown in FIG. 28. In the description of the embodiment, the gaming machine is a digital pachinko gaming machine (called digipachi, pachinko gaming machine of first kind) by way of example.

Configuration of Gaming Machine

The pachinko gaming machine 1001 shown in FIGS. 28 and 29 includes an outer frame 1002 housed and installed in a predetermined installation frame in a game arcade (hall). A base door (inner frame) 1003 provided pivotally relative to the outer frame 1002 is disposed on the front of the outer frame 1002, and a game board 1004 shown in FIG. 29 is built in the base door 1003. A front door 1005 is provided on the front of the outer frame 1002. The front door 1005 covers the front of the game board 1004 and is installed pivotally relative on the front of the base door 1003.

A card unit 1084 for lending game balls in response to the balance on the prepaid card when a prepaid card, etc., is inserted is installed adjacent to the pachinko gaming machine 1001. FIGS. 28 to 30 do not shown the card unit 1084.

The front door 1005 includes a glass plate 1005a roughly in all area in the center of the front door 1005, enabling a player to visually recognize the game board 1004 inside the glass plate 1005a. A ball lending operation panel 1028 having ball lending operation relevant buttons for the player to perform card return operation of the card unit, game ball lending operation, etc., is provided in the lower part of the front door 1005. The ball lending operation panel 1028 is provided with a determination button 1020a and selection buttons 1020b and 1020c for the player to perform predetermined operation.

A tray panel 1006 that can be opened and closed relative to the outer frame 1002 is installed below the front door 1005. An upper tray 6a for receiving game balls lent from the card unit 1084 and game balls paid out when a ball enters a win opening (described later), a lower tray 1006b for receiving game balls overflowing the inside of a ball exit 1006d when the upper tray 1006a is full, and a propelling handle 1006c provided at the right of the lower tray 1006b are placed on the front of the tray panel 1006.

The propelling handle 1006c is used to propel game balls in the upper tray 1006a and is provided for rotation relative to the tray panel 1006 and the player can operate the propelling handle 1006c for advancing a pachinko game. When the player holds the propelling handle 1006c and turns the handle clockwise, power is supplied to a propelling motor provided at the rear of the propelling handle 1006c in response to the turn angle and game balls are propelled onto the game board 1004 in order.

The propelled game ball is guided by a guide rail 1007 provided on the outer periphery of a game area 1004a described later and moves to the top of the game board 1004 and then flows down toward the bottom of the game board 1004 while changing in the travel direction as it collides with game nails 1008, etc., as shown in FIG. 32.

The game board 1004 is formed with the game area 1004a which becomes an area wherein game balls flow down in the gaming state, and a large number of game nails 1008 are provided in the game area 1004a for changing the flow-down direction of each game ball. A start winning opening 1009 is provided on the center line separating the game board face from side to side and slightly below the center in the height direction in the game area 1004a, as shown in FIG. 32. Further, usual symbol actuation gates 1010 and 1010 are provided on the left and right sides of the center line and above the start winning opening 1009 in the height direction. A big winning opening 1011 is provided below the start winning opening 1009 in the height direction on the center line. Further, ordinary winning openings 1012a to 1012d are provided on the side of the start winning opening 1009. A symbol display area 1015a is provided in the game area 1004a and an out opening 1013 is provided in a lower end part of the game area 1004a.

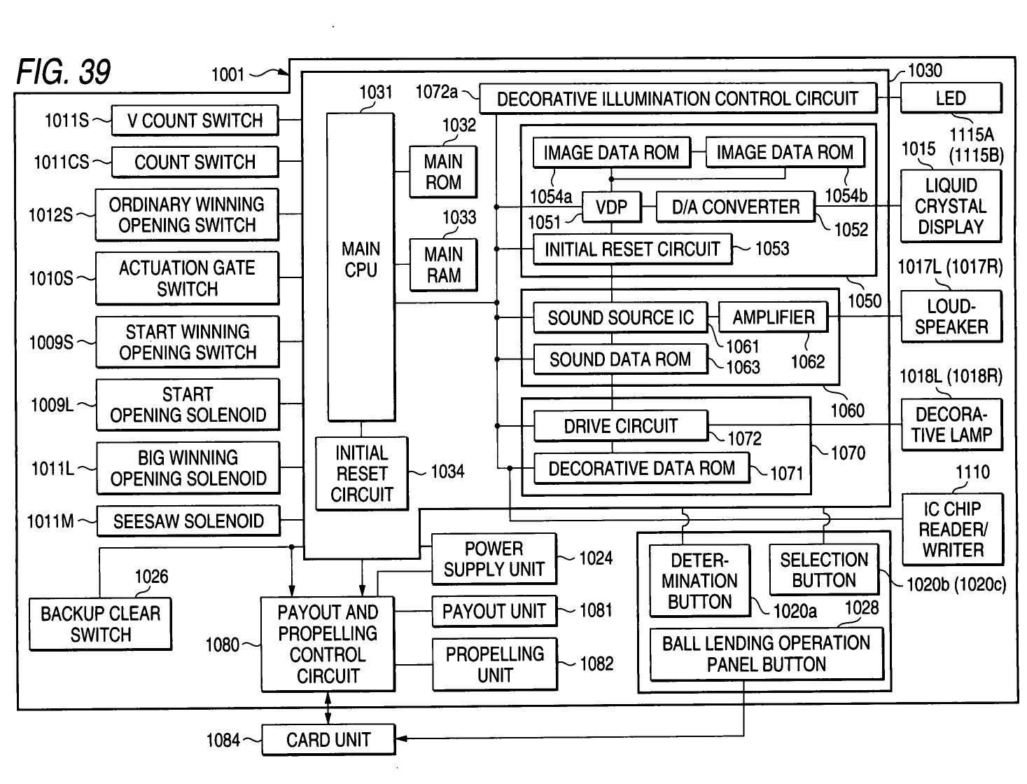

The start winning opening 1009 allows a game ball to enter and is provided with a start winning opening switch 1009S (FIG. 39). The start winning opening switch 1009S detects a game ball entering the start winning opening 1009 and outputs a detection signal to a main control circuit 1030. When the start winning opening switch 1009S detects a game ball, a main CPU 1031 in the main control circuit 1030 extracts a big bonus determination random number value, etc., to make a big bonus determination.

Each usual symbol actuation gate 1010 allows a game ball to pass through and is a passage gate which becomes a trigger for extracting a usual symbol win determination random number value provided that a game ball passes through the usual symbol actuation gate 1010. As the usual symbol win determination random number value is extracted, when the gaming state becomes a usual symbol big bonus gaming state, one of specific gaming states (non-probability change specific gaming state), a pair of blades (usual electric-driven prize, tulip) 1009a provided in the start winning opening 1009 is opened and closed for a predetermined time (seconds), enabling a game ball to easily enter the start winning opening 1009.

The big winning opening 1011 is an opening-closing device of attacker type. It has a shutter (not shown) and is switched between an easy-to-win state and a hard-to-win state as the shutter is opened and closed back and forth. The shutter can be opened and closed by a big winning opening solenoid 1011L (described later) through a shaft. The big winning opening 1011 is a winning opening of a trigger for paying out a predetermined number of game balls (for example, 1015 balls) as win balls when a game ball enters the shutter.

Each of the ordinary winning openings 1012a to 1012d is a winning opening which becomes a trigger for paying out a predetermined number of game balls (for example, 1010 balls) as win balls when a game ball enters the ordinary winning opening. The out opening 1013 accepts game balls not entering any of the start winning opening 1009, the big winning opening 1011, the ordinary winning openings 1012a to 1012d, etc.

The game board 1004 is made of a translucent board 1014. This translucent board 1014 has a transparent section formed of a synthetic resin of polycarbonate, etc., for example, or any other transparent member (translucent member). The “transparent member” mentioned here refers to a member with light transmittance 100% or with high light transmittance to such an extent that the player can visually recognize an object through the member. The game area 4a in the embodiment is mostly a transparent game area. The game nails 1008 are fixed at least with the tops embedded in the translucent board 1014, and the area formed by the translucent board 1014 and the glass plate 1005a of the front door 1005 is used as the game area 1004a. A liquid crystal display 1015 having the display area 1015a of a large screen for displaying various pieces of image information is placed at the rear of the translucent board 1014, as shown in FIGS. 30 and 33. The image displayed on the liquid crystal display 1015 can be visually recognized by the player from the font of the pachinko gaming machine 1001 through the portion where the game nails 1008 are not provided roughly at the center of the translucent board 1014 and the portion where the fame nails 1008 are provided on the periphery. Three digits are variably displayed in the display area 1015a as identification information.

The liquid crystal display 1015 produces variable display of a special symbol, a decorative symbol, an ordinary symbol, a character, etc., and also displays a background image and a character image in the display area 1015a, as shown in FIG. 30. The “variable display” is the concept of variable symbol display; for example, “variable display” of actually displaying symbols, etc., in a variable manner, “stop display” of actually displaying symbols etc., in a still manner, and the like are made possible. In addition, “appearance display” of producing stop display as a special symbol simply appears, “derivative display” of displaying a special symbol as the result of a special symbol game, and the like are also made possible.

The pachinko gaming machine 1001 further has loudspeakers 1017L and 1017R as a notification unit for outputting a sound in a predetermined mode above the liquid crystal display 1015 as shown in FIG. 30 and decorative lamps 1018L and 1018R for notification as they are turned on and off in a predetermined mode as shown in FIG. 32. The pachinko gaming machine 1001 further includes a payout unit 1081 (see FIG. 39) below the game board 1004 for paying out game balls lent from the card unit 1084 described above and game balls as a game ball enters the start winning opening 1009, the big winning opening 1011, the ordinary winning openings 1012a to 1012d, etc., to the upper tray 1006a.

The pachinko gaming machine 1001 also has a main control board 1021 including the main control circuit 1030, a subcontrol board 1022 including a subcontrol circuit 1040, a payout and propelling control board 1023 including a payout and propelling control circuit 1080 for controlling payout and propelling of a game ball, a power supply unit 1024 for supplying power, a power switch 1025, and a backup clear switch 1026 on the rear as shown in FIG. 31.

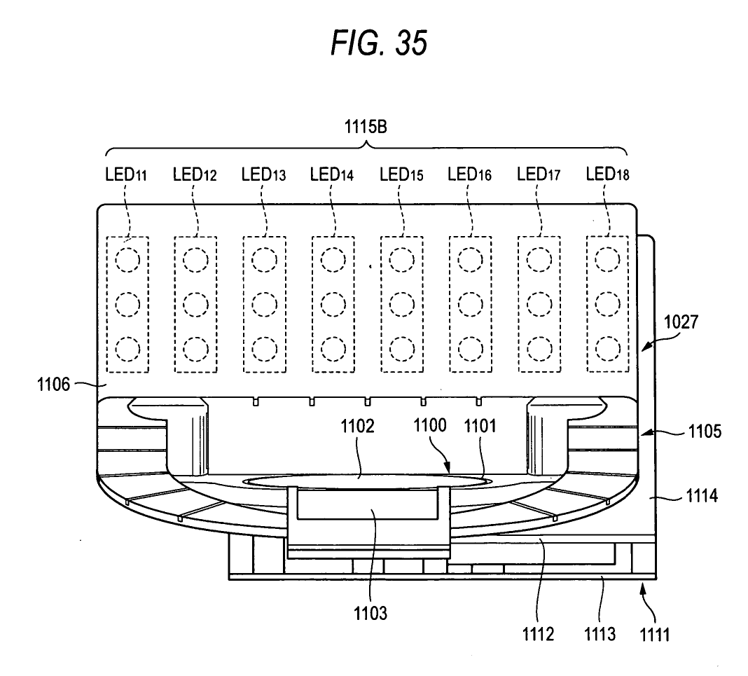

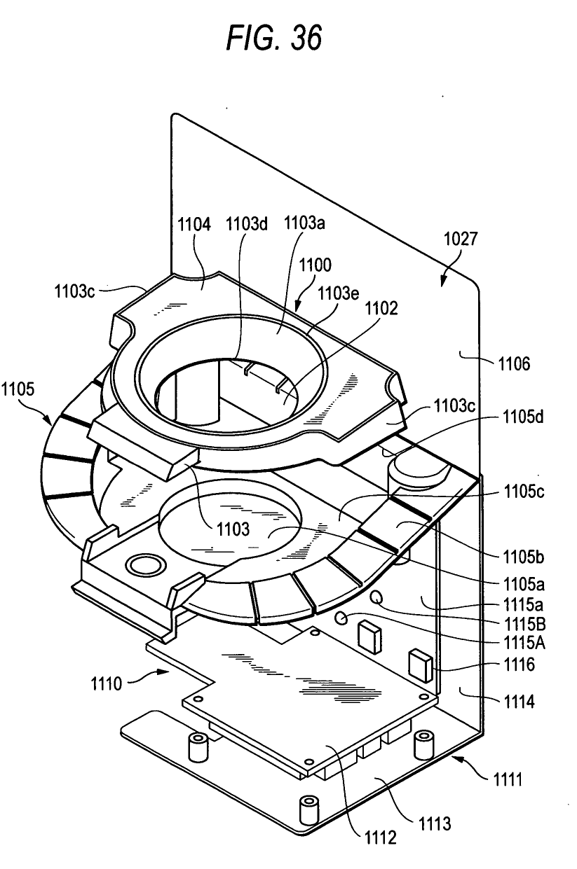

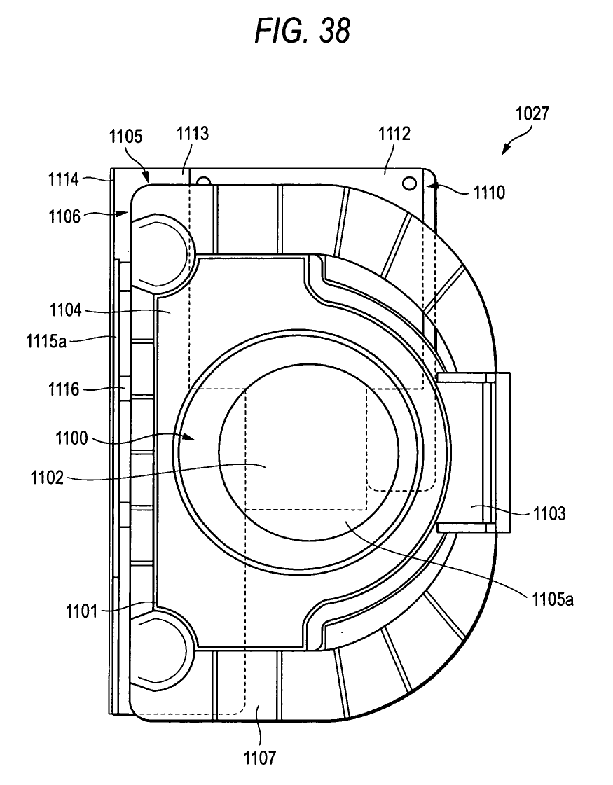

An authentication unit 1027 where a figure 1090 (described later) can be placed is provided in an installation part 1006e at the left of the lower tray 1006b. The authentication unit 1027 has a holding member 1100 made of transparent urethane of a transparent resin, a holding frame 1105 for holding the holding member 1100 from surroundings and from below, and an IC chip reader/writer 1110 and further has a base 1111 for fixing the holding frame 1105 to the installation part 1006e together with the holding member 1100, as shown in FIGS. 35 to 38.

The holding member 1100 is formed roughly like a ring having a holding hole 1102 and has a projection part 1103 provided to the front (player side), wide parts 1103c and 1103c provided wider to the rear, and a black light shield seal 1104 put on the upper surface (except a peripheral wall face 1103a formed with the holding hole 1102).

The holding member 1100 also includes a circular opening 1103d on the base 1111 side (the side closed by a placement part 1105a of the holding frame 1105) facing the holding hole 1102 and a circular opening end part 1103e on the open side. The opening end part 1103e has a larger diameter than the opening 1103d has and the peripheral wail face 1103a between the opening end part 1103e and the opening 1103d is a cone-shaped inclined face becoming gradually narrower in diameter from the opening end part 1103e to the opening 1103d. The shape of the opening 1103d corresponds to the shape of a pedestal 1091 of the figure 1090, allowing the pedestal 1091 to be inserted through the opening 1103d. Lower decorative light a produced by a lower light emission body 1115A described later is output from the peripheral wall face 1103a.

The holding frame 1105 includes an annular frame 1105b surrounding the holding member 1100, a holding reception part 1105c being dented inside the frame 1105b for holding the holding member 1100, a light transmission window 1105d formed at the rear of the holding reception part 1105c, and the placement part 1105a dented like a column with a step roughly at the center of the inside of the holding reception part 1105c. The opening of the placement part 1105a is a concentric circle corresponding to the shape of the opening 1103d of the holding member 1100 and the pedestal 1091 can be fitted into the placement part 1105a. Further, the holding frame 1105 has a rear transmission panel 1106 having translucency installed so as to be upright like a flat plate in the rear portion of the holding member 1100 in the frame 1105b.

Further, the IC chip reader/writer 1110 of a read unit and a write unit of the invention and the base 1111 are placed below the holding frame 1105. The IC chip reader/writer 1110 includes a convex board 1112 and has an antenna, a wireless circuit (not shown), etc., on the convex board 1112, and the antenna is placed just below the placement part 1105a. The IC chip reader/writer 1110 reads game information in a non-contact manner from an IC chip 1094 (described later) contained in the figure 1090 through the antenna. When the figure 1090 is set in the authentication unit 1027, the IC chip reader/writer 1110 can also write predetermined information into the IC chip 1094 of the figure 1090 in accordance with an instruction of the main CPU 1031.

The base 1111 is fixed to the inside of the installation part 1006e and is placed below the IC chip reader/writer 1110. The base 1111 has a bade main body 1113 and a rear plate 1114 connected to an end part on the rear of the base main body 1113 and upright at the depth from the rear transmission panel 1106. An LED support plate 1115a is placed between the rear plate 1114 and the rear transmission panel 1106.

The lower light emission body 1115A made up of full-color LEDs (Light Emitting Diodes) arranged in one horizontal row, a side light emission body 1115B made up of 1024 LEDs (3 LEDs×8 LEDs) placed above the lower light emission body 1115A, and a spacer 1116 are attached to the LED support plate 1115a. The lower light emission body 1115A is made up of light emitting diodes as one package (or unit) of light emitting elements of three primary colors of light made up of red, green, and blue for emitting light of different colors; likewise, the side light emission body 1115B is made up of light emitting diode packages or units each made up of light emitting elements of three primary colors of light made up of red, green, and blue for emitting light of different colors.

The lower light emission body 1115A generates lower application light α applied to the figure 1090 set in the authentication unit 1027 from below.

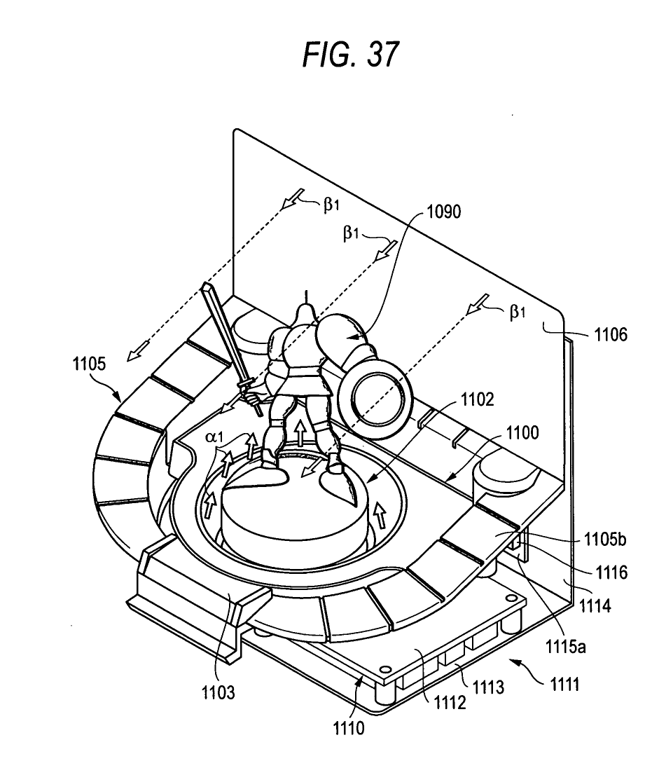

The side light emission body 1115B is a light emission unit in the invention and has light emitting diode units (each made up of three light emitting diodes arranged longitudinally) indicated by LED₁₁ to LED₁₈ in order from left to right, as shown in detail in FIGS. 35 and 37. Each light emitting diode unit generates transmission light β₁ incident on an incidence section of the figure 1090 (described later) and passing through the inside of the figure 1090. Although described later in detail, LED₁₁ to LED₁₃ are classified into four groups of three units of LED₁₁, to LED₁₃, one unit of LED₁₄, two units of LED₁₅ and LED₁₆, and two units of LED₁₇ and LED₁₈ from left to right for emitting light, and each light emission is controlled.

The lower light emission body 1115A and the side light emission body 1115B are placed at the rear of the rear transmission panel 1106 with a given space (about 5 mm) via the spacer 1116.

The figure 1090 can be placed in the authentication unit 1027. When the figure 1090 is placed in the authentication unit 1027, the pedestal 1091 is guided along the peripheral wall face 1103a and then is fitted into the placement part 1105a. At this time, the lower portion of the pedestal 1091 (IC chip 1094) faces the convex board 1112 of the IC chip reader/writer 1110.

Configuration of Figure

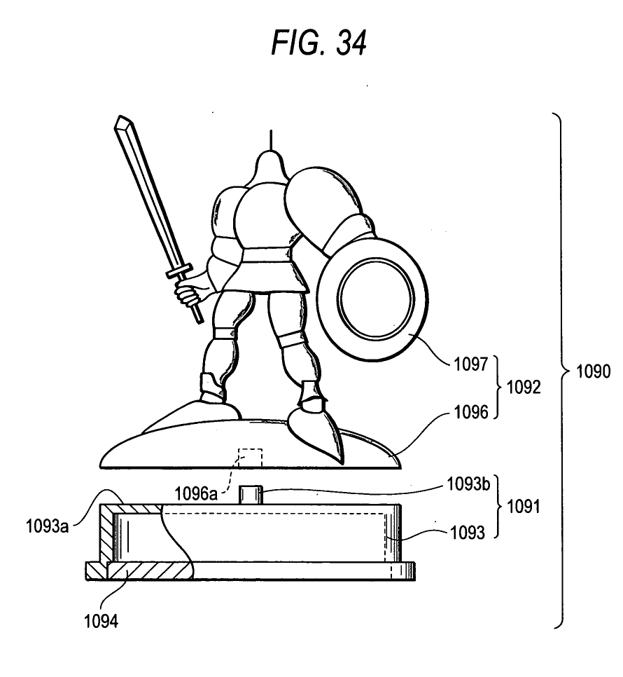

FIG. 34 is an exploded perspective view to show the configuration of the figure 1090. The figure 1090 is a game article in the invention and has the pedestal 1091 and a figure main body 1092.

The pedestal 1091 has a size corresponding to the placement part 1105a of the authentication unit 1027 and is formed like a hollow thick disk. The pedestal 1091 has a closed-end cylindrical pedestal main body 1093 having a top section 1093a and the above-mentioned IC chip 1094 for storing game information in the invention, and the IC chip 1094 is embedded and fixed in an opening end part of the pedestal main body 1093. The pedestal main body 1093 has a projection part 1093b roughly at the center of the top section 1093a.

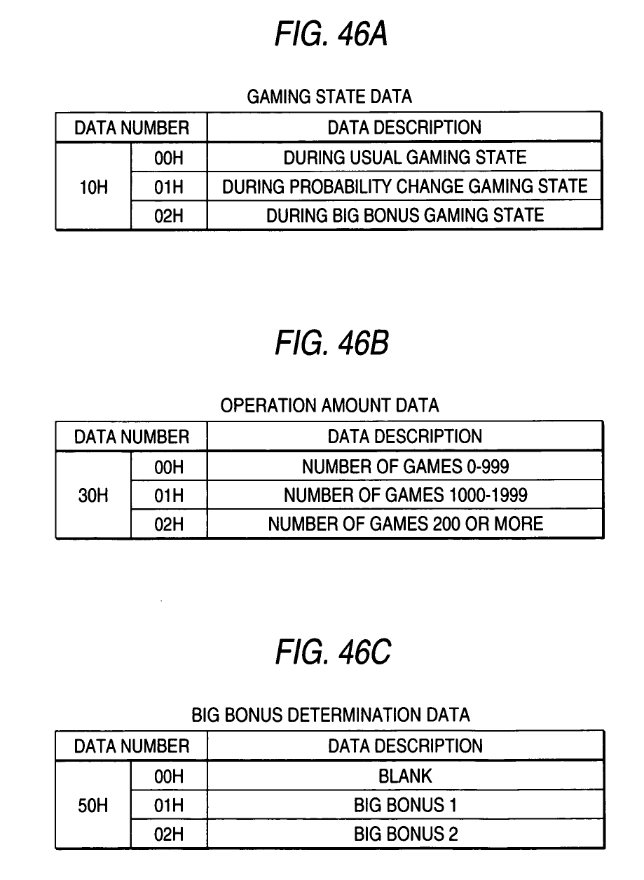

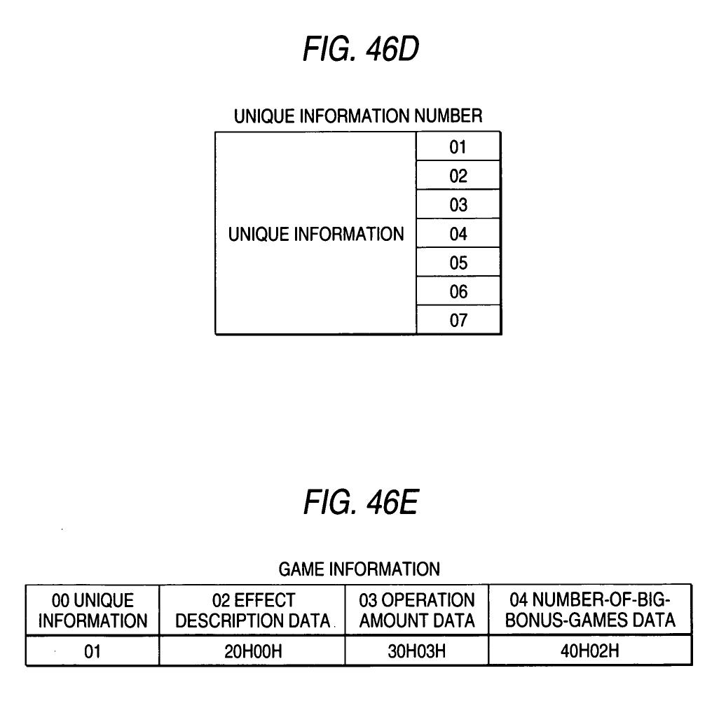

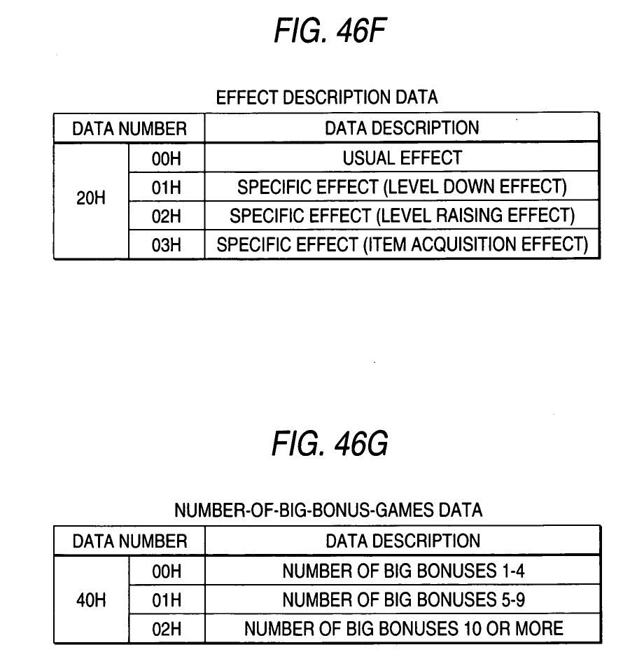

The IC chip 1094 stores game information in the format as shown in FIG. 46E (having entries of 00 unique information, 02 effect description data, 03 operation amount data, and 04 big bonus count data). The unique information to the figure 1090 is stored in the 00 unique information area as shown in FIG. 46D. Information other than the unique information, namely, 02 effect description data, 03 operation amount data, and 04 big bonus count data are rewrite game information in the invention, and information as shown in FIGS. 46F, 46B, and 46G is written into the areas.

The figure main body 1092 is made of a colorless or colored transparent material (for example, transparent material like crystal glass) for allowing the transmission light β₁ output from the side light emission body 1115B to pass through, and the side near to the rear transmission panel 1106 becomes the incident section of the transmission light β₁ and the opposite side becomes the emission section of the light. The figure main body 1092 has a foot pedestal section 1096 having a concave part 1096a corresponding to the projection part 1093b and a three-dimensional figure section 1097 shaped like a character such as a soldier as shown in the figure or a magician. The projection part 1093b is fitted into the concave part 1096a and is fixed to the top section 1093a of the pedestal 1091. The figure 1090 is stored in a capsule about 7 cm in diameter (not shown), and is sold at a selling machine installed in a game arcade, etc.

FIG. 39 is a block diagram of the pachinko gaming machine 1001 in FIGS. 28 to 33 shown centering on the internal configuration thereof. The pachinko gaming machine 1001 has a plurality of components centering on a main control circuit 1030, a payout and propelling control circuit 1080, and a power supply unit 1024. The power supply unit 1024 is connected to the main control circuit 1030 and the payout and propelling control circuit 1080 and can supply power thereto. The main control circuit 1030 has a main CPU (Central Processing Unit) 1031 implemented as a one-chip microcomputer, main ROM (Read-Only Memory) 1032, and main RAM (Random Access Memory) 1033 and also has an initial reset circuit 1034, an image control circuit 1050, a sound control circuit 1060, a lamp control circuit 1070, and a decorative illumination control circuit 1072a.

The main CPU 1031 inputs a game ball detection signal from a V count switch 1011S, etc., described later and on the other hand, operates in accordance with a control program stored in the main ROM 1032 and controls the whole operation of the pachinko gaming machine 1001 such as big bonus lottery, win ball ejection in the pachinko gaming machine 1001. The main CPU 1031 implements a gaming state transition unit, a gaming state determination unit, and a transition permission/inhibition determination unit in the invention. That is, the main CPU 1031 causes the gaming state to make a transition from a usual gaming state to a specific gaming state (big bonus) according to the big bonus lottery result, change in the gaming state, etc. The main CPU 1031 determines whether or not a transition condition holds in big bonus determination processing described later and when the main CPU 1031 determines a big bonus (when the transition condition holds and a transition to a big bonus is determined), the main CPU 1031 determines the big bonus to which a transition is to be made from among the big bonus types (in the embodiment, big bonus 1 or big bonus 2) and causes the gaming state to make a transition to the determined big bonus. When the transition of the gaming state is made, the main CPU 1031 sets the gaming state data shown in FIG. 46A in the gaming state data. In the pachinko gaming machine 1001, the gaming states include the usual gaming state, a probability change gaming state, and a big bonus (big bonus gaming state), as shown in FIG. 46A.

The main ROM 1032 stores control programs executed by the main CPU 1031 and permanent data of lighting pattern determination tables, first to fourth light emission mode tables, etc., as described later. In addition, the main ROM 1032 stores a plurality of pieces of effect information used in the effect description determination processing described later and implements an effect information storage unit in the invention. The main RAM 1033 temporarily stores data and a program used for the main CPU 1031 to operate. The initial reset circuit 1034 outputs a reset signal to the main CPU 1031 on a regular basis. The reset signal causes the main CPU 1031 to execute processing starting at the top of the control program.

Various switches including the V count switch 1011S and the like are connected to the main control circuit 1030. The V count switch 1011S counts the number of game balls passing through a V zone provided in the big winning opening 1011 and outputs a detection signal indicating the count result to the main control circuit 1030. A count switch 1011CS counts the number of game balls entering the big winning opening 1011 and outputs a detection signal indicating the count result to the main control circuit 1230.

An ordinary winning opening switch 1012S outputs a detection signal of a game ball entering each of ordinary winning openings 1012a to 1012d to the main control circuit 1030. An actuation gate switch 1010S outputs a detection signal of a game ball passing through a usual symbol actuation gate 1010 to the main control circuit 1030. A start winning opening switch 1009S outputs a detection signal of a game ball entering a start winning opening 1009 to the main control circuit 1030.

A start opening solenoid 1009L opens and closes the above-mentioned pair of blades 1009a and 1009a provided in the start winning opening 1009, and a big winning opening solenoid 1011L opens and closes the shutter of the big winning opening 1011. A seesaw solenoid 11M drives a seesaw (not shown) of the big winning opening 1011. The backup clear switch 1026 clears backup data at the power failure time, etc., in response to operation of the operator.

In the pachinko gaming machine 1001, when the start winning opening switch 1009S detects winning of a game ball and outputs a detection signal, a random number is extracted and lottery processing using the random number is performed and a decorative symbol on the liquid crystal display 1015 is determined.

When a big bonus occurs, the main CPU 1031 outputs a drive signal to the big winning opening solenoid 1011L, thereby opening the big winning opening 1011. When the big winning opening 1011 is opened, it is closed under a condition of winning of a predetermined number of (for example, 10) game balls or the expiration of a predetermined time (for example, 30 seconds). The main CPU 1031 also controls the power supply unit 1024 in accordance with a signal from the selection button 1020b, 1020c, the determination button 1020a.

The main CPU 1031 performs control required for the effects such as variable display of decorative symbol, riichi effect, and notice effect using the liquid crystal display 1015 and on the other hand, operates the image control circuit 1050 to display a predetermined image on the liquid crystal display 1015. The main CPU 1031 operates the sound control circuit 1060 and the lamp control circuit 1070 and performs control required for the effect produced by sound output using loudspeakers 1017L and 1017R and the effect produced by blink display of decorative lamps 1018L and 1018R.

The image control circuit 1050 has a VDP (Video Display Processor) 1051, a D/A converter 1052, an initial reset circuit 1053, and image data ROM (an image storage unit) 1054a and 1054b. The VDP 1051 forms an image responsive to the display of the liquid crystal display 1015 determined by the main CPU 1031 and outputs the formed image to the D/A converter 1052. The D/A converter 1052 converts the digital image data output from the VDP 1051 into an analog signal and outputs the provided analog signal to the liquid crystal display 1015 for displaying the image. The initial reset circuit 1053 receives a reset instruction from the main CPU 1031 and executes processing of restoring the VDP 1051 to the initial state. Image data indicating a decorative symbol, a special symbol, a character, a background, etc., is stored in the image data ROM 1054a, and image data to display various pieces of image data on the liquid crystal display 1015 is stored in the image data ROM 1054b.

The sound control circuit 1260 has a sound source IC 1261 for generating a sound signal, an AMP 1262 for amplifying the generated sound signal, and sound data ROM 1263 storing sound data used for various effects.

The lamp control circuit 1070 has decorative data ROM 1071 storing decorative data indicating blink patterns of the decorative lamps 1018L and 1018R and a drive circuit 1072 for blinking the decorative lamps 1018L and 1018R using the decorative data stored in the decorative data ROM 1071 in accordance with an instruction from the main CPU 1031.

The payout and propelling control circuit 1080 operates the payout unit 1081 for paying out a predetermined number of game balls as winning balls and paying out winning balls when a game ball enters the big winning opening 1011 under the control of the main control circuit 1030. The payout and propelling control circuit 1080 operates the propelling handle 1006c and a propelling unit 1082 having a propelling motor and propels game balls toward the game area on the game board by the propelling unit 1082.

The power supply unit 1024 supplies power to the main control circuit 1030 and the payout and propelling control circuit 1080 and limit power supply to the payout and propelling control circuit 1080 and the main control circuit 1030 under the control of the main control circuit 1030.

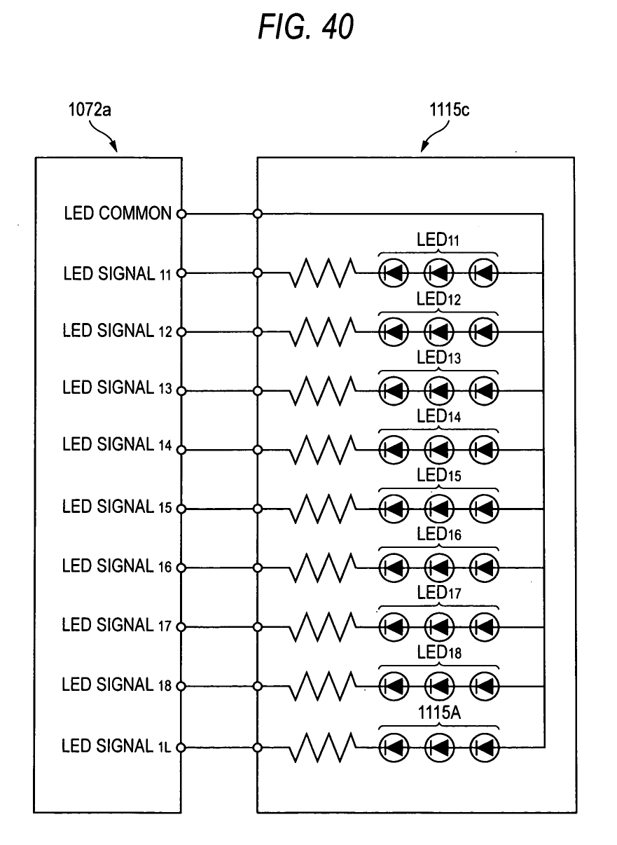

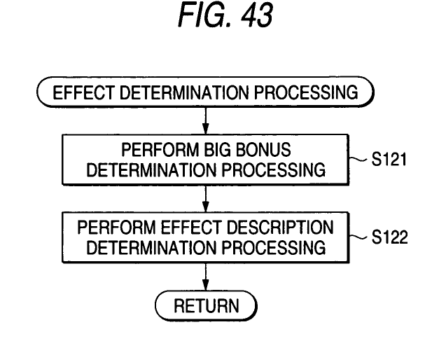

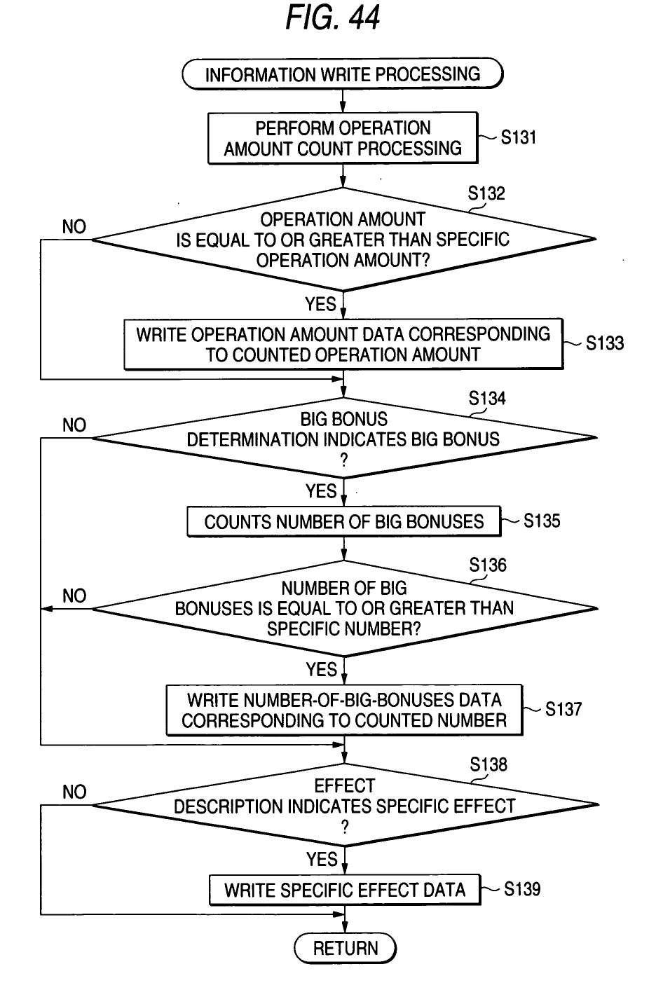

FIG. 40 is a circuit diagram to show the decorative illumination control circuit 1072a and an LED circuit 1115c wherein the LED₁₁ to the LED ₈ making up the side light emission body 1115B and the lower light emission body 1115A are connected in parallel. The decorative illumination control circuit 1072a has an LED common line for outputting a signal common to the LED₁₁ to the LED₁₈ making up the side light emission body 1115B and an LED signal line ₁₁ to an LED signal line ₁₈ for outputting signals for separately lighting the LED₁₁ to the LED₁₈ (“LED signal ₁₁ to LED signal ₁₈” shown in FIG. 44). In the LED circuit 1115c, the LED₁₁ to the LED₁₈ and the lower light emission body 1115A are connected in parallel to a line connected to the LED common line and the LED₁₁ to the LED₁₈ (each made up of three LEDs) are connected in series to the LED signal line ₁₁ to the LED signal line ₁₈ respectively each via a resistor. Further, the lower light emission body 1115A is connected to an LED signal line _{1L}.

Operation Description of Pachinko Gaming Machine

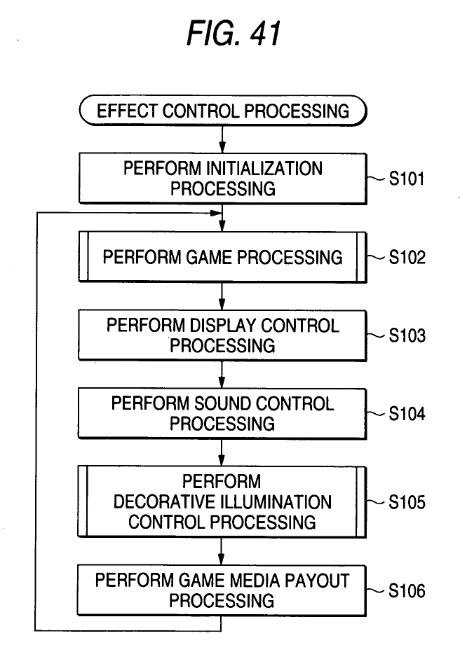

The control processing procedure of the main control circuit 1030 of the pachinko gaming machine 1001 will be discussed with reference to flowcharts of FIGS. 41 to 45. FIG. 41 is a flowchart to show the operation procedure of effect control processing executed by the main control circuit 1030 in the pachinko gaming machine 1001. Each step in FIGS. 41 to 45 is abbreviated as S.

Operation Procedure of effect Control Processing

As shown in FIG. 41, when the main CPU 1031 of the main control circuit 1030 starts effect control processing, the pachinko gaming machine 1001 executes steps 101 to 106 are executed in order and initialization processing, game processing, display control processing, sound control processing, decorative illumination control processing, and game media payout processing are executed in order. A loop of steps 102 to 106 is entered.

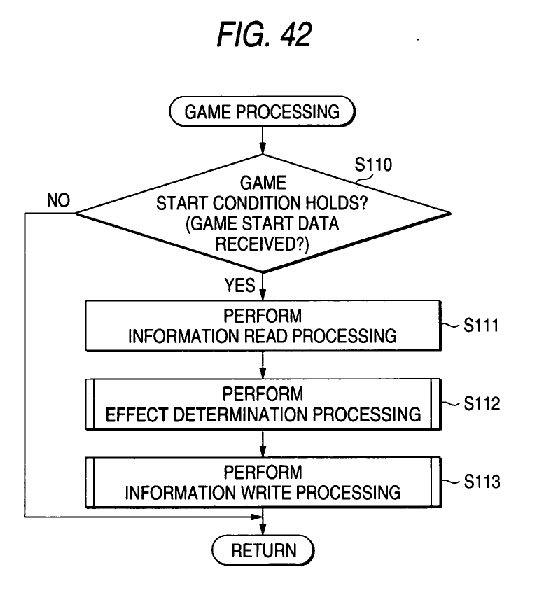

The game processing is performed as shown in the flowchart of FIG. 42. When the game processing is started, the process goes to step 110 and whether or not a game start condition holds, namely, whether or not a condition required for starting a game holds is determined. Whether or not the game start condition holds is determined by whether or not a game ball enters a winning opening in the embodiment, but may be determined according to any other condition. When the game start condition holds, the process goes to step 111; if the game start condition does not hold, the game processing is exited without executing the subsequent steps.

Next, when the process goes to step 111, information read processing is executed. Her, the main CPU 1031 determines whether or not game information read by the IC chip reader/writer 1110 is input. In this case, when the figure 1090 is set in the authentication unit 1027, the IC chip reader/writer 1110 reads the stored game information from the IC chip 1094 of the set figure 1090 and inputs the read game information into the main CPU 1031; when the figure 1090 is not set or when game information cannot be read although the figure 1090 is set, game information is not input.

Subsequently, the process goes to step 112 and effect determination processing is performed according to the flowchart of FIG. 43. When the effect determination processing is started, the process goes to step 121 and big bonus determination processing is performed. In this big bonus determination processing, the gaming state transition is made based on the result of determination as to whether or not the gaming state is allowed to make a transition to a big bonus and then the main CPU 1031 determines whether or not the extracted big bonus determination random number value matches a predetermined winning random number value based on a predetermined effect start condition, and generates the big bonus determination data indicating the determination. In this case, as the generated big bonus determination data, classification data “00H,” “01H,” or “02H” responsive to the corresponding determination is set in data number “50H,” as shown in FIG. 46C.

Next, the process goes to step 122 and effect description determination processing is performed. In this effect description determination processing, the main CPU 1031 operates as an effect determination unit in the invention. It references the big bonus determination data generated at step 121, extracts a predetermined effect random number value, determines the effect description, and generates effect description data indicating the determined effect description. In this case, the main CPU 1031 reads a plurality of pieces of effect information from the main ROM 1032 and then determines the effect description using any of the pieces of effect information. The pachinko gaming machine 1001 provides four types shown in FIG. 46F, namely, usual effect, specific effect (level down effect), specific effect (level raising effect), and specific effect (item acquisition effect) as the determined effect description. When the effect description determination processing is executed, the effect determination processing is exited and the process goes to step 113, information write processing.

The information write processing is performed according to the flowchart of FIG. 44. When the information write processing is started, the process goes to step 131 and operation amount count processing is performed. Here, the main CPU 1031 counts the operation amount of the pachinko gaming machine 1001 performed by the player (in the embodiment, the number of games is adopted; in addition, the number of propelled game balls, the game execution time from the start, the number of identification symbol variation times, etc., for example, may be adopted). Subsequently, the process goes to step 132 and whether or not the operation amount counted at step 131 is equal to or greater than a predetermined specific operation amount is determined. If the operation amount is equal to or greater than the specific operation amount, the process goes to step 133; otherwise, step 133 is skipped and the process goes to step 134. In this case, the numbers of games “0” “1000,” and “2000” are provided as the specific operation amounts. At step 133, the main CPU 1031 generates the operation amount data corresponding to the counted operation amount (operation relevant information in the embodiment) and instructs the IC chip reader/writer 1110 to write (store) the operation amount data into (in) the IC chip 1094 of the set figure 1090 as rewrite game information in the invention. In this case, the operation amount data varies depending on the number of games ranging from 0 to 999, 1000 to 1999, and 2000 or more, and classification data “00H,” 01H,” or “02H” responsive to the corresponding number of games is set in data number “30H,” as shown in FIG. 46B.

Subsequently, the process goes to step 134 and the big game determination data is referenced and whether or not the big bonus determination indicates a big bonus is determined. If the determination is a big bonus, the process goes to step 135; otherwise, the process goes to step 138. At step 135, the main CPU 1031 counts the number of big bonuses gained by the player. At step 136, whether or not the number of big bonuses counted at step 135 is equal to or greater than a specific number (for example, 100). If the number of big bonuses is equal to or greater than the specific number (for example, 100), the process goes to step 137; otherwise, step 137 is skipped and the process goes to step 138. At step 137, the main CPU 1031 generates number-of-big-bonuses data indicating the counted number of big bonuses (number relevant information in the invention) and instructs the IC chip reader/writer 1110 to write the number-of-big-bonuses data into the IC chip 1094 of the set figure 1090 as rewrite game information in the invention. In this case, as the number-of-big-bonuses data, classification data “00H,” 01H, or “02H” responsive to the number of big bonuses is set in data number “40H,” as shown in FIG. 46G.

Further, at step 138, the effect description data is referenced and whether or not the effect description indicates any specific effect described above is determined. If the effect description indicates any specific effect, the process goes to step 139; otherwise, step 139 is skipped and the information write processing is exited. At step 139, the main CPU 1031 instructs the IC chip reader/writer 1110 to write (store) the effect description data (which becomes effect relevant information in the invention) into (in) the IC chip 1094 of the figure 1090 set in the authentication unit 1027 as rewrite game information in the invention. In this case, as the effect description data, classification data “00H,” 01H,” or “02H” responsive to the effect description is set in data number “20H,” as shown in FIG. 46F.

When the information write processing is exited, the game processing is also exited. Subsequently, the process goes to step 103 shown in FIG. 41 and display control processing is executed. In this display control processing, the main CPU 1031 instructs the image control circuit 1050 to display an image on the liquid crystal display 1015. Subsequently, in sound control processing at step 104, the main CPU 1031 instructs the sound control circuit 1060 to output a sound from the loudspeakers 1017L and 1017R.

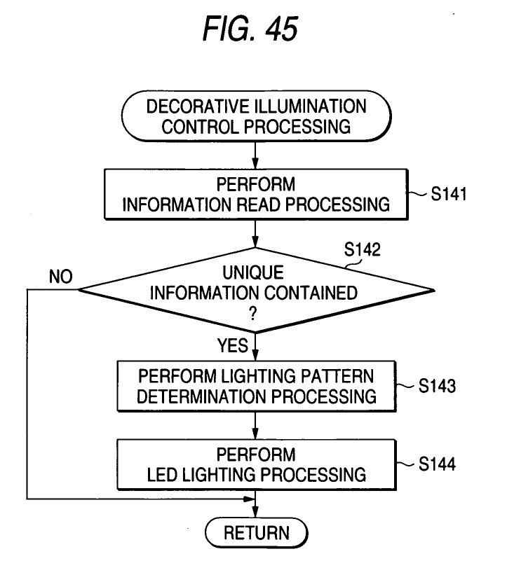

Further, at step 105, decorative illumination control processing is performed according to the flowchart of FIG. 45. When the decorative illumination control processing is started, the process goes to step 141 and information read processing similar to that at step 111 is performed. Here, unique information and the rewrite game information of the effect description data, etc., already written are acquired from the set figure 1090. Subsequently, the process goes to step 142 and the main CPU 1031 operates as a determination unit in the invention and determines whether or not the information read at step 111 contains unique information. If the information contains unique information, the process goes to step 143; otherwise, the decorative illumination control processing is exited without executing the subsequent steps. As step 142 is executed, the subsequent decorative illumination control processing is performed only when the figure 1090 which is set in the authentication unit 1027 and can be used with the pachinko gaming machine 1001 is used for playing a game. Thus, in the pachinko gaming machine 1001, when the figure 1090 is not used for a game, the side light emission body 1115B does not emit light, so that the power required for the side light emission body 1115B to emit light can be saved.

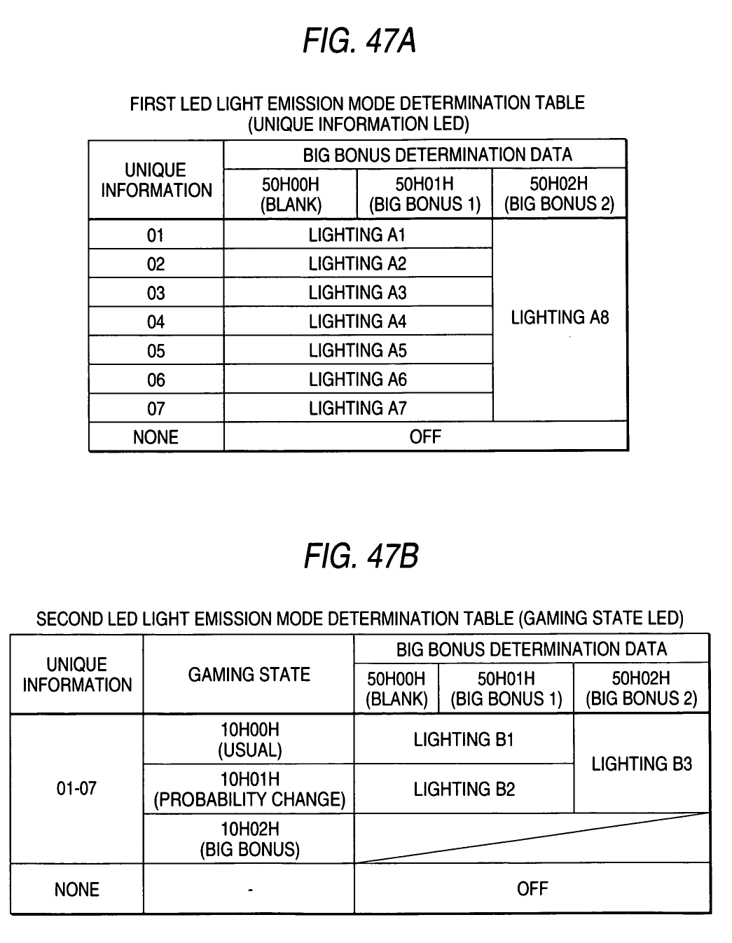

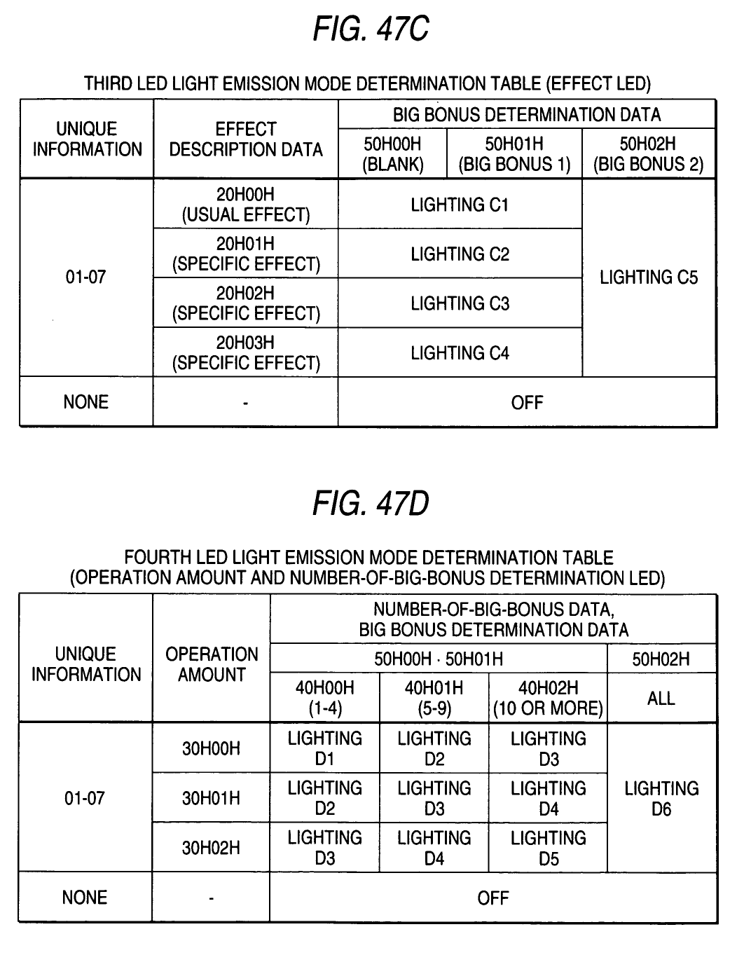

At step 143, lighting pattern determination processing is performed. In this lighting pattern determination processing, the main CPU 1031 operates as a light emission mode determination unit in the invention and searches the lighting pattern determination table shown in FIGS. 47A to 47D using the read game information and the data generated at the steps described above and determines the lighting pattern (light emission mode) of the LED₁₁ to the LED₁₈ making up the side light emission body 1115B. Here, the lighting pattern determination table is made up of four tables of first to fourth LED light emission mode determination tables as shown in FIGS. 47A, 47B, 47C, and 47D respectively so that the light pattern can be determined based on the unique information and the rewrite game information. The first to fourth LED light emission mode determination tables are formed for determining the light patterns of LED₁₁ to LED₁₃, LED₁₄, LED₁₅ and LED₁₆, and LED₁₇ and LED₁₈. For example, in the first LED light emission mode determination table shown in FIG. 47A, the lighting pattern is determined based on the unique information and the big game determination data. In the first LED light emission mode determination table, when the big game determination data is “blank” or “big bonus 1,” the lighting pattern varies from “lighting A1” to “lighting A7” in response to the unique information; when the big game determination data is “big bonus 2,” the lighting pattern becomes “lighting A8.” Therefore, according to the first LED light emission mode determination table, the lighting pattern varies in response to not only the unique information, but also the big game determination data of rewrite game information. In the second to fourth LED light emission mode determination tables, like the first LED light emission mode determination table, the lighting pattern also varies in response to the unique information and the rewrite game information.

When searching the first LED light emission mode determination table, the main CPU 1031 uses the unique information and the big game determination data; when searching the second LED light emission mode determination table, the main CPU 1031 uses the unique information, the gaming state data, and the big game determination data. According to the second LED light emission mode determination table, the lighting pattern is determined based on the determination result of the unique information, the gaming state, and the big game determination.

When searching the third LED light emission mode determination table, the main CPU 1031 uses the unique information, the effect description data, and the big game determination data; when searching the fourth LED light emission mode determinate on table, the main CPU 1031 uses the unique information, the operation amount data, the number-of-big-bonuses data, and the big game determination data.

The first to fourth LED light emission mode determination tables are searched, whereby the light patterns of LED₁₁ to LED₁₃, LED₁₄, LED₁₅ and LED₁₆, and LED₁₇ and LED₁₈ of the LED₁₁ to the LED₁₈ making up the side light emission body 1115B are determined separately. In the first to fourth LED light emission mode determination tables, the lighting pattern of the side light emission body 1115B is determined, but the lighting pattern of the lower light emission body 1115A as well as that of the side light emission body 1115B may be defined.

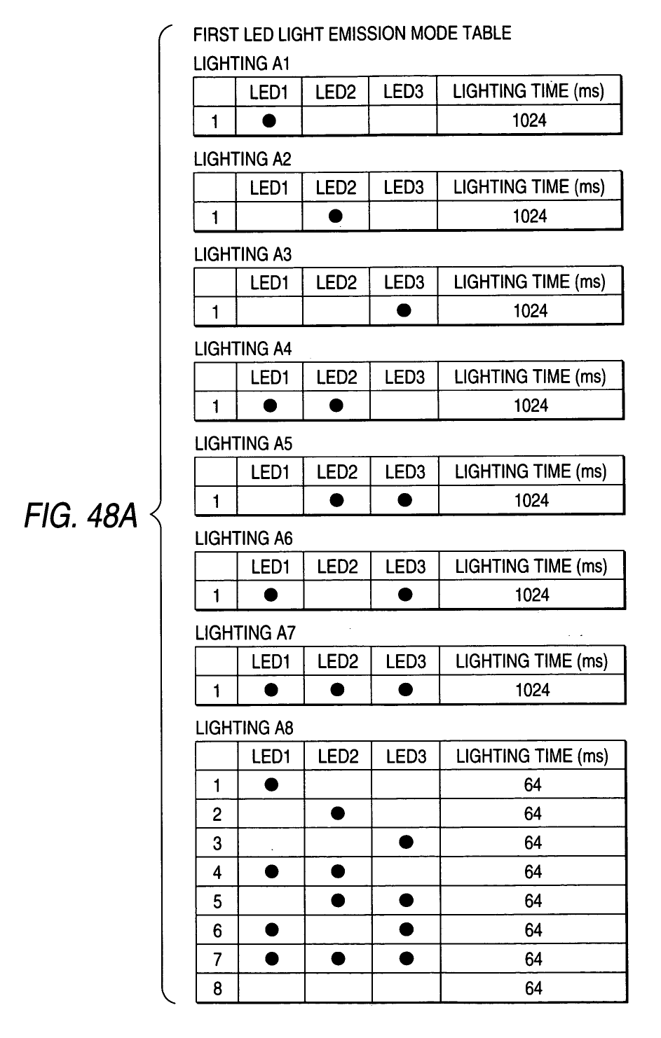

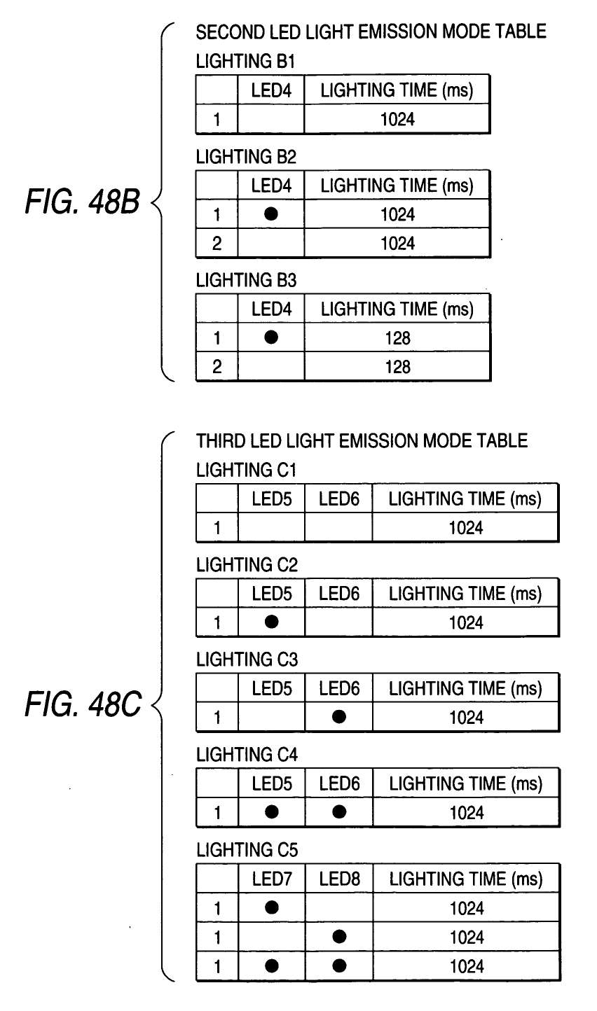

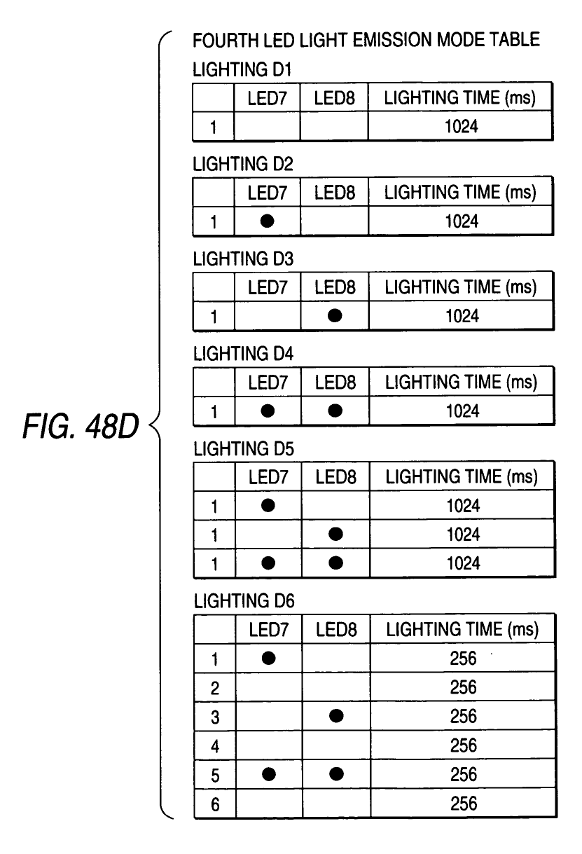

Next, at step 144, LED lighting processing is performed. In this LED lighting processing, the main CPU 1031 operates as a light emission control unit in the invention and instructs the decorative illumination control circuit 1072a to output a drive signal for lighting the LED₁₁ to the LED₁₈ according to the lighting pattern determined at step 143. At this time, the main CPU 1031 causes the decorative illumination control circuit 1072a to output an LED lighting signal for lighting the LED₁₁ to the LED₁₈ according to the first to fourth LED light emission mode tables shown in FIGS. 48A, 48B, 48C, and 48D respectively for each lighting pattern determined by searching the first to fourth LED light emission mode determination tables. Here, the first to fourth LED light emission mode tables define the blink cycles of the LED₁₁ to the LED₁₈ responsive to the lighting patterns. For example, the first LED light emission mode table shown in FIG. 48A defines the blink cycle so that LED₁₁, LED₁₂, and LED₁₃ are lighted each for 1024 ms in the order of “lighting A1,” “lighting A2,” and “lighting A3.” For example, the second LED light emission mode table shown in FIG. 48B defines the blink cycle so that no LEDs are lighted, LED₁₄ blinks at 1024-ms intervals, and LED₁₄ blinks at 128-ms intervals in the order of “lighting B1,” “lighting B2,” and “lighting B3.”

When the LED₁₁ to the LED₁₈ are lighted, the transmission light β₁ described above is emitted. Then, since the figure main body 1092 of the figure 1090 is made of transparent material, the transmission light β₁ enters the inside of the figure main body 1092 from the incidence section on the side near to the rear transmission panel 1106, passes through the inside of the figure main body 1092, and is emitted from the emission section on the opposite side. Thus, the player visually recognizes as if the inside of the figure 1090 was lighted and light was emitted from the inside of the figure 1090. Therefore, as the LED₁₁ to the LED₁₈ are lighted, the figure 1090 emits light in a different mode from the mode wherein application light is applied to the outside of the FIG. 1090, so that the number of decorative modes of the figure 1090 increases.

Then, when the LED lighting processing is terminated, the decorative illumination control processing is exited and the process goes to step 106 shown in FIG. 41 and the main CPU 1031 instructs the payout and propelling control circuit 1080 to perform payout processing of game media (in the embodiment, game balls) responsive to the game play. Then, the process returns to step 102 and the above-described processing is repeated.

As described above, in the pachinko gaming machine 1001 according to the embodiment, the game information (unique information and rewrite game information of effect description data, etc.,) stored in the figure 1090 is read by the authentication unit 1027, the light emission mode is determined based on the read game information, and the side light emission body 1115B emits light in accordance with the determined light emission mode. Thus, in addition to change in the unique information when another figure 1090 is set, etc., the rewrite game information of the game information can change in response to the number of big bonuses and the number of games even if the same figure 1090 is set in the authentication unit 1027. Thus, the light emission mode changes in response to the change in the rewrite game information and the side light emission body 1115B emits light in a different way accordingly. Therefore, one figure 1090 can be decorated in different manners and thus if a large number of figure 1090 are not provided, the player is enabled to play a game without losing interest in playing the game and the interest in the game play can be enhanced.

In the pachinko gaming machine 1001, the rewrite game information includes the effect description data, the operation amount data, and the number-of-big-bonuses data, so that the light emission mode of the side light emission body 1115B changes based on the effect description, the game operation amount of the player, and the number of big bonuses and decoration of the figure 1090 changes accordingly. Therefore, the player's interest in the game play can be still more enhanced. Further, the light emission mode of the side light emission body 1115B also changes based on the determined gaming state and decoration of the figure 1090 also changes accordingly, so that the player can also keep track of the gaming state according to the decoration of the figure 1090. Therefore, in the pachinko gaming machine 1001, the interest in the game play can be more enhanced.

Further, in the first to fourth LED light emission mode tables, the light emission mode is determined based on the big bonus determination data written after the gaming state transition is made, whereby the light emission mode is determined before the transition to a big bonus is made, and the main CPU 1032 as the light emission control unit controls the light emission of the side light emission body 1115B. Thus, the side light emission body 1115B emits light before the gaming state transition to a big bonus is made. Accordingly, the player is previously notified of the transition to a big bonus before the transition to a big bonus is made, so that the interest in the game play can be more enhanced.

### Fifth Embodiment

Next, a fifth embodiment of the invention will be discussed. In the embodiment, a Pachi-Slot machine 1201 is adopted as a gaming machine in the invention. The Pachi-Slot machine 1201 has a configuration as shown in FIGS. 47A to 47D. The Pachi-Slot machine 1201 has a variable display unit for variably displaying a plurality of symbols in a plurality of rows and variably displays a plurality of symbols by the variable display unit, enabling a player to play a game. General configuration of Pachi-Slot machine

The Pachi-Slot machine 1201 has an image display section 1220 on the front of a cabinet 1202 and has three reels 1203L, 1203C, and 1203R placed in one horizontal row for rotation in the cabinet 1202.

The reels 1203L, 1203C, and 1203R can be visually recognized from the outside through symbol display areas 1221L, 1221C, and 1221R of the image display section 1220. The reels 1203L, 1203C, and 1203R have each a symbol row with 21 different symbols drawn on the outer peripheral surface (not shown), and make up the rotatable variable display unit for variably displaying the symbols.

An almost horizontal frontward projection portion 1204 is provided below the image display section 1220. ABET switch 1205 is provided at the left of the frontward projection portion 1204, and a coin insertion slot 1206 is provided at the right of the frontward projection portion 1204. An authentication unit 1227 similar to the authentication unit 1027 in the pachinko gaming machine 1001 described above is provided at the right of BET switch 1205. The BET switch 1205 is provided for the player to make setting to bet a credited coin by pushbutton operation. The coin insertion slot 1206 is provided for the player to input a coin and has an input coin sensor 1206a for outputting a signal indicating coin input.

Further, a C/P switch 1208 and a start lever 1209 are provided from left to right on the front of the frontward projection portion 1204 and three stop buttons 1207L, 1207C, and 1207R are provided at the front center of the frontward projection portion 1204. The C/P switch 1208 is an operation button for the player to switch between credit and payout of a gained coin in a game. The start lever 1209 is attached for rotation in a predetermined angle range and is provided for the player to start variable display of the symbols with rotation of the reels 1203L, 1203C, and 1203R. The stop buttons 1207L, 1207C, and 1207R are provided as a stop operation unit for the player to stop rotation of the reels 1203L, 1203C, and 1203R (scroll display).

The Pachi-Slot machine 1201 is also provided with a coin payout opening 1210 and a coin receiving tray 1211 for collecting paid-out coins at the bottom of the cabinet 1202. As the C/P switch 1208 is switched, a coin is paid out and is stored in the coin receiving tray 1211.

On the other hand, the Pachi-Slot machine 1201 is provided with loudspeakers 1212L and 1212R on the left and the right above the image display section 1220 of the cabinet 1202, and is provided with an award display panel 1213 between the loudspeakers 1212L and 1212R.

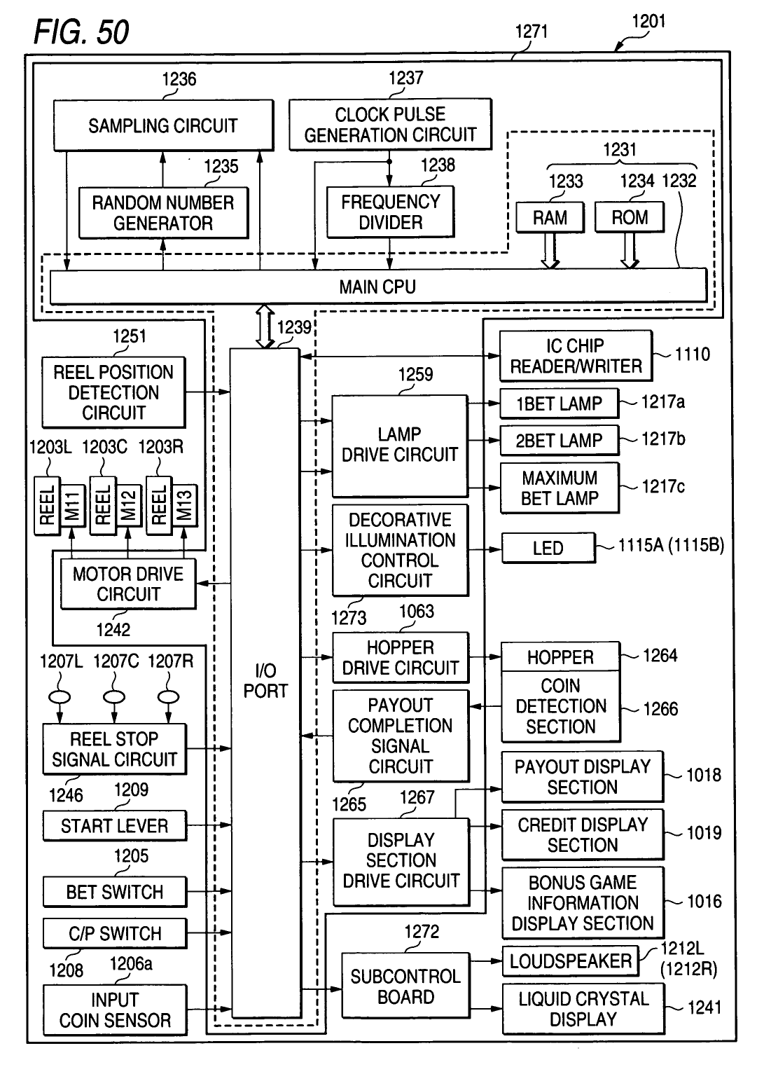

FIG. 50 is a block diagram of the Pachi-Slot machine 1201 shown centering on the internal configuration thereof. The Pachi-Slot machine 1201 has a plurality of components centering on a main control board 1271 including a microcomputer 1231. The main control board 1271 has the microcomputer 1231, a random number generator 1235, a sampling circuit 1236, a clock pulse generation circuit 1237, a frequency divider 1238, a lamp drive circuit 1259, a hopper drive circuit 1263, a payout completion signal circuit 1265, a display section drive circuit 1267, and a decorative illumination control circuit 1273 similar to the decorative illumination control circuit 1072a in the gaming machine 1001.

The microcomputer 1231 has a main CPU (Central Processing Unit) 1232, RAM (Random Access Memory) 1233, and ROM (Read-Only Memory) 1234. The main CPU 1232 operates as various unit of a gaming state transition unit, etc., in accordance with a program stored in the ROM 1234 and on the other hand, inputs/outputs a signal from/to other components via an I/O port 1239 for controlling the whole operation of the Pachi-Slot machine 1201. The RAM 1233 stores data and a program used for the main CPU 1232 to operate; for example, it temporarily retains the random number value sampled by the sampling circuit 1236 described later after a game starts, and also stores the code numbers and the symbol numbers of the reels 1203L, 1203C, and 1203R. The ROM 1234 stores programs executed by the main CPU 1232 and permanent data of a plurality of pieces of effect information, a lighting pattern table, first to fourth light emission mode tables, etc., as in the gaming machine 1001.

The random number generator 1235 operates in accordance with an instruction of the main CPU 1232 and generates random numbers in a given range. The sampling circuit 1236 extracts any random number from among the random numbers generated by the random number generator 1235 in accordance with an instruction of the main CPU 1232 and inputs the extracted random number into the main CPU 1232. The clock pulse generation circuit 1237 generates a reference clock to operate the main CPU 1232, and the frequency divider 1238 inputs a signal provided by dividing the reference clock with a given period into the main CPU 1232.

Further, a reel position detection circuit 1251 and a reel stop signal circuit 1246 are connected to the main control board 1271, and the main control board 1271 has a motor drive circuit 1242. The reel position detection circuit 1251 detects the positions of the reels 1203L, 1203C, and 1203R, and the reel stop signal circuit 1246 outputs a stop signal responsive to stop operation of each stop button 1207L, 1207C 1207R and inputs the stop signal into the microcomputer 1231 through the I/O port 1239. The motor drive circuit 1242 inputs a drive signal into motors M11, M12, and M13 for rotating the reels 1203L, 1203C, and 1203R. The drive signal is input from the motor drive circuit 1242, whereby the motors M11, M12, and M13 operate and rotate the reels 1203L, 1203C, and 1203R respectively. In addition, the start switch 1209, the BET switch 1205, the C/P switch 1208, and the input coin sensor 1206a are connected to the main control board 1271 and a signal is input to the main control board 1271 from the components.

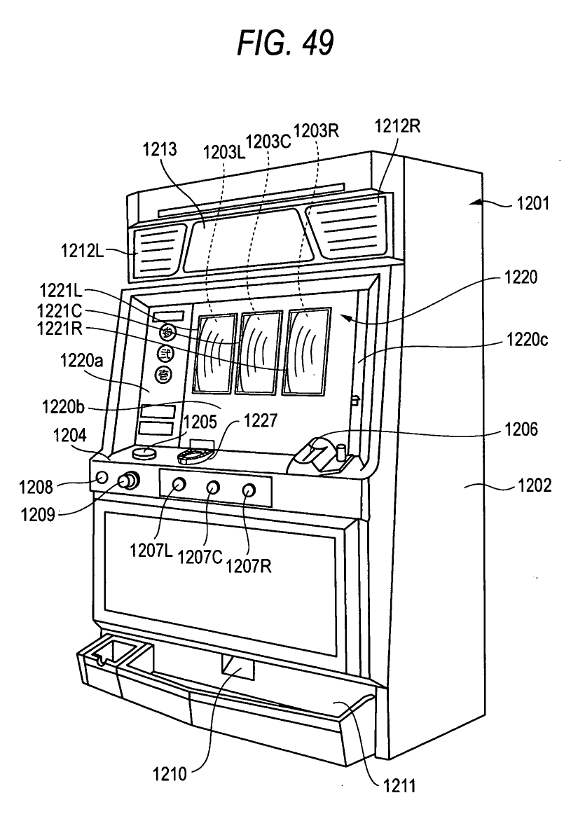

The lamp drive circuit 1259 outputs a signal for lighting various lamps (BET lamps 1217a, 1217b, and 1217c) during game execution. The hopper drive circuit 1263 drives a hopper 1264 under the control of the main CPU 1232, and the hopper 1264 operates for paying out a coin and causes a coin to be paid out from the coin payout opening 1220. The payout completion signal circuit 1265 inputs the number-of-coins data from a coin detection section 1266 connected to the payout completion signal circuit 1265 and when the number of coins reaches the setup value, inputs a signal reporting the coin payout completion into the main CPU 1232. The coin detection section 1266 counts the number of coins paid out by the hopper 1264 and inputs the data of the counted number of coins into the payout completion signal circuit 1265. The display section drive circuit 1267 controls the display operation of display sections 1018, 1019, and 1020 (not shown in FIG. 49).

Further, a subcontrol board 1272 is connected to the main control board 1271. The subcontrol board 1272 inputs a control instruction (command) from the main control board 1271 and performs display control of a liquid crystal display 1241 (which implements the image display section 1220 and is placed at the front of the reels 1203L, 1203C, and 1203R producing transparent display in the symbol display areas 1221L, 1221C, and 1221R) and performs output control of a sound produced by the loudspeakers 1212L and 1212R. The subcontrol board 1272 is implemented on a circuit board separate from the circuit board implementing the main control board 1271. It has a microcomputer not shown (which will be hereinafter referred to as submicrocomputer) as the main component and also has a sound source IC for controlling the sound output from the loudspeakers 1212L and 1212R, a power amplifier, and an image control circuit operating as a display control unit of the liquid crystal display 1241.

In the described Pachi-Slot machine 1201, the reels 1203L, 1203C, and 1203R rotate for producing variable display of the symbols as the player operates the start lever 1209; the reels 1203L, 1203C, and 1203R stop as the player operates the stop buttons 1207L, 1207C, 1207R. At this time, when the symbols stopped and displayed on a predetermined activated pay line become specific symbols in the symbol display areas 1221L, 1221C, and 1221R of the image display section 1220, a medium used with a game, such as a medal or a coin, (which will be hereinafter referred to as coin), is paid out to the player. Further, the main CPU 1232 operates as the gaming state transition unit and causes the gaming state to make a transition from the usual gaming state to a specific gaming state such as BB (big bonus) or RB (regular bonus) more advantageous to the player than the usual gaming state.

When the Pachi-Slot machine 1201 operates, effect control processing is performed as in the flowchart of FIG. 41 under the control of the main CPU 1232. In game processing, when the player operates the start lever 1209 at step 110 in the flowchart of FIG. 42, it is determined that the game start condition holds. In any other processing, processing peculiar to the Pachi-Slot machine 1201 may be performed instead of the processing peculiar to the gaming machine 1001. For example, at step 121, whether or not internal winning of BB or RB occurs may be determined instead of the determination as to whether or not a big bonus occurs, and the data indicating the determination result may be generated. At step 122, the effect description data corresponding to the effect peculiar to the Pachi-Slot machine 1201 may be generated. Further, in information write processing shown in FIG. 44, as operation amount count processing at step 131, the number of times the start lever 1209 has been operated is counted, determination at step 134 is made according to whether or not data indicating internal winning of BB or RB is set, and determination at step 136 is made according to whether or not the number of times internal winning of BB or RB has occurred is equal to or greater than a specific number of times. Various tables shown in FIGS. 46A to 46G and 47A to 47D may be changed to data peculiar to the Pachi-Slot machine 1201 appropriately. (The subCPU on the subcontrol board 1272 controls steps 103, 104, and 105 as instructed by the main CPU 1232.)

In doing so, also in the Pachi-Slot machine 1201, as in the gaming machine 1001, the light emission mode is determined based on the game information read from the figure 1090 set in the authentication unit 1227, and the side light emission body 1115B emits light in accordance with the determined light emission mode. Thus, even with the same figure 1090, if the rewrite game information of the game information changes, the light emission mode changes accordingly and the side light emission body 1115B emits light in a different way, so that one game article can be decorated in different manners. Therefore, if a large number of figure 1090 are not provided, the player is enabled to play a game without losing interest in playing the game. Moreover, the player can play a game while considering the relationship among the figure 1090, the stopped and displayed symbols, and the transition to a specific gaming state of BB, RB, etc., so that the player can be still more prevented from losing interest in playing the game.

### Sixth Embodiment

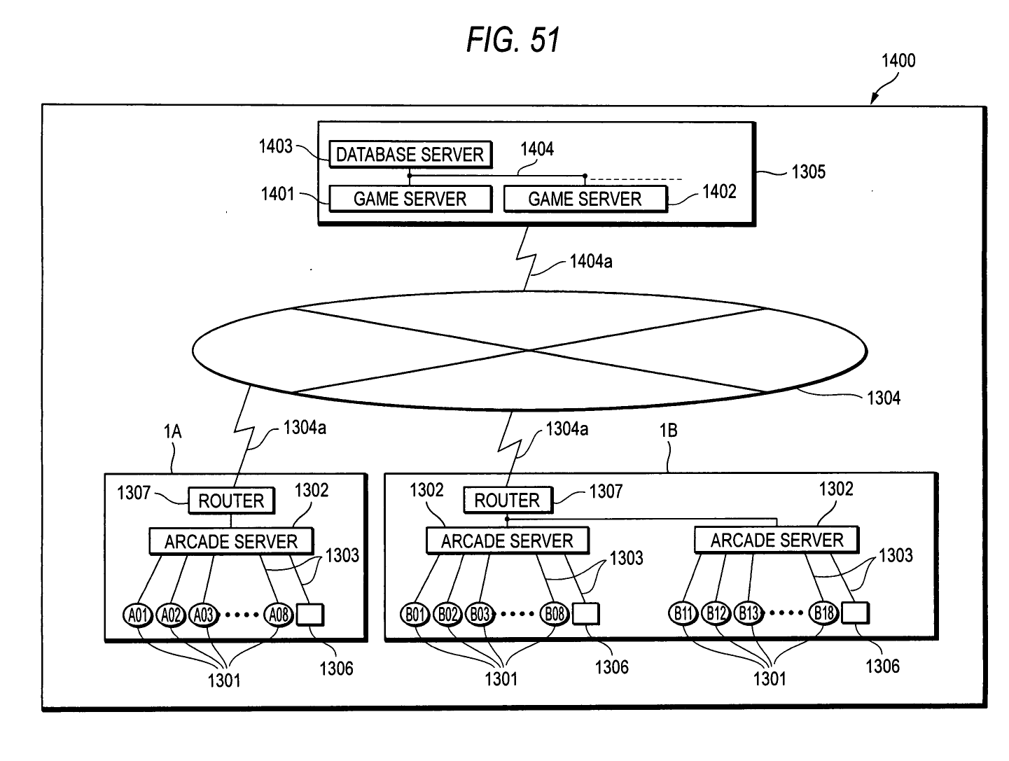

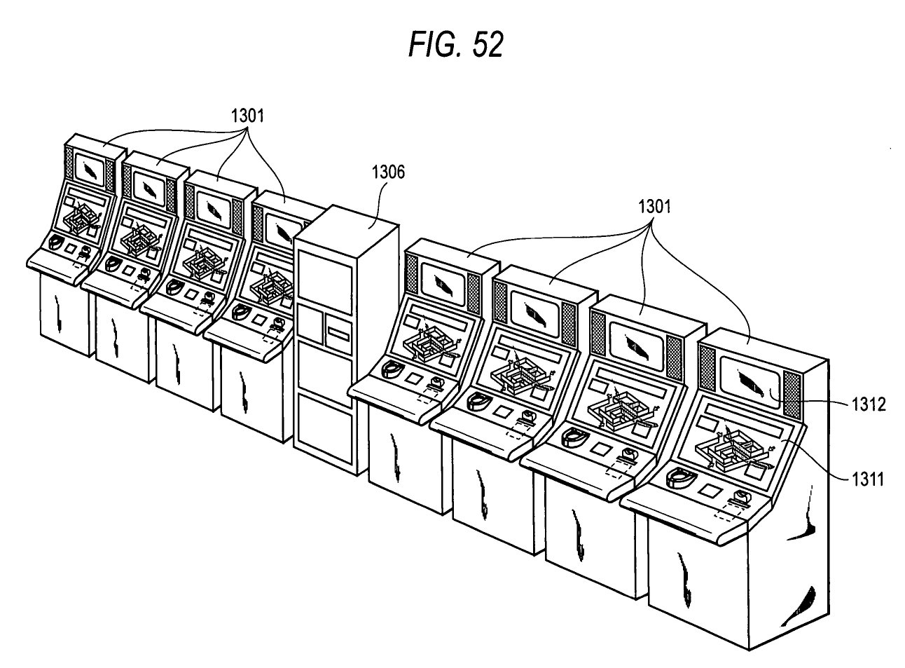

Next, a sixth embodiment of the invention will be discussed. In the embodiment, a gaming machine 1301 forming a part of a game system 1400 shown in FIG. 51 is adopted as a gaming machine in the invention. FIG. 51 is a diagram to show the configuration of the game system 1400 including a plurality of gaming machines 1301 according to the invention. FIG. 52 is a perspective view to show a plurality of gaming machines 1301 and a card selling machine 1306. The game system 1400 has a total of three arcade servers 1302 (one server installed in a game arcade 1A and two servers installed in a game arcade 1B), a plurality of (in the embodiment, eight) gaming machines 1301 and the card selling machine 1306 for issuing an ID card 1317 (described later), connected to the server by dedicated lines 1303 so that they can communicate with each other, in-arcade routers 1307 installed in the game arcades 1A and 1B, and a center server group 1305 connected to the in-arcade routers 1307 through communication lines 1304a and Internet 1304.

In each game arcade 1A, 1B, the arcade server(s) 1302, the gaming machines 1301, and the card selling machine 1306 are connected by the dedicated lines 1303 to form an in-arcade local area network (LAN), and the in-arcade LAN is connected to the Internet 1304 through the in-arcade router 1307.

Configuration of Gaming Machine

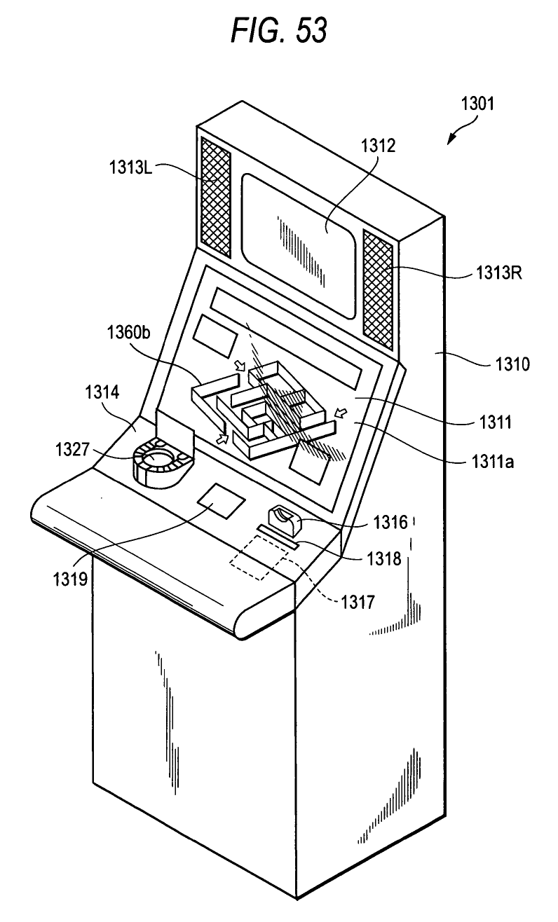

The gaming machine 1301 has an image display unit for displaying a character image indicating a character acting in response to player operation as a game image used to play a game and enables the player to play an image game for causing the character to act in response to player operation. The gaming machine 1301 includes a phase wherein a labyrinth is changed by shifting a wall part 1360b (see FIG. 53) of the labyrinth where a character moves in response to user selection (shift phase) and a phase wherein a character moves in a labyrinth along the route selected by the player (move phase), and enables the player to a game wherein the character selected by the player opposes a different character (a player character acting in accordance with selection of a different player or a non-player character caused to act by the gaming machine), struggles for items each other, gathers all items and then falls down the character of the final goal (which will be hereinafter referred to as “labyrinth battle game”). The labyrinth battle game is a game of the type wherein a plurality of players paying a game with each game machine 1301 enter the game.

As shown in FIG. 53, the gaming machine 1301 has a main display 1311 including a liquid crystal display on the front of a cabinet 1310. It also has a subdisplay 1312 including a liquid crystal display above the main display 1311 and loudspeakers 1313L and 1313R for outputting a sound used for the effect of game play on the right and the left sides of the subdisplay 1312.

The main display 1311 is a display unit in the invention and displays a game image responsive to each stage of game play (for example, a labyrinth image having a labyrinth where each character moves or the like) and the game execution result. The subdisplay 1312 displays an image at a specific stage of game play.

The gaming machine 1301 also has an operation panel 1314 below the main display 1311, an authentication unit 1327 similar to the authentication unit of the pachinko gaming machine 1001 at the left of the operation panel 1314, and a coin insertion slot 1316 for inputting a coin required for playing a game (a game medium such as a coin or a game medal) and a card slot 1318 for inserting an ID card 1317 at the right of the operation panel 1314.

Each of the gaming machines 1301 forming the game system 1400 is assigned the unique machine ID. The machine ID is made up of the server ID unique to each arcade server 1302 and the ID unique to each gaming machine 1301; for example, the machine IDs of the gaming machines 1301 installed in the arcade A are A01, A02, A03, . . .

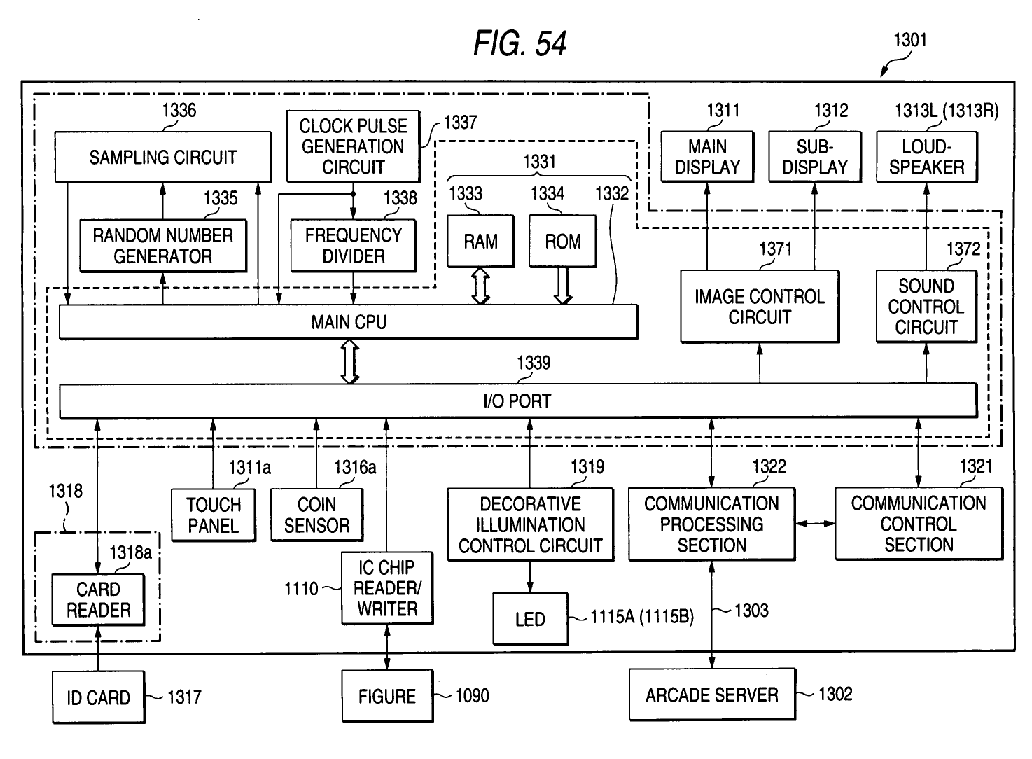

FIG. 54 is a block diagram of the gaming machine 1301 centering on the internal configuration thereof. The gaming machine 1301 has components centering on a microcomputer 1331.

The microcomputer 1331 has a main CPU (Central Processing Unit) 1332, RAM (Random Access Memory) 1333, and ROM (Read-Only Memory) 1334. The main CPU 1332 operates in accordance with a program stored in the ROM 1334 and inputs a signal from each component provided on the operation panel 1314 through an I/O port 1339 and on the other hand, inputs/outputs a signal from/to other components for controlling the whole operation of the gaming machine 1301. The RAM 1333 stores data and a program used for the main CPU 1332 to operate (in the embodiment, application data described later). The ROM 1334 stores the control program executed by the main CPU 1332 and permanent data of a lighting pattern table and first to fourth light emission mode tables, etc., and further stores a plurality of pieces of effect information used for effect peculiar to the gaming machine 1301.

The gaming machine 1301 has a random number generator 1335, a sampling circuit 1336, a clock pulse generation circuit 1337, and a frequency divider 1338. The random number generator 1335 operates in accordance with an instruction of the main CPU 1332 and generates random numbers in a given range. The sampling circuit 1336 extracts any random number from among the random numbers generated by the random number generator 1335 in accordance with an instruction of the main CPU 1332 and inputs the extracted random number into the main CPU 1332. The clock pulse generation circuit 1337 generates a reference clock to operate the main CPU 1332, and the frequency divider 1338 inputs a signal provided by dividing the reference clock with a given period into the main CPU 1332.

The gaming machine 1301 further has a touch panel 1311a, a coin sensor 1316a, a card reader 1318a, a communication control section 1321, a communication processing section 1322 as a communication processing unit in the invention, an image control circuit 1371, a sound control circuit 1372, and a decorative illumination control circuit 1319 similar to the decorative illumination control circuit 1072a in the gaming machine 1001.

The touch panel 1311a is provided so as to cover the display screen of the main display 1311 for detecting the touch position of a finger of a player and inputting a position signal corresponding to the detection position into the main CPU 1332. The player uses the touch panel 1311a to execute operation input for determining the action of the character.

The coin sensor 1316a detects a coin input through the coin insertion slot 1316 and outputs a detection signal corresponding to the coin detection to the main CPU 1332. The card reader 1318a reads card information of the player ID, etc., recorded on the ID card 1317 inserted into the card slot 1318 and inputs the read card information into the main CPU 1332.

The communication control section 1321 operates as instructed by the main CPU 1332 and controls connection and disconnection of the communication line with the arcade server 1302. The communication processing section 1322 operates as instructed by the communication control section 1321 and transmits and receives data via the dedicated line 1303.

The image control circuit 1371 controls image display of the main display 1311 and the subdisplay 1312 and causes the main display 1311 and the subdisplay 1312 to display various images such as an image indicating a character. The sound control circuit 1372 inputs a sound signal for outputting a sound from the loudspeakers 1313L and 1313R into the loudspeakers 1313L and 1313R. For example, a sound to liven up the game is output from the loudspeakers 1313L and 1313R at an appropriate timing after the game starts.

With the described gaming machine 1301, application data (containing various pieces of data such as image data used to execute a labyrinth battle game) is received from the arcade server 1302 and is stored in the RAM 1333. When the main CPU 1332 reads the application data, it allows the labyrinth battle game to proceed in response to operation input of the player. At this time, the gaming machines 1301 synchronize with each other through the arcade server 1302 and the center server group 1305 for displaying the game image on each main display 1311 and allowing the labyrinth battle game to proceed. At this time, in each gaming machine 1301, if a figure 1090 is set in the authentication unit 1327, game information is read from the figure 1090 through the authentication unit 1327 and the labyrinth battle game is allowed to proceed in a figure presence mode (the gaming machine 1301 enables the player to play the labyrinth battle game in the figure presence mode applied when the figure 1090 is set or in a no-figure mode applied when no figure 1090 is set). While the labyrinth battle game is proceeding, game relevant information is received by the communication processing section 1322 through the arcade server 1302 from another gaming machine 1301. The game relevant information includes information concerning selection of the route where each character corresponding to each player moves (the wall part to be shifted, selected by the player, of wall parts 1160b forming the labyrinth or the route on the labyrinth selected by the player), information of the character of the opponent, etc., for example.

When the gaming machine 1301 operates, effect control processing is performed as in the flowchart of FIG. 41 under the control of the main CPU 1332. In game processing, when the player inputs a coin into the coin insertion slot 1316 at step 110 in the flowchart of FIG. 42, it is determined that the game start condition holds. In any other processing, processing peculiar to the gaming machine 1301 may be performed instead of the processing peculiar to the gaming machine 1001. For example, game relevant information of another gaming machine 1301 is received from the arcade server 1302 instead of effect determination processing. In information write processing at step 113, the number of character move times, the number of battles, the presence or absence of battle with a specific character, and the like are determined at steps 131, 135, and 138 and the corresponding data is written. Further, in decorative illumination control processing in FIG. 45, the light emission mode is determined using the game information read from the figure 1090 and the game relevant information received from another gaming machine 1301, and the decorative illumination control circuit 1319 is operated for causing a side light emission body 1115B to emit light in accordance with the determined light emission mode

In doing so, the side light emission body 1115B emits light in accordance with the determined light emission mode. Thus, even with the same figure 1090, if the rewrite game information of the game information or the game relevant information received from another gaming machine 1301 changes, the light emission mode changes accordingly and the side light emission body 1115B emits light in a different way. Therefore, one game article can be decorated in different manners, so that if a large number of figures 1090 are not provided, the player is enabled to play a game without losing interest in playing the game, and the light emission mode is determined based on the game relevant information received from another gaming machine through the arcade server and thus the player can play a game while imaging the relationship between the decoration of the figure 1090 and the received game relevant information, and can be still more prevented from losing interest in playing the game.

### Seventh Embodiment

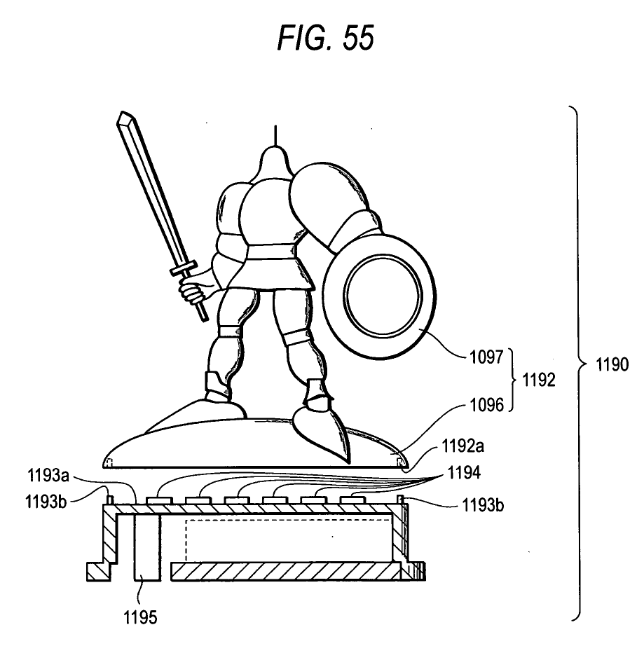

FIG. 55 is an exploded perspective view to show a different figure 1190. This figure 1190 differs from the figure 1090 described above in that it has a pedestal 1191 rather than the pedestal 1091 and a figure main body 1192 rather than the figure main body 1092.

The pedestal 1191 has a plurality of LEDs 1194 attached to a top section 1193a of a pedestal main body 1193, an LED circuit similar to the LED circuit 1115c, and a projection part 1193b attached to the periphery and further has a connector 1195 electrically connected to each LED 1194 and provided in an internal hollow portion. The figure main body 1192 has a concave part 1192a different from the figure main body 1092 in shape and placement location.

In the figure 1190, a lighting signal can be input to each LED 1194 through the connector 1195 for lighting each LED 1194. Light produced by lighting each LED 1194 can be introduced into the inside of the figure main body 1192 from the pedestal 1191. That is, the figure 1190 emits light by inputting the lighting signal from the outside.

To use the figure 1190 in place of the figure 1090, the authentication unit 1027 described above is provided with a connector that can be connected to the connector 1195 and on the other hand, a lighting signal is input through the connectors from a gaming machine such as the pachinko gaming machine 1001. If the input pattern of the lighting signal is determined as described above, advantages similar to those described above can be provided.

In the description of the embodiments, as the game article, a figure is taken as an example. In addition, however, a three-dimensional article such as a cassette or a cartridge may be used in place of a three-dimensional article such as the figure 1090.

In the pachinko gaming machine 1001 in the fourth embodiment, in addition to the main control circuit 1030, a subcontrol circuit including a subCPU may be provided and may be provided with lighting pattern determination tables, etc., for the subCPU to determine a lighting pattern and control light emission of LED₁₁ to LED₁₈. Also in the Pachi-Slot machine 1201, the subCPU on the subcontrol board 1272 may determine a lighting pattern and control light emission of LED₁₁ to LED₁₈.

In the pachinko gaming machine 1001, the lighting pattern determination tables and the first to fourth light emission mode tables are stored in the main ROM 1032. However, the lighting pattern determination tables and the first to fourth light emission mode tables may be stored in the decorative data ROM 1071. The decoration data stored in the decorative data ROM 1071 may be stored in the main ROM 1032 to remove the decorative data ROM 1071. The lamp control circuit 1070 may be provided with a circuit similar to the decorative illumination control circuit 1072a so that the lamp control circuit 1070 lights LED₁₁ to LED₁₈.

Further, LED₁₁ to LED₁₈ are classified into four groups of LED₁₁ to LED₁₃, LED₁₄, LED₁₅ and LED₁₆, and LED₁₇ and LED₁₈ for emitting light, and each light emission is controlled. In addition, LED₁₁ to LED₁₈ may be grouped in various manners like LED₁₁ and LED₁₂, LED₁₃ and LED₁₄, LED₁₅ to LED₁₇, and LED₁₈, etc., for example. The lighting pattern determination table configuration may be changed in response to the grouping mode of the LEDs. Classifying the LEDs into the four groups described in the fourth embodiment may be released for allowing LED₁₁ to LED₁₈ to light emit separately.

The lighting pattern determination table is formed for determining the lighting pattern of each group, but the correspondence between each group and the lighting pattern determination table can also be changed whenever necessary. For example, LED₁₇ and LED₁₈ may be lighted according to the third LED light emission mode determination table.

What is claimed is:

1. A gaming machine comprising:
a read unit for reading game information concerning a game from a game article including a main body section having an incidence section for introducing light incident from the outside into the inside and an emission section for emitting light incident from the incidence section and passing through the inside to the outside and a storage section for storing the game information concerning a game;
a light emission mode determination unit for determining a light emission mode of a light emission body for emitting light to the incidence section of the game article based on the game information read through the read unit; and
a light emission control unit for controlling the light emission of the light emission body in accordance with the light emission mode determined by the light emission mode determination unit.

2. The gaming machine according to claim 1, wherein
the light emission body can emit light of a plurality of colors to the incidence section of the game article.

3. The gaming machine according to claim 1, wherein
the light emission body is provided.

4. The gaming machine according to claim 1, wherein
the game article has the light emission body.

5. The gaming machine according to claim 1, further comprising:
an image display unit for displaying a game image used for a game;
an operation unit for a player to perform operation input required for progress of an image game using the game image;
a game progress control unit for displaying the game image on the image display unit and allowing the image game to proceed; and
a communication unit for receiving game relevant information concerning the image game from the outside, wherein
the light emission mode determination unit determines the light emission mode of the light emission body based on the game relevant information received by the communication unit and the game information read through the read unit.

6. The gaming machine according to claim 1, further comprising
a gaming mode control unit for causing a gaming mode to make a transition from a usual gaming mode to a special gaming mode as a predetermined transition condition holds, wherein the usual gaming mode and the special gaming mode for giving an advantageous bonus to the player are provided as the gaming mode.

7. The gaming machine according to claim 1, further comprising:
a write unit for storing rewritable rewrite game information of the game information except for unique information to the game article in the game article; and
a light emission unit for generating light that can be made incident on the incidence section of the game article.

8. The gaming machine as according to claim 7, further comprising:
an effect information storage unit for storing effect information to produce different types of game effects; and
an effect determination unit for determining the description of the effect produced using the effect information stored in the effect information storage unit, wherein
when the effect determination unit determines producing a specific effect, the write unit stores effect relevant information relevant to the specific effect in the game article as the rewrite game information.

9. The gaming machine according to claim 7, wherein
when the operation amount of the gaming machine by a player reaches a specific operation amount, the write unit stores operation relevant information concerning the specific operation amount in the game article as the rewrite game information.

10. The gaming machine according to claim 7, further comprising
a gaming state transition unit for causing the gaming state to make a transition from a usual gaming state to a specific gaming state more advantageous to the player than the usual gaming state, wherein
when the number of times the gaming state transition unit has caused the gaming state to make a transition from the usual gaming state to the specific gaming state reaches a specific number of times, the write unit stores number-of-times relevant information concerning the specific number of times in the game article as the rewrite game information.

11. The gaming machine according to claim 7, further comprising
a gaming state determination unit for determining the gaming state for the player to play a game from among a usual gaming state and a plurality of specific gaming states more advantageous to the player than the usual gaming state, wherein
the light emission mode determination unit determines the light emission mode based on the game information read through the read unit and the gaming state determined by the gaming state determination unit.

12. The gaming machine according to claim 7, further comprising:
a transition permission/inhibition determination unit for determining whether or not the gaming state is allowed to make a transition from a usual gaming state to a specific gaming state more advantageous to the player than the usual gaming state; and
a gaming state transition unit for causing the gaming state to make a transition to the specific gaming state when the transition permission/inhibition determination unit determines the gaming state transition to the specific gaming state, wherein
before the gaming state transition unit causes the gaming state to make a transition to the specific gaming state, the light emission mode determination unit determines the light emission mode based on the game information read through the read unit and the determination of the transition permission/inhibition determination unit and the light emission control unit controls the light emission of the light emission unit.

13. The gaming machine according to claim 7, further comprising
a determination unit for determining whether or not the game article is used for a game, wherein
when the determination unit determines that the game article is not used for the game, the light emission control unit inhibits the light emission unit from emitting light to control the light emission of the light emission unit.

14. The gaming machine according to claim 7, further comprising:
a display unit for displaying a game image used for a game and the game execution result; and
a communication processing unit for receiving the game relevant information relevant to the game from the outside, wherein
the light emission mode determination unit determines the light emission mode of the light emission unit based on the game information and the game relevant information received by the communication processing unit.

15. The gaming machine according to claim 7, further comprising:
a variable display unit for variably displaying a plurality of symbols; and
a gaming state transition unit for causing the gaming state to make a transition from a usual gaming state to a specific gaming state more advantageous to the player than the usual gaming state when the symbols stopped and displayed on the variable display unit are specific symbols.

16. A game article comprising:
a storage section for storing game information concerning a game of a gaming machine; and
a main body section having an incidence section for introducing light incident from a light emission body into the inside and an emission section for emitting light incident from the incidence section and passing through the inside to the outside.
